(19) United States
(12) Patent Application Publication
(10) Pub. No.: US 2026/0339488 A1
(43) Pub. Date: Oct. 29, 2026

(54) GROUP PRESENTATION METHOD

(71) Applicant: Tencent Technology (Shenzhen) Company Limited, Shenzhen (CN)

(72) Inventor: Huajian ZHANG, Shenzhen (CN)

(73) Assignee: Tencent Technology (Shenzhen) Company Limited, Shenzhen (CN)

(21) Appl. No.: 19/703,045

(22) Filed: Jun. 9, 2026

Related U.S. Application Data
(63) Continuation of application No. PCT/CN2025/088021, filed on Apr. 9, 2025.

(30) Foreign Application Priority Data
May 15, 2024 (CN) 202410602103.9

(51) Int. Cl. G06F 3/0483; G06F 3/04842

(52) U.S. Cl. CPC G06F 3/0483; G06F 3/04842

(57) ABSTRACT

In a method for group presentation, a first page in an application is displayed on a display of a terminal associated with a first entity. A target group name of a target group is displayed in the first page; the target group name being associated with a link tag of an entry link of the target group. The entry link is created by a second entity in the target group and associated with the target group name upon creation by the second entity. A hover operation in a region of the displayed target group name on the first page is detected. Basic information of the target group is displayed in a notification window overlaying the first page based on the hover operation. A session page of the target group is displayed based on a triggering operation performed on the displayed target group name on the first page.

### RELATED APPLICATIONS

The present application is a continuation of International Application No. PCT/CN2025/088021, filed on Apr. 9, 2025, which claims priority to Chinese Patent Application No. 202410602103.9, filed on May 15, 2024. The entire disclosures of the prior applications are hereby incorporated by reference.

### FIELD OF THE TECHNOLOGY

This disclosure relates to the field of data processing technologies, including a group presentation method and apparatus in an application, a non-transitory computer-readable storage medium, and a computer program product.

### BACKGROUND

In an application, users of the application may be divided into groups. When managing the groups in the application, a group name of a group to be searched may be inputted in a fixed search region of the application, to find a target group. Alternatively, a group may be directly entered using a group link without searching the group (e.g., a message transmitted by another user containing a group link of the target group). In the latter approach, the user can only see a link, and may view basic information or a type of a group after clicking or tapping into the link of the group. Group management efficiency and information transmission efficiency are low.

### SUMMARY

Embodiments of this disclosure include a group presentation method and apparatus in an application, a non-transitory computer-readable storage medium, and a computer program product, which can improve information transmission efficiency.

According to an aspect of embodiments of this disclosure, a group presentation method is provided. In the method, a first page in an application is displayed on a display of a terminal associated with a first entity. A target group name of a target group is displayed in the first page, the target group name being associated with a link tag of an entry link of the target group, the entry link being created by a second entity in the target group and associated with the target group name of the target group upon creation by the second entity. A hover operation performed in a region of the displayed target group name on the first page is detected by processing circuitry of the first terminal. In the method, basic information of the target group is displayed in a notification window overlaying the first page based on the hover operation being detected. A triggering operation performed on the displayed target group name on the first page is detected by the processing circuitry of the first terminal. A session page of the target group is displayed based on the triggering operation being detected.

According to an aspect of embodiments of this disclosure, a group presentation apparatus is provided. The group presentation apparatus includes processing circuitry configured to display, on a display of the apparatus associated with a first entity, a first page in an application. The processing circuitry is configured to display a target group name of a target group in the first page, the target group name being associated with a link tag of an entry link of the target group, the entry link being created by a second entity in the target group and associated with the target group name of the target group upon creation by the second entity. The processing circuitry is configured to detect a hover operation performed in a region of the displayed target group name on the first page. The processing circuitry is configured to display basic information of the target group in a notification window overlaying the first page based on the hover operation being detected. The processing circuitry is configured to detect a triggering operation performed on the displayed target group name on the first page. The processing circuitry is configured to display a session page of the target group based on the triggering operation being detected.

According to an aspect of embodiments of this disclosure, a non-transitory computer-readable storage medium is provided. The non-transitory computer-readable storage medium stores instructions, which when executed by a processor, cause the processor to perform a group presentation method. In the method, a first page in an application is displayed on a display of a terminal associated with a first entity. A target group name of a target group is displayed in the first page, the target group name being associated with a link tag of an entry link of the target group, the entry link being created by a second entity in the target group and associated with the target group name of the target group upon creation by the second entity. A hover operation performed in a region of the displayed target group name on the first page is detected. In the method, basic information of the target group is displayed in a notification window overlaying the first page based on the hover operation being detected. A triggering operation performed on the displayed target group name on the first page is detected. A session page of the target group is displayed based on the triggering operation being detected.

According to an aspect of embodiments of this disclosure, a group presentation method in an application is provided. The method is applied to a terminal of a first entity and includes: displaying a first page in the application, the first page including a target group name of a target group, the target group name carrying a link tag of an entry link of the target group, and the entry link being created by a second entity in the target group and associated with the target group name of the target group upon creation; displaying basic information of the target group in response to a hover operation triggered in the vicinity of the target group name; and displaying a session page of the target group in response to triggering for the link tag.

According to an aspect of embodiments of this disclosure, a group presentation apparatus in an application is provided. The apparatus is applied to a terminal of a first entity and includes: a first display module, configured to display a first page in the application, the first page including a target group name of a target group, the target group name carrying a link tag of an entry link of the target group, and the entry link being created by a second entity in the target group and associated with the target group name of the target group upon creation; a second display module, configured to display basic information of the target group in response to a hover operation triggered in the vicinity of the target group name; and a third display module, configured to display a session page of the target group in response to triggering for the link tag.

According to an aspect of embodiments of this disclosure, an electronic device is provided, including a memory and a processor. The memory has a computer program stored therein, and the processor, when executing the computer program, implements the group presentation method in an application described above.

According to an aspect of embodiments of this disclosure, a non-transitory computer-readable storage medium is provided. The storage medium has a computer program stored therein, and the computer program, when executed by a processor, implements the group presentation method in an application described above.

According to an aspect of embodiments of this disclosure, a computer program product is provided. The computer program product includes a computer program, and the computer program is read and executed by a processor of a computer device, to enable the computer device to perform the group presentation method in an application described above.

In one or more embodiments of this disclosure, when a user (a terminal of a first entity) accesses a first page having a group link (entry link), the group link in the first page is displayed as a target group name carrying a link tag. At this time, the user can intuitively recognize which group the entry link represents, making the entry link created and shared by a second entity more concrete. In addition, in one or more embodiments of this disclosure, when hovering in the vicinity of the target group name, basic group information of the target group is automatically displayed to the user. This allows the user to preview basic information of the target group without triggering the entry link and opening a session page of the target group. Based on the previewed basic information of the target group, the user can understand a type of the group and thus determine whether to enter the session page of the group. Finally, when determining to enter the session page of the group, the link tag in the first page is triggered to enter the session page of the target group, thereby improving the efficiency of group information transmission.

Other features and advantages of one or more embodiments of this disclosure will be described in the following description, and in part will become apparent from the description or will be learned through practice of one or more embodiments of this disclosure. The objectives and other advantages of one or more embodiments of this disclosure may be achieved and obtained through the examples of structures pointed out in the specification, claims, and accompanying drawings.

### BRIEF DESCRIPTION OF THE DRAWINGS

The accompanying drawings are used to provide further understanding of technical solutions of this disclosure, constitute a part of the description, are used to explain the technical solutions of this disclosure along with embodiments of this disclosure, and do not constitute a limitation to the technical solutions of this disclosure.

FIG. 1 is a diagram of a system architecture of a system to which a group presentation method in an application according to an embodiment of this disclosure is applied.

FIGS. 2A-2D are schematic diagrams illustrating a scenario where a group presentation method in an application according to an embodiment of this disclosure is applied to triggering group display based on a session group.

FIGS. 2E-2H are schematic diagrams illustrating a scenario where a group presentation method in an application according to an embodiment of this disclosure is applied to triggering group display based on announcement information.

FIG. 3 is a flowchart of a group presentation method in an application according to an embodiment of this disclosure.

FIGS. 4A and 4B are schematic diagrams illustrating an implementation process of enabling name display and disabling name display on a terminal of a first entity according to an embodiment of this disclosure.

FIGS. 5A-5C are schematic diagrams illustrating an implementation process of displaying an entry link as a target group name carrying a link tag according to an embodiment of this disclosure.

FIGS. 6A-6C are schematic diagrams illustrating an implementation process of displaying an entry link as a target group name carrying a link tag based on user preferences according to an embodiment of this disclosure.

FIG. 7 is a schematic diagram illustrating an implementation process of displaying an entry link as a target group name carrying a link tag according to an embodiment of this disclosure.

FIG. 8 is a flowchart of determining that a target group includes a terminal of a first entity according to an embodiment of this disclosure.

FIG. 9 is a flowchart of displaying a session page of a target group according to an embodiment of this disclosure.

FIGS. 10A and 10B are schematic diagrams illustrating an implementation process of displaying a session page of a target group according to an embodiment of this disclosure.

FIG. 11 is a flowchart of displaying a session page of a target group according to another embodiment of this disclosure.

FIG. 12 is a flowchart of generating an authorization response according to an embodiment of this disclosure.

FIGS. 13A-13C are schematic diagrams illustrating an implementation process of displaying a session page of a sub-group according to an embodiment of this disclosure.

FIG. 14 is an overall flowchart of displaying a session page of a target group according to an embodiment of this disclosure.

FIG. 15 is a flowchart of creating an entry link according to an embodiment of this disclosure.

FIG. 16 is a flowchart of determining that a group character string satisfies a first condition according to an embodiment of this disclosure.

FIG. 17 is a schematic structural diagram of a predetermined relationship comparison table according to an embodiment of this disclosure.

FIGS. 18A and 18B are schematic diagrams illustrating an implementation process of creating an entry link according to an embodiment of this disclosure.

FIG. 19 is an overall flowchart of creating an entry link according to an embodiment of this disclosure.

FIG. 20 is a flowchart of creating an entry link according to another embodiment of this disclosure.

FIGS. 21A and 21B are schematic diagrams illustrating an implementation process of creating an entry link according to another embodiment of this disclosure.

FIG. 22 is a flowchart of performing a second verification on a sub-group link according to an embodiment of this disclosure.

FIG. 23 is a flowchart of determining a sub-group link of each target sub-group according to an embodiment of this disclosure.

FIG. 24 is a flowchart of determining a sub-group link of each target sub-group according to another embodiment of this disclosure.

FIGS. 25A and 25B are schematic diagrams illustrating an implementation process of determining a sub-group link of each target sub-group according to another embodiment of this disclosure.

FIG. 26 is an overall flowchart of creating an entry link according to another embodiment of this disclosure.

FIG. 27 is a flowchart of displaying an entry link as a target group name carrying a link tag according to an embodiment of this disclosure.

FIG. 28 is an overall flowchart of presenting a group name and basic group information according to another embodiment of this disclosure.

FIG. 29 is a schematic diagram of implementation details of a group presentation method in an application according to an embodiment of this disclosure.

FIG. 30 is a block diagram of a group presentation apparatus in an application according to an embodiment of this disclosure.

FIG. 31 is a structural diagram of a terminal for a group presentation method in an application according to an embodiment of this disclosure.

FIG. 32 is a structural diagram of a server for a group presentation method in an application according to an embodiment of this disclosure.

### DETAILED DESCRIPTION

To describe the objectives, technical solutions, and advantages of this disclosure, the following describes this disclosure in further detail with reference to the accompanying drawings and one or more embodiments. One or more embodiments described herein are merely intended to explain this disclosure, instead of limiting this disclosure.

Before embodiments of this disclosure are described in further detail, the terms used to describe one or more embodiments of this disclosure are introduced based on the following explanations.

Descriptions of terms in this disclosure are provided as examples only and are not intended to limit the scope of the disclosure.

An application is a software program running (or being executed) on a computer or a mobile device, intended to provide users with specific functions or services. In one or more embodiments of this disclosure, a home page of the application displays names of a plurality of target groups. Each name is accompanied by (or associated with) a link tag pointing to an entry link of the group. Such entry link is created by a second entity (e.g., an administrator or a specified user) in the group and associated with the group name. When the user performs a hover operation in the vicinity of the group name, the application displays basic information of the group, such as descriptions and a quantity of members. If the user performs a triggering operation on the link tag, the application will jump to a session page of the group, allowing the user to discuss and interact with other members in the group.

### Descriptions of System Architecture and Scenarios of System to which the Embodiments of this Disclosure is Applied

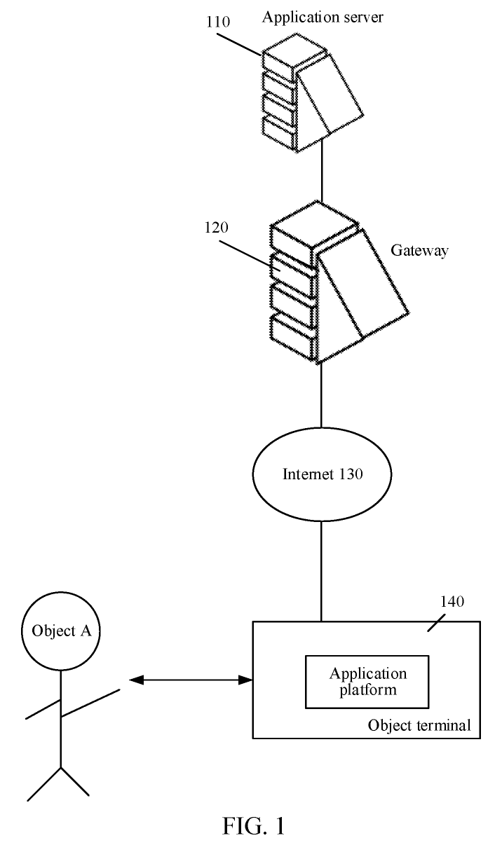

FIG. 1 is a diagram of an architecture of a system to which a group presentation method in an application according to an embodiment of this disclosure is applied. The system includes an object terminal 140, Internet 130, a gateway 120, an application server 110, and the like.

The object terminal 140 is in various forms such as a desktop computer, a laptop computer, a personal digital assistant (PDA), a mobile phone, an in-vehicle terminal, a home theater terminal, and a dedicated terminal. In addition, the object terminal may be a single device or a collection of a plurality of devices. The object terminal 140 may communicate with the Internet 130 in a wired or wireless manner to exchange data. The object terminal 140 has an application platform. The application platform is used by each object terminal to perform operations such as social activities, resource interaction, and information interaction.

The application server 110 is a computer system that provides some services for the object terminal 140. Compared with the ordinary object terminal 140, the application server 110 has higher requirements in aspects such as stability, security, and performance. The application server 110 may be a high-performance computer, a cluster of a plurality of high-performance computers, a part (e.g., a virtual machine) spared from a high-performance computer, a combination of a part (e.g., a virtual machine) spared from a plurality of high-performance computers, or the like in a network platform. The application server 110 includes a plurality of types of services. Implementation of each service of the application server 110 is usually associated with some intermediate databases, storage media, or the like. The application server 110 is configured to create a link for at least one group according to a group link creation operation of an object terminal and determine a manner of displaying the group link to other object terminals. The application server 110 is further configured to display group information of the group, a session window of the group, or the like according to an interaction operation of the other object terminals.

The gateway 120 is also referred to as an inter-network connector or a protocol converter. The gateway implements network interconnection on a transport layer and is a computer system or device providing a conversion function. The gateway is a translator between two systems that use different communication protocols, data formats, or languages, or even substantially different architectures. Meanwhile, the gateway may provide filtering and security functions. A message transmitted by the object terminal 140 to the application server 110 may be transmitted to the corresponding server through the gateway 120. A message transmitted by the application server 110 to the object terminal 140 may also be transmitted to the corresponding object terminal 140 through the gateway 120.

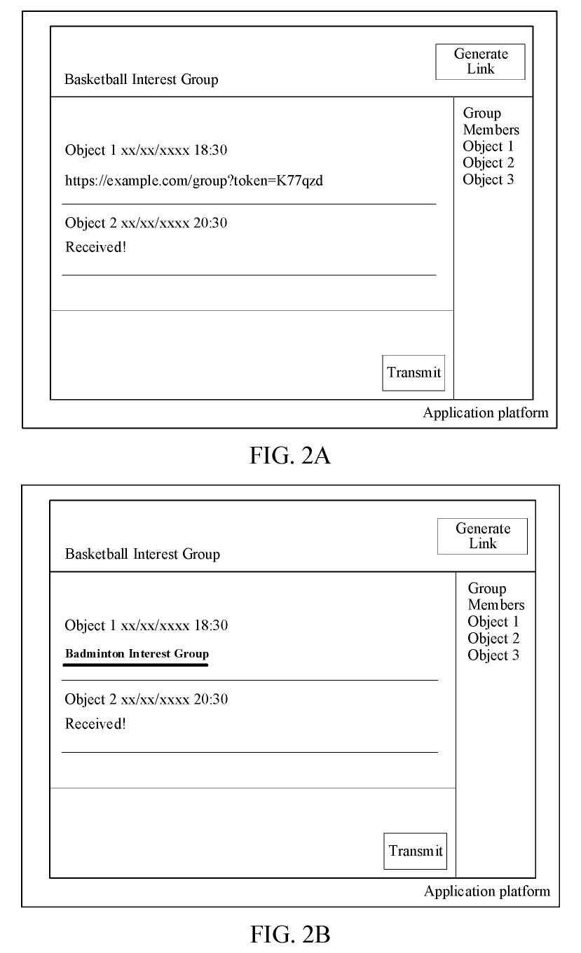

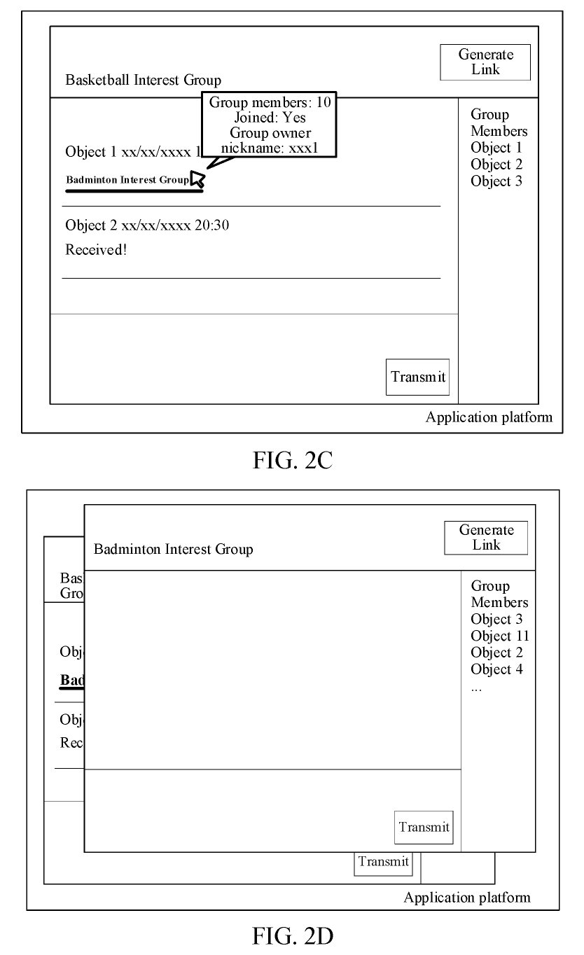

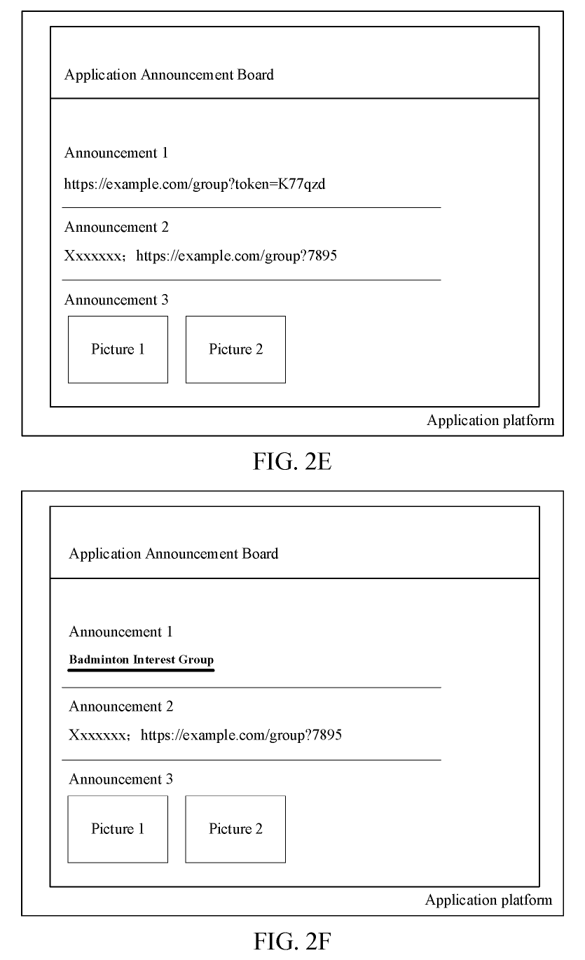

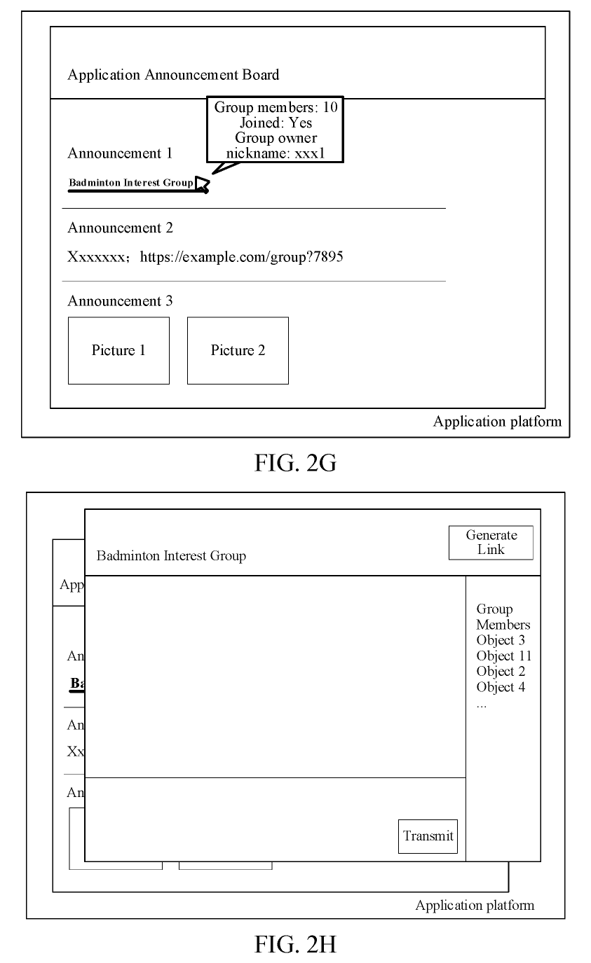

Embodiments of this disclosure may be applied to various scenarios, such as a scenario of triggering group display based on a session group as shown in FIGS. 2A-2D and a scenario of triggering group display based on announcement information as shown in FIGS. 2E-2H.

As shown in FIG. 2A, in a group "Basketball Interest Group" on an application platform, group members include object 1, object 2, and object 3. At this time, object 1 transmits a session message "https://example.com/group?token=K77qzd" in a session page of the basketball interest group, where the session message is a group link of group A shared by object 1.

As shown in FIG. 2B, group members include object 1, object 2, and object 3. When object 3 logs into the application platform and opens the session page of the basketball interest group, the group link previously transmitted by object 1 is displayed as a group name of group A carrying a link tag, and the group name of group A is "Badminton Interest Group". "Received" was previously transmitted by object 2, where the link tag refers to an interactive underline located below the group name "Badminton Interest Group".

As shown in FIG. 2C, group members include object 1, object 2, and object 3. When object 3 hovers a mouse over "Badminton Interest Group" in the session page of the basketball interest group, a notification window is displayed in the session page, where the notification window contains information such as "Group members: 10; Joined: Yes; Group owner nickname: xxx1". Based on this, object 3 clicks/taps the group name "Badminton Interest Group" and triggers the link tag to open a session page of the badminton interest group.

As shown in FIG. 2D, group members include object 3, object 11, object 3, and object 4. After object 3 double-clicks/double-taps the group name "Badminton Interest Group" and triggers the link tag, a new session window is displayed in the application platform, where the session window is the session page of the badminton interest group.

FIGS. 2A-2D illustrate a situation where group links shared by various objects are displayed and previewed in a session page of an application, enabling an object to know a group name shared by other objects according to a group link shared by other objects in the session page, and to know basic information of the group without entering the session page of the group. The object may further directly navigate to the session page of the group according to the group link, thereby improving the efficiency of group search.

FIG. 2E shows a page of an application bulletin board of an application platform. A plurality of pieces of announcement information released by different objects at different times are displayed on the page. Announcement 1 includes link information "https://example.com/group?token=K77qzd". Announcement 2 includes text information "Xxxxxxx" and link information "https://example.com/group?7895". Announcement 3 includes picture information of picture 1 and picture 2. The link information of announcement 1 meets format requirements of a group link of a group, and the link of announcement 1 is an entry link indicating access to group A. The link information of announcement 2 does not meet the format requirements of the group link and is an ordinary link.

As shown in FIG. 2F, when an object opens an application bulletin board on an application platform, three announcements are displayed on a page of the application bulletin board. Link information of announcement 1 is displayed as a group name of group A carrying a link tag, and the group name of group A is "Badminton Interest Group". Announcement 2 is still displayed as text information "Xxxxxxx" and link information "https://example.com/group?7895". Announcement 3 is still displayed as picture information composed of picture 1 and picture 2.

As shown in FIG. 2G, when an object hovers a mouse over "Badminton Interest Group" of announcement 1 in a page of an application bulletin board, a notification window is displayed on the page of the application bulletin board, where the notification window contains information such as "Group members: 10; Joined: Yes; Group owner nickname: xxx1". Based on this, the object clicks/taps the group name "Badminton Interest Group" and triggers the link tag to open a session page of the badminton interest group.

As shown in FIG. 2H, after an object double-clicks/double-taps a group name "Badminton Interest Group" and triggers a link tag, a session window is displayed on a page of an application bulletin board. The session window is a session page of the badminton interest group.

FIGS. 2E-2H illustrate a situation where group links shared by various objects are displayed and previewed in a group announcement page of an application, enabling an object to know, according to a group link displayed in an announcement, a group name of a group indicated by the group link on the group announcement page, and to know basic information of the group without entering a session page of the group.

The group presentation method according to one or more embodiments of this disclosure supports previewing group information related to group links shared by other objects in a plurality of scenarios such as a session window, a group announcement, a document, or favorite content, making display scenarios of group information more diversified. In addition, the group presentation method according to one or more embodiments of this disclosure provides group sharing and preview functions, thereby improving the transmission efficiency of group information.

### Overall Description of Embodiments of this Disclosure

According to an embodiment of this disclosure, a group presentation method in an application is provided. The method is applied to a terminal of a first entity (e.g., a first user).

The group presentation method in an application is typically applied to scenarios such as group sharing and group presentation in an application, for example, group display scenarios shown in FIGS. 2A-2D and FIGS. 2E-2H. Embodiments of this disclosure provide a solution that sets an entry link for each group, allowing an object to preview group information before joining the group based on the entry link, thereby improving information transmission efficiency.

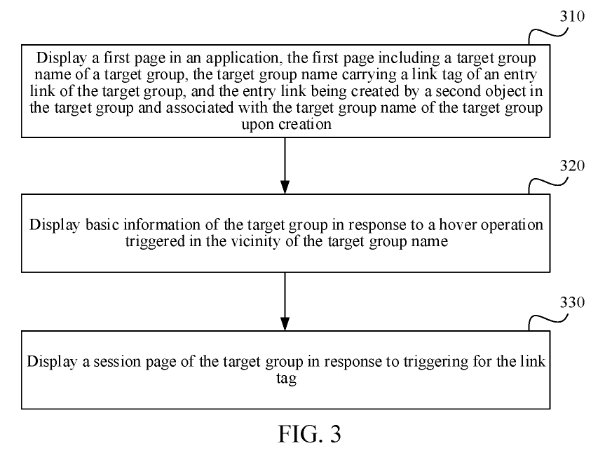

As shown in FIG. 3, a group presentation method in an application according to an embodiment of this disclosure may include:

Operation 310: Display a first page in an application, the first page including a target group name of a target group, the target group name carrying a link tag of an entry link of the target group, and the entry link being created by a second entity in the target group and associated with the target group name of the target group upon creation.

Operation 320: Display basic information of the target group in response to a hover operation triggered in the vicinity of the target group name.

Operation 330: Display a session page of the target group in response to triggering for the link tag.

The following describes operations 310 to 330 in further detail.

In operation 310, a first page is displayed in an application, where the first page includes a target group name of a target group, the target group name carries a link tag of an entry link of the target group, and the entry link is created by a second entity (e.g., a second user) in the target group and associated with the target group name of the target group upon creation.

The first page is a content page in the application. The first page includes the entry link of the target group.

The target group refers to a group formed by respective object terminals that have been successfully registered in the application and have the same or similar characteristics. For example, the target group may be a group formed by a plurality of objects with the same hobbies and interests, or a group formed by a plurality of objects performing the same task.

The entry link is a character string composed of a fixed-format character string and a random character string corresponding to each group. The entry link is configured to connect to a session page of the target group, so that an object can quickly navigate to or access the session page of the target group.

The second entity is another successfully registered object terminal in the application that is different from a terminal of the first entity.

The target group name is configured to indicate title content of the target group, and the target group name is configured to distinguish the target group from other groups.

The link tag is provided for the object to trigger the entry link of the target group, so as to access or join the session page of the target group.

In some embodiments, the first page is a content page in the application, which includes the target group name of the target group. The name is a link tag pointing to an entry link. The entry link is created by the second entity of the target group and associated with the target group name upon creation. The target group refers to a group formed by respective object terminals that have been successfully registered in the application and have the same or similar characteristics. For example, the target group may be a group formed by a plurality of objects with the same hobbies and interests, or a group formed by a plurality of objects performing the same task.

In some embodiments, the entry link is a character string composed of a fixed-format character string and a random character string corresponding to each group. The entry link is connected to a session page of the target group, so that an object can quickly navigate to or access the session page of the target group. The second entity is another successfully registered object terminal in the application that is different from a terminal of the first entity. The target group name is configured to indicate title content of the target group, and is configured to distinguish the target group from other groups. The link tag is provided for the object to trigger the entry link of the target group, so as to access or join the session page of the target group.

As an example, in a social media application, the first page may be a news feed page including target group names of groups followed by a user. These names carry link tags of entry links, and the entry links are created by an administrator (second entity) of the group and associated with the group names upon creation. The first page is a content page in the application, which includes an entry link of a group. The group may be an interest group formed by users with the same hobbies and interests, or a project group formed by users performing the same task. The entry link is a character string composed of a fixed-format character string and a random character string corresponding to each group. The entry link is connected to a session page of the group, so that a user can quickly navigate to or access the session page of the group. The second entity is another successfully registered object terminal in the application that is different from a terminal of the first entity. The group name is configured to indicate title content of the group, and is configured to distinguish the group from other groups. The link tag is provided for the user to trigger the entry link of the group, so as to access or join the session page of the group.

For example, the link tag may be an underline below the group name of the group, or a graphical interactive control before the group name or after the group name.

In an implementation of some aspects, when the terminal of the first entity accesses the application and opens any content page in the application, a server displays the content page to be accessed by the terminal of the first entity as a first page in the application with authorization and permission. The first page may include information such as text, pictures, videos, or an entry link of a target group.

In some embodiments, if a display form of the entry link in the first page is retained when an object browses the first page, directly displaying the entry link still prevents the object from intuitively knowing a type of a group indicated by the entry link. Based on this, when the server determines that the entry link in the first page is created by the second entity of the target group and is associated with a target group name of the target group upon creation, the entry link is displayed as the target group name carrying a link tag in the first page in the application, so that the first page viewed by the terminal of the first entity includes the target group name, where the target group name carries the link tag of the entry link of the target group. This enables the object to intuitively know the type of the group indicated by the entry link according to the target group name, and provides the link tag for the object to trigger and access a session page of the group.

To save space, a specific process of creating an entry link and a specific process of displaying an entry link as a target group name carrying a link tag according to embodiments of this disclosure will be described in further detail below and will not be repeated here.

In this way, the first page is displayed in the application, where the name and entry link of the target group are included. This design may improve convenience for users to participate in group activities by providing an intuitive and easily accessible interface. The link tag of the target group name not only clarifies the theme and purpose of the group, but also simplifies operations for a user to navigate to the session page of the group through the associated entry link. Based on behavior analysis and interface design principles, this design reduces complexity and time of user operations and improves user experience. The combination of the fixed format and the random character string of the entry link helps ensure security and uniqueness of the link, prevents unauthorized access, and also facilitates detection and management of access traffic of the group. Participation of the second entity in creating the entry link increases social interaction of the group and flexibility of management, enabling the group to better adapt to needs and preferences of different users. Overall, through technical arrangement, this design optimizes the user interface and enhances social interaction, thereby improving attractiveness and user satisfaction of the application.

In operation 320, basic information of the target group is displayed in response to a hover operation triggered in the vicinity of the target group name.

In some embodiments, the hover operation triggered in the vicinity of the target group name refers to a hover operation triggered in a target region of the first page. The target region is a region on the first page where a distance from a display position of the target group name is less than a distance threshold. The basic information is configured to notify the first entity whether to trigger the link tag.

A target object refers to an object for interacting with a page of the application. For example, a mouse, a stylus, a user's finger, and the like all fall within the scope of the target object.

The vicinity of the target group name refers to a region range in which the server may sense and confirm that a hover operation of the target object is valid.

In some embodiments, the first page in the application includes a name of a target group. There is a specific target region in the vicinity of the name. When a user uses a target object (e.g., a mouse, a stylus, or a finger) to perform a hover operation in the target region on the first page, the application responds to the operation and displays basic information of the target group. The basic information is intended to notify the user whether to trigger the link tag to access or join the session page of the target group.

In some embodiments, the target region is defined based on a display position of the target group name. Specifically, the target region is a region where a distance from the display position of the name is less than a preset distance threshold. The distance threshold is set by an application developer according to user experience and design requirements, so as to help ensure that the user can conveniently obtain basic information of the group when operating near the position of the target group name.

In some embodiments, when the target object of the user hovers in the target region for a period of time (typically set by the application), the application detects the hover operation and triggers display of the basic information of the target group. The information may include a group description, a quantity of members, latest activities, and the like, helping the user understand the content and activity of the group and thus decide whether to access or join the group.

As an example, the first page is a dynamic news feed page displaying names of various groups followed by the user. There is a target region in the vicinity of each group name. When the user hovers a mouse over the region, the application displays basic information of the group. For example, if the user hovers the mouse near a group name "Photography Enthusiasts", a notification box pops up on a screen showing a group description (e.g., "Welcome all friends who love photography to join, share your photographic works, and discuss photography skills. "), current members (e.g., "5000+ members"), and the latest activity of the group (e.g., "Latest photo share: beautiful sunset photo"). The basic information helps the user quickly understand the content and activity of the group and decide whether to click/tap a group name link to join the group or view detailed information of the group. This design not only improves user interaction experience but also increases visibility and attractiveness of the group, encouraging the user to participate in more social activities. Meanwhile, the possibility of accidental clicks/taps on the group name by the user is also reduced, and the usability and user satisfaction of the application are improved.

For example, the vicinity of the target group name, namely the target region, may be defined as a rectangular region range formed by outwardly expanding four sides of an external rectangle of the target group name at an equal distance.

The hover operation refers to keeping the target object at a current position unchanged for a particular duration. The hover operation includes, but is not limited to, hovering, long-pressing, and other operations.

The basic information of the target group is configured to indicate specific content of the target group. For example, the number of group members of the target group, a group type, a group creation date, an object with management permission in the group, and the like all fall within the scope of the basic information of the target group.

In some embodiments, the basic information of the target group is data about the group and provides an overview and basic attributes of the group. The information generally includes the number of group members, which reflects the scale and activity of the group. The group type is, for example, an interest group, a work team, a study group, or the like, which helps the user understand the nature and purpose of the group. The group creation date shows how long the group has existed and sometimes reflects the maturity and stability of the group. And the object with management permission in the group indicates an administrator or person in charge of the group who is responsible for maintaining group order and managing group content. The basic information is useful for the user, as the information helps the user quickly evaluate whether the user expects to join or participate in a group, and also provides basic information required by group administrators for group management.

In an implementation of some aspects, for interaction requirements, the terminal of the first entity may control the target object to hover at any position of an interface of the application. Based on this, when the terminal of the first entity views the target group name displayed with a link tag in the application, the terminal of the first entity may control the target object to hover in the vicinity of the target group name, so that the server detects a hover state of the target object. Next, the server obtains a hover position of the target object on the interface of the application.

In some embodiments, the server identifies whether the hover position of the target object is within a predefined range in the vicinity of the target group name. Until a hover duration of the target object in the vicinity of the target group name reaches a predetermined value, basic group information of the target group is extracted, and the basic group information of the target group is displayed in a form of a message window on the interface of the application, so that the terminal of the first entity understands a type of the target group without joining the target group.

In this way, in the application, when the target object of the user performs a hover operation in the target region on the first page, the system displays basic information of the target group. By providing a detailed overview of the group, the user is helped to quickly understand the content and nature of the group without leaving the current page. This not only improves user experience and reduces the need for the user to jump between different pages, but also increases the possibility of the user participating in group activities. This interaction mode also improves information visibility, enables group administrators to manage groups more effectively, helps prevent accidental clicks/taps, and improves the usability and user satisfaction of the application.

In operation 330, a session page of the target group is displayed in response to triggering for the link tag.

The session page refers to a window for members of the target group to conduct session communication.

In an implementation of some aspects, when an object intends to access the target group, the object triggers the link tag in the application. Based on this, the server receives a trigger operation on the link tag performed by the object, and displays the session page of the target group in the application, so that the object can view session content of each member of the target group and conduct session communication with the members of the target group on the session page.

In some embodiments, when a user triggers the link tag next to the target group name on the first page in the application, the application responds to the operation and displays the session page of the target group. The session page is a specially designed window for members of the group to conduct real-time or asynchronous session discussions. In an implementation, when the user intends to access the target group, the user clicks/taps or touches the link tag in the application. Once the user triggers the link tag, the application transmits the operation to the server. After receiving the trigger operation, session page data of the target group associated with the link tag is retrieved. Such data may include a list of group members, historical session records, states of currently online members, and the like. The server transmits the data back to the application, and the application renders the session page of the target group on a device of the user. The user may now view session content of group members on this page, including latest messages and historical records. In addition, the user may input own messages on the session page to discuss with other group members in real time.

To save space, a specific process of displaying a session page of a target group according to embodiments of this disclosure will be described in further detail below and will not be repeated here.

Through the foregoing operations 310 to 330, in one or more embodiments of this disclosure, when a user (a terminal of a first entity) accesses a first page having a group link (entry link), the group link in the first page is displayed as a target group name carrying a link tag. At this time, the user can intuitively recognize which group the entry link represents, making the entry link created and shared by a second entity more concrete. In addition, in one or more embodiments of this disclosure, when the user hovers in the vicinity of the target group name using a target object (a mouse or a stylus), basic group information of the target group is automatically displayed to the user. This allows the user to preview basic information of the target group without triggering the entry link and opening a session page of the target group. Based on the previewed basic information of the target group, the user can understand a type of the group and thus determine whether to enter the session page of the group. Finally, when determining to enter the session page of the group, the link tag in the first page is triggered to enter the session page of the target group, thereby improving the efficiency of group information transmission.

Operations 310 to 340 are described generally above. The implementation of operation 310, operation 320, and operation 330 will be described in further detail below.

### Detailed Descriptions of Operation 310

In operation 310, a first page is displayed in an application, where the first page includes a target group name of a target group, the target group name carries a link tag of an entry link of the target group, and the entry link is created by a second entity in the target group and associated with the target group name of the target group upon creation. In some examples, a first page in an application is displayed on a display of a terminal associated with a first entity. In some examples, a target group name of a target group is displayed in the first page, the target group name being associated with a link tag of an entry link of the target group, and the entry link being created by a second entity in the target group and associated with the target group name of the target group upon creation by the second entity.

Since the security levels of various object terminals in the application are different, directly displaying an entry link as a target group name carrying a link tag may reduce the security of some relatively private groups in the application. Based on this, this disclosure provides a solution for controlling a display form of an entry link based on a setting operation performed by a second entity during creation, which can improve the display diversity of entry links and further improve the security of information display.

In some embodiments, the first page in the application is typically a content-rich page that includes names of a plurality of target groups. A link tag of an entry link is provided beside each name, and a user can access a corresponding group session page by clicking/tapping or touching such link tag. Such entry link is created by a second entity in the group (typically a group administrator or creator) and associated with the group name during creation. However, considering that the security of various object terminals in the application may vary, especially for some relatively private groups, directly displaying an entry link as a target group name carrying a link tag may bring security risks. For example, this may make it easier for unauthorized users to discover and join these private groups, thereby leaking sensitive information or undermining group privacy.

In some embodiments, this disclosure proposes a solution for controlling a display form of an entry link based on a setting operation performed by a second entity during creation. Specifically, a group administrator may select different display forms of entry links according to the privacy settings and security requirements of the group. For example, the administrator may select to hide the entry link which is displayed only after a specific operation or permission verification. Alternatively, the administrator may select to display the entry link in an encrypted or obfuscated form to reduce the risk of being discovered by unauthorized users. This solution improves the display diversity of entry links, allowing the group administrator to flexibly control the visibility and access mode of entry links according to different group requirements and security conditions. Furthermore, this also helps improve the security of information display and protect the privacy and security of group members. In this way, the application can provide a convenient group access function while helping ensure the security and privacy of groups.

In some embodiments, the target group name of the first page in operation 310 is determined in the following manner:
constructing, if the entry link is created by the second entity of the target group and associated with the target group name upon creation, and name display has been enabled for the terminal of the first entity, the link tag of the entry link as the target group name.

In some examples, the link tag of the entry link is determined as the target group name when the second entity enables name display of the target group for the terminal associated with the first entity upon creation of the entry link of the target group.

Enabling name display means displaying the entry link as a target group name carrying a link tag when the first page is displayed on the terminal of the first entity, whereas disabling name display means displaying the entry link in an original link form when the first page is displayed on the terminal of the first entity.

In an implementation of some aspects, when the second entity creates an entry link of the target group and associates the entry link with the target group name, if the group name of the target group is expected to be visible only to some fixed object terminals, the second entity may add, in a setting interface for creating the entry link, terminal names or terminal identifiers of object terminals that are allowed to directly view the target group name through the entry link to an editing region for enabling name display. Based on this, when the terminal name or terminal identifier of the first entity is added to the editing region for enabling name display, the entry link on the first page is directly displayed as a target group name carrying a link tag instead of the original form of the entry link when the terminal of the first entity accesses the first page. When the terminal name or terminal identifier of the first entity is not added to the editing region for enabling name display, the entry link on the first page retains an original display form and is still displayed as common link information when the terminal of the first entity accesses the first page.

In some embodiments, in the application, when an entry link is created by a second entity (e.g., a group administrator) of the target group, the second entity may select whether to enable name display for the terminal of the first entity during creation. If name display is enabled, the link tag of the entry link is constructed as the target group name, which means that when the first page is viewed on the terminal of the first entity, a group name carrying a link tag instead of the original link form will be viewed. In the setting interface for creating the entry link, the second entity may specify terminal names or terminal identifiers that are allowed to view the group name. These terminal names or terminal identifiers are typically associated with specific users or devices. If the terminal name or terminal identifier of the first entity is added to the editing region for enabling name display, the entry link is displayed as a target group name carrying a link tag when the first entity accesses the first page, and the user may directly click/tap or touch the link to access a group session page. Conversely, if the terminal name or terminal identifier of the first entity is not added to the editing region for enabling name display, the entry link retains an original link form and is displayed as common link information instead of a group name. This design allows a group administrator to control which users or devices can access a group in a more intuitive manner, thereby improving the display diversity of entry links and the security of information display. The application can flexibly control a display form of entry links according to settings of the group administrator, thereby not only helping ensure the privacy and security of the group but also providing a more convenient and intuitive group access manner for specific users.

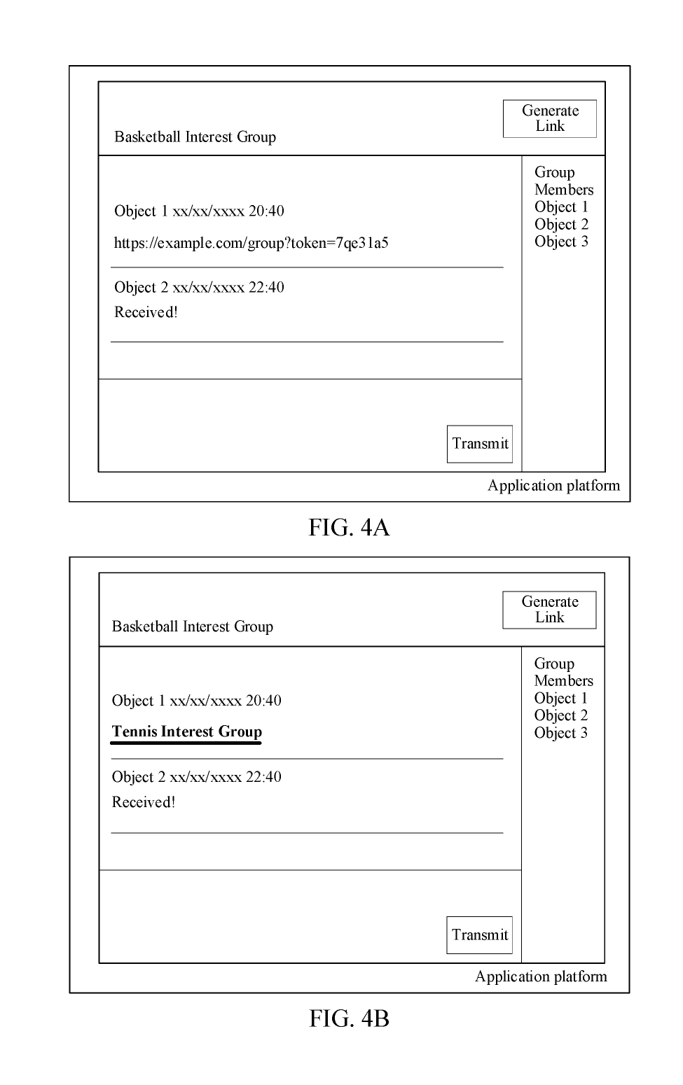

As an example, as shown in FIG. 4A, when object 1 creates an entry link "https://example.com/group?token=7qe31a5" for a tennis interest group, name display is not enabled for object 3. At this time, when object 3 accesses a session page of a basketball interest group, only common link information "https://example.com/group?token=7qe31a5" transmitted by object 1 is displayed on the session page, and object 3 may not directly know what the link information indicates.

As an example, as shown in FIG. 4B, when object 1 creates an entry link "https://example.com/group?token=7qe31a5" for a tennis interest group, name display is enabled for object 3. At this time, when object 3 accesses a session page of a basketball interest group, content transmitted by object 1 displayed on the session page is a group name carrying a link tag of the tennis interest group, and object 3 may directly know that what object 1 shares is a link channel for joining the tennis interest group. Based on this, object 3 may select whether to join the tennis interest group through the group name carrying the link tag according to own needs.

As an example, it is assumed that there is a group named "Photography Enthusiasts", and a group administrator (second entity) creates an entry link and associates the entry link with the group name. The administrator expects only specific user terminals to be able to view the group name, while other users may only view an original link form. In a setting interface for creating the entry link, the administrator adds terminal names or terminal identifiers of user terminals that are allowed to view the group name to an editing region for enabling name display. For example, the administrator adds terminal identifiers of user A and user B. When user A and user B access the first page of the application, the users may see the group name "Photography Enthusiasts" with a link tag beside the name on the page. The users may click/tap or touch the name to directly enter the session page of the group. If the terminal name or terminal identifier of user C is not added to the editing region for enabling name display, user C only sees common link information instead of the group name when accessing the first page. User C may click/tap the link to enter the session page of the group. This enables the group administrator to control which users can access a group in a more intuitive manner while maintaining the privacy and security of the group. Authorized users may join and participate in group activities more conveniently. Unauthorized users may perform additional operations to access the group. This helps protect the privacy and security of the group.

An advantage of some aspects is that a display form of an entry link is controlled according to a setting operation performed by the second entity during creation. When the terminal of the first entity is set by the second entity as an object terminal for which name display is enabled, the terminal of the first entity directly receives the target group name of the group indicated by the entry link when accessing the first page, and more intuitively knows the meaning of the entry link. When the terminal of the first entity is not set by the second entity as an object terminal for which name display is enabled, the entry link viewed by the terminal of the first entity when accessing the first page is only a common link, and the underlying meaning may not be intuitively known. This manner can improve the display diversity of entry links and further improve the security of information display.

Since different object terminals in the application have different levels of understanding and demand for a target group, displaying a target group name of the target group on the first page in a fixed form usually results in low flexibility of group presentation. Based on this, this disclosure provides a solution for indicating the same group with different target group names for different objects, to improve the flexibility of group presentation information.

In some embodiments, the target group name of the first page in operation 310 is determined in the following manner:
determining a group name specified for the terminal of the first entity by the second entity when creating the entry link as the target group name corresponding to the terminal of the first entity, the second entity specifying different group names for different object terminals when creating the entry link.

In some examples, a group name specified for the terminal associated with the first entity is determined as the target group name, the group name being specified by the second entity upon creation of the entry link of the target group, different group names being specified by the second entity for different terminals upon creation of the entry link of the target group.

In an implementation of some aspects, when the second entity creates an entry link of a target group and associates the entry link with a target group name, the target group is set to be displayed with different target group names carrying link tags for different objects through the entry link, and a type of the target group name viewed by each object is also set, so as to specify different target group names for different object terminals. Based on this, when the terminal of the first entity accesses the first page, the entry link is displayed as a target group name corresponding to the terminal of the first entity according to settings of the second entity.

In some embodiments, in the application, when a second entity (e.g., a group administrator) creates an entry link, the second entity may specify different group names for different object terminals. This means that when different users access the first page, different group names may be shown depending on the settings of the second entity. In a setting interface for creating the entry link, the second entity may specify a unique group name for each object terminal. For example, the second entity may specify "Photography Club" for a terminal of user A and "Photography Community" for a terminal of user B, even though the two names point to the same target group. When the terminal of the first entity accesses the first page, the application may display the entry link as a target group name corresponding to the terminal of the first entity according to settings of the second entity. For example, if the first entity is user A, the user sees the group name "Photography Club" carrying a link tag on the first page. If the first entity is user B, the user sees the group name "Photography Community" carrying a link tag on the first page. This allows a group administrator to flexibly present group names for different users or devices, thereby improving user experience and group attractiveness. Meanwhile, a personalized manner is also provided for the group administrator to interact and communicate with different user groups. In this way, the application can better meet the needs and preferences of different users and enhance user engagement and satisfaction.

When specifying different target group names for different object terminals, the second entity may set a different target group name for each object so that different objects may see different target group names, or may set different group names by grouping so that objects in the same group see the same target group name while objects in different groups see different target group names.

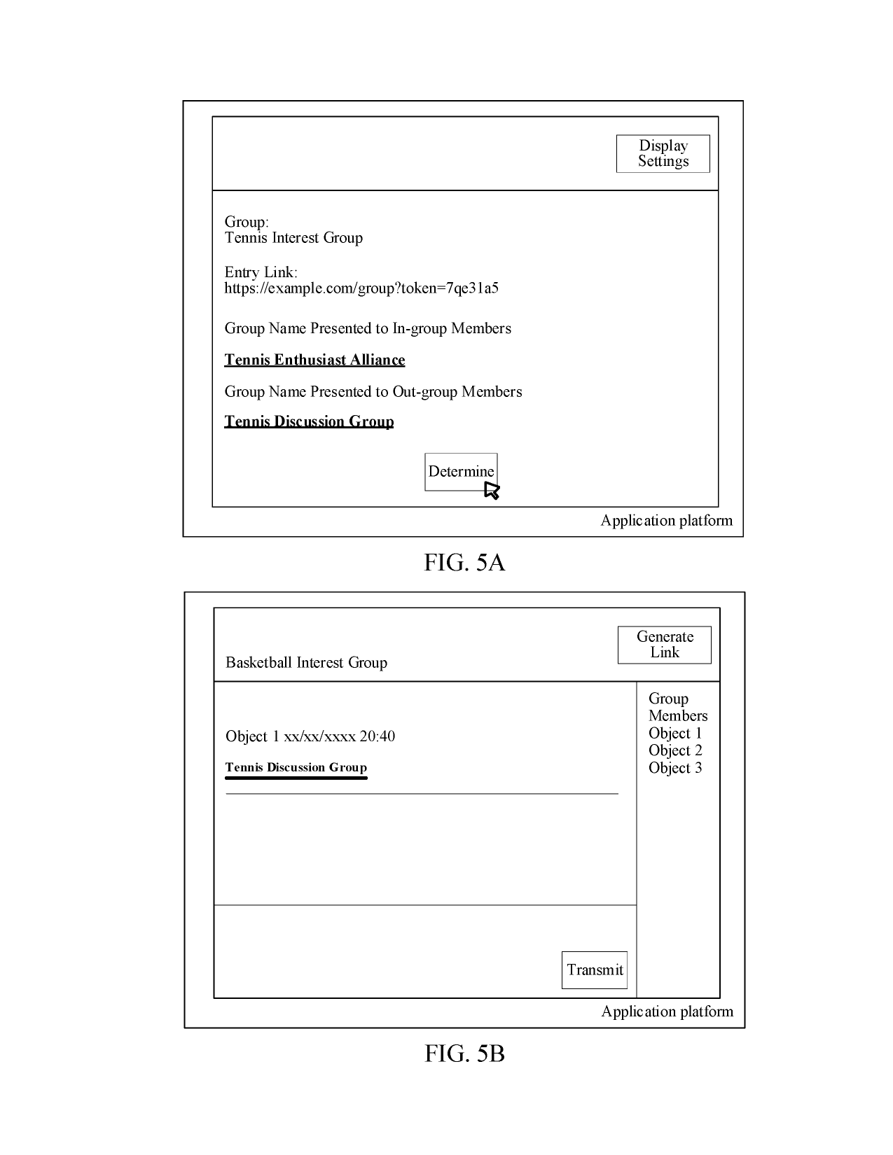

As shown in FIG. 5A, when object 1 creates an entry link for a tennis interest group, display settings is made for the entry link on an application platform. In a display setting page, the entry link of the tennis interest group is set to "https://example.com/group?token=7qe31a5". Next, object 1 sets, through the entry link of the tennis interest group, a group name presented to in-group members as "Tennis Enthusiasts Alliance", and a group name presented to in-group members as "Tennis Discussion Group".

As shown in FIG. 5B, group members include object 1, object 2, and object 3, where object 2 is not a group member of a tennis interest group. When object 2 accesses a session page of a basketball interest group, content transmitted by object 1 displayed on the session page is a group name carrying a link tag of the tennis interest group. At this time, the group name carrying the link tag is "Tennis Discussion Group".

As shown in FIG. 5C, group members include object 1, object 2, and object 3, where object 3 is a group member of a tennis interest group. When object 2 accesses a session page of a basketball interest group, content transmitted by object 1 displayed on the session page is a group name carrying a link tag of the tennis interest group. At this time, the group name carrying the link tag is "Tennis Enthusiasts Alliance".

As an example, it is assumed that there is a group named "Fitness Fanatics", and a group administrator (second entity) creates an entry link and associates the entry link with the group name. The administrator expects to specify different group names for different user terminals according to user interests and preferences. In a setting interface for creating the entry link, the administrator may specify a unique group name for each object terminal. For example, the administrator may specify "Yoga Enthusiasts" for user terminals that prefer yoga, "Strength Training Fanatics" for user terminals that prefer strength training, and "Aerobic Exercise Enthusiasts" for user terminals that prefer aerobic exercise, even though the three names point to the same target group. When a terminal of user A (who prefers yoga) accesses the first page of the application, the user may see the group name "Yoga Enthusiasts" with a link tag on the page. User A may click/tap or touch the name to directly enter the session page of the group. When a terminal of user B (who prefers strength training) accesses the first page, the user may see the group name "Strength Training Fanatics" with a link tag on the page. User B may click/tap or touch the name to directly enter the session page of the group. When a terminal of user C (who prefers aerobic exercise) accesses the first page, the user may see the group name "Aerobic Exercise Enthusiasts" with a link tag on the page. User C may click/tap or touch the name to directly enter the session page of the group. This design enables a group administrator to flexibly present group names according to user interests and preferences, thereby improving user experience and group attractiveness. Meanwhile, a personalized manner is also provided for the group administrator to interact and communicate with different user groups. In this way, the application can better meet the needs and preferences of different users and enhance user engagement and satisfaction.

An advantage of some aspects is that when a second entity creates an entry link of a target group, a channel is provided for setting different target group names for different object terminals, so that the second entity may specify different target group names for different objects as required, and indicate the same group with different target group names for different objects, thereby improving the flexibility of group presentation information.

Different objects have different preferences for group naming. For example, some objects prefer a concise display of group names, while other objects prefer a specific display of group names. In addition, different objects have different preferences for formats such as fonts and font sizes when displaying group names. For example, some groups need group names to be displayed in a larger font size to help the group clearly determine a group indicated by the group name. Based on this, this disclosure provides a solution for controlling a display form of an entry link according to object preferences during creation by a second entity, to make displayed target group names more fit the preferences of various objects and improve the display diversity of entry links.

In some embodiments, the target group name of the first page in operation 310 is determined in the following manner:
determining, among a plurality of candidate group names, a candidate group name corresponding to a first preference of the terminal of the first entity as the target group name, the plurality of candidate group names being associated with the entry link when the second entity creates the entry link.

In some examples, a candidate group name corresponding to a first preference of the terminal associated with the first entity among a plurality of candidate group names is determined as the target group name, the plurality of candidate group names being associated with the entry link by the second entity upon creation of the entry link of the target group.

The first preference is configured to indicate habits and preferences of an object of the terminal of the first entity in group name display, where the first preference includes, but is not limited to, preferences of the object for a font, a font size, a format, and the like during group name display.

The candidate group names are configured to indicate different naming manners for the same target group.

In some embodiments, in the application, when a second entity (e.g., a group administrator) creates an entry link, the second entity may set a plurality of candidate group names for the same target group. These candidate group names represent different naming manners for the same group and are intended to meet the preferences of different users in group name display. These preferences include, but are not limited to, a font type, a font size, a format, and the like.

In some embodiments, the application first collects group name display preferences of the terminal of the first entity. This is typically determined according to user settings or usage habits in the application. For example, a user may select a specific font and font size in settings, or frequently select a particular display format in past use. Next, the application analyzes these preferences and matches the preferences with a plurality of candidate group names set by the second entity for the entry link. Each candidate group name may have different display settings, such as a different font, font size, or format. The goal of the application is to find a candidate group name that best matches the first preference. Once a matching candidate group name is found, the application displays this name as a target group name on the terminal of the first entity. In this way, the first entity may see a group name that conforms to the own display preferences, thereby improving user experience and satisfaction. The group names can be presented according to personalized user needs, thereby enhancing user interactivity and satisfaction with the application. Meanwhile, the attention and responsiveness of the application to personalized user needs are also presented, to improve the overall user experience of the application.

As an example, it is assumed that there is a group named "Food Discussion", and a group administrator (second entity) creates an entry link and sets a plurality of candidate group names for the entry link to adapt to display preferences of different users. These candidate group names include: "Gourmet", in an elegant font and a larger font size, suitable for users who prefer a formal style; "Foodie Paradise", in a lively font and a medium font size, suitable for young users who prefer a relaxed style; and "Cooking World", in a professional font and a smaller font size, suitable for users interested in cooking and technical details. Each candidate group name corresponds to different display settings to meet the preferences of different users.

As an example, when a first entity (user A) accesses the first page of the application, the application detects preference settings of a terminal of user A. It is assumed that user A prefers a formal font and a larger font size. Therefore, the application displays "Gourmet" as a target group name on the terminal of user A. When a second entity (user B) accesses the first page, the application detects that user B prefers a lively font and a medium font size. Therefore, the application displays "Foodie Paradise" as a target group name on a terminal of user B. When a third entity (user C) accesses the first page, the application detects that user C prefers a professional font and a smaller font size. Therefore, the application displays "Cooking World" as a target group name on the terminal of user C. The group administrator can provide personalized group name display for each user according to user display preferences, thereby improving user satisfaction and engagement. Meanwhile, the attention and responsiveness of the application to personalized user needs are also presented.

In an implementation of some aspects, when the second entity creates an entry link of a target group and associates the entry link with a target group name, different objects have different display preferences for group names. First, group display parameters set by each object in the application are obtained from background logs of the server with authorization and permission, where the group display parameters include a display font, a font size, a display mode, and the like of a group name. Next, objects with group display parameter similarity greater than a predetermined threshold are included in the same set, and a candidate group name corresponding to the group display parameters is set for each set, so that when objects in the set access an entry link, the entry link is displayed as a corresponding candidate group name. Each candidate group name is configured to indicate the target group. Based on this, when the terminal of the first entity accesses the first page, a set to which the terminal of the first entity is classified according to the first preference is first determined, and a candidate group name corresponding to the set is displayed as a target group name carrying a link tag, so that the displayed target group name adapts to the preferences of the terminal of the first entity.

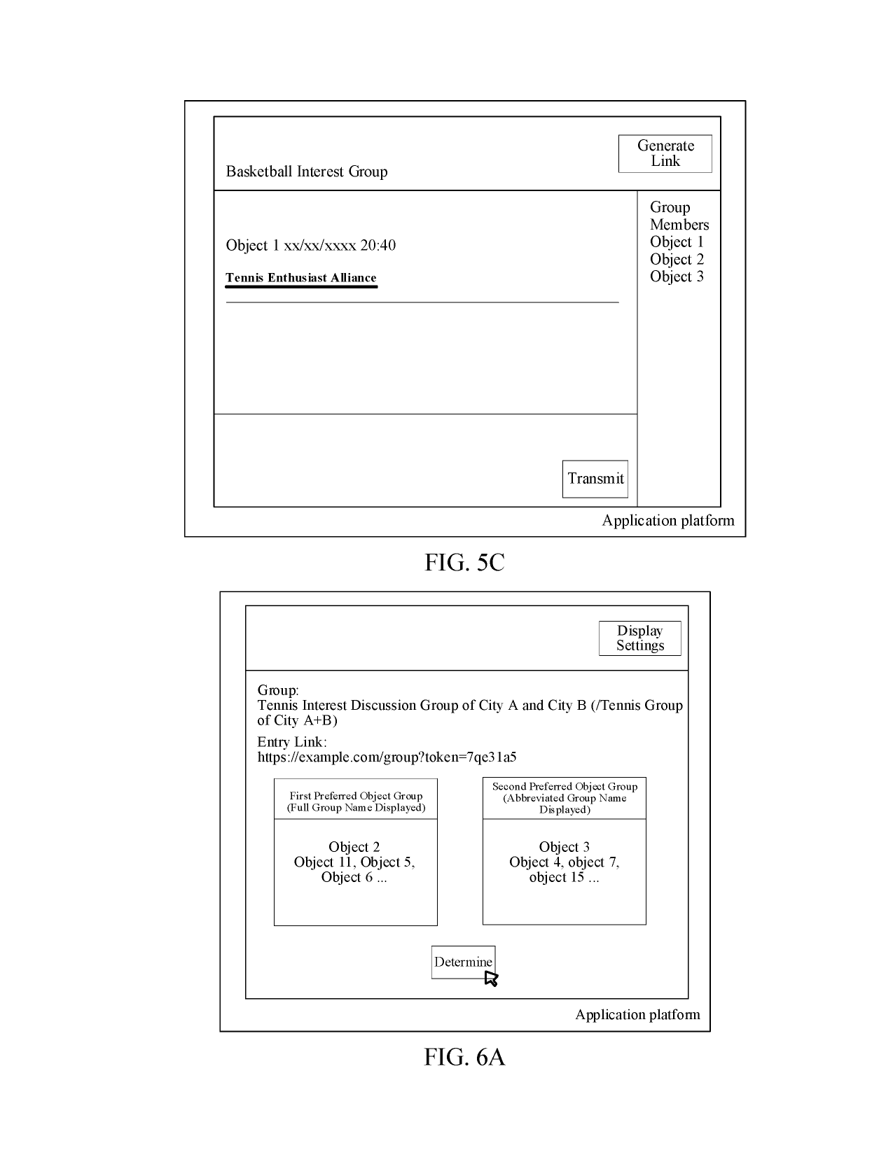

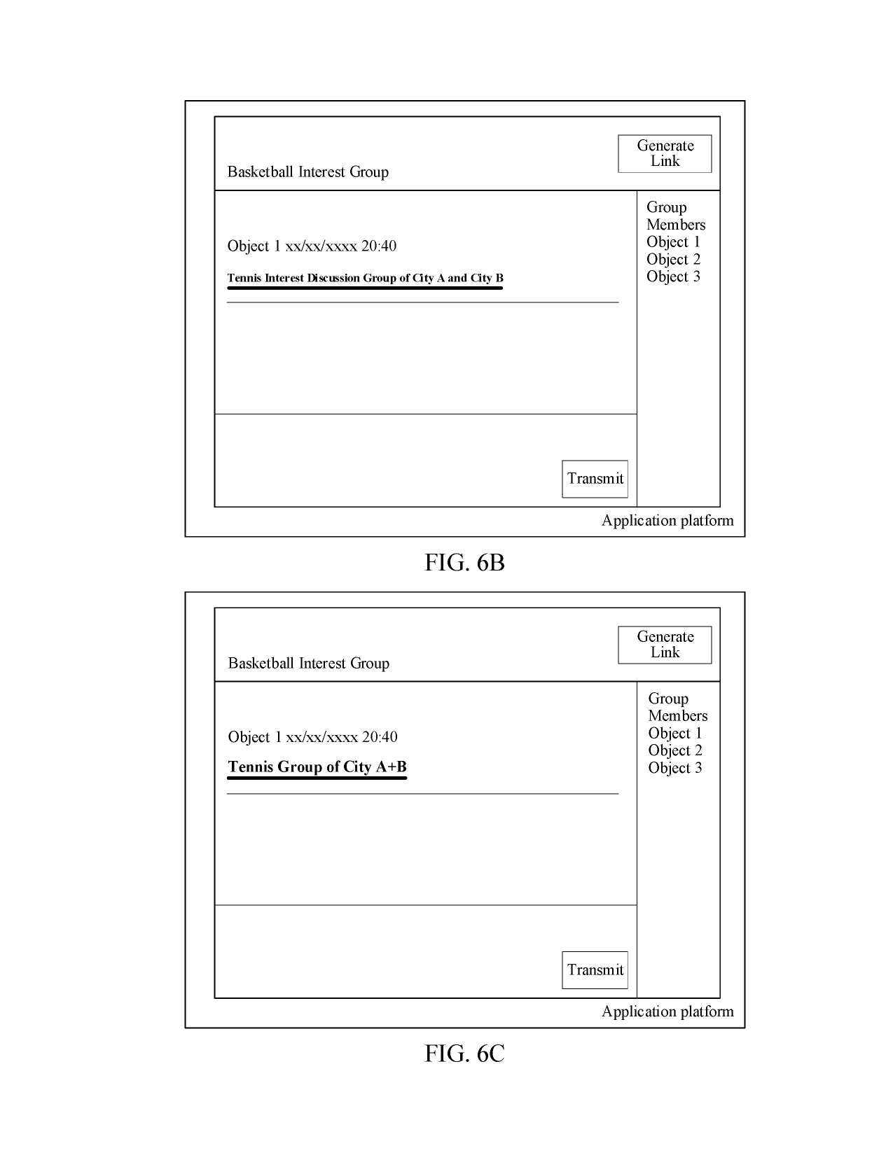

As shown in FIG. 6A, when an entry link for a tennis interest group is created, display settings is made for the entry link on an application platform. In a display setting page, candidate group names of the tennis interest group are set to a full group name "Tennis Interest Discussion Group of City A and City B" and a short group name "Tennis Group of City A+B", and an entry link thereof is "https://example.com/group?token=7qe31a5". Next, according to habits and preferences of various objects for displaying the full group name and the short group name, the objects are divided into two object groups, where a first preference object group is composed of objects that prefer to display the full group name, and the object group includes object 2, object 11, object 5, object 6, and the like. A second preference object group is composed of objects that prefer to display the short group name, and the object group includes object 3, object 4, object 4, object 15, and the like.

As shown in FIG. 6B, group members include object 1, object 2, and object 3. When object 2 accesses a session page of a basketball interest group, content transmitted by object 1 displayed on the session page is a group name carrying a link tag of the tennis interest group. At this time, the group name carrying the link tag is "Tennis Interest Discussion Group of City A and City B".

As shown in FIG. 6C, group members include object 1, object 2, and object 3. When object 3 accesses a session page of a basketball interest group, content transmitted by object 1 displayed on the session page is a group name carrying a link tag of the tennis interest group. At this time, the group name carrying the link tag is "Tennis Group of City A+B".

An advantage of some aspects is that when a second entity creates an entry link, a target group name displayed for each object is selected according to object preferences, and the same group is displayed with different names for different objects, so that displayed target group names are more fit the preferences of various objects, thereby improving the display diversity of entry links and improving user experience in the application.

### Detailed Descriptions of Operation 320

In operation 320, basic information of the target group is displayed in response to a hover operation triggered in the vicinity of the target group name. In some examples, a hover operation performed in a region of the displayed target group name on the first page is detected by processing circuitry of the first terminal. In some examples, basic information of the target group is displayed in a notification window overlaying the first page based on the hover operation being detected.

In some embodiments, a target region is a region on the first page where a distance from a display position of the target group name is less than a distance threshold. The basic information is configured to notify the first entity whether to trigger the link tag.

In one or more embodiments of this disclosure, the basic information of the target group includes at least one of information set by the second entity when creating the target group, or information extracted from the target group by an application platform based on basic information extraction rules.

Information set by the second entity when creating the target group is group information expected by the second entity for an object to preview without opening the session page.

Information extracted from the target group by an application platform based on basic information extraction rules is group information that is screened by the application platform according to multiple factors such as a group type and a group security level of the target group and can be previewed before opening the session page.

Information overlap may exist between the information set by the second entity when creating the target group and the information extracted from the target group by the application platform based on basic information extraction rules. When information to be displayed is the same, the information is displayed only once.

In some embodiments, in the application, when a user (first entity) triggers a hover operation in a target region of a first page, the system displays basic information of a target group. The target region is a region on the first page where a distance from a display position of the target group name is less than a distance threshold. This design allows the user to preview basic group information through a simple hover operation without directly clicking/tapping or triggering a link tag, thereby helping the user decide whether to open a session page.

In some embodiments, information is set by a second entity (e.g., a group administrator) when creating the target group. This part of information is group information expected by the administrator for the user to preview without opening the session page, and may include a group description, purpose, rules, and the like. Information is extracted from the target group by the application platform based on basic information extraction rules. This part of information is group information that is screened by the application platform according to multiple factors such as a group type and a group security level of the target group and can be previewed before opening the session page. For example, for a public group, the application platform may extract a latest discussion topic or activity of the group. For a private group, the platform may extract the quantity of members or a profile of an administrator of the group. If information overlap exists between the information set by the second entity when creating the target group and the information extracted from the target group by the application platform based on basic information extraction rules, the application may display the same information only once to avoid redundancy and confusion. The user experience is improved, enabling users to obtain necessary information without going deep into a group and helping the users decide whether to join or participate in the group. Meanwhile, the responsiveness of the application to user needs and the flexibility in group information management are also presented.

As an example, it is assumed that there is a group named "Photography Skill Discussion", and a group administrator (second entity) creates an entry link and sets a target group name "Photography Skill Discussion" for the entry link. The administrator expects a user to preview some basic group information without opening a session page. When a first entity (user A) accesses the first page of the application, the user sees the group name "Photography Skill Discussion" carrying a link tag. User A hovers a mouse over a target region (a region where a distance from a display position of the group name is less than a distance threshold) near the group name to trigger a hover operation. In response to the hover operation of the user, the application displays basic information of the target group on a terminal of user A. This information includes: group description: "Welcome photography enthusiasts to join, share and learn photography skills, and discuss experiences." This is information set by the administrator when creating the group, so that a user is expected to understand the purpose and content of the group without opening the session page. Latest discussion topic: "How to take beautiful sunset photos?" This is group information that is screened by the application platform according to the group type and security level and can be previewed before opening the session page. The information helps the user understand the activity level and discussion topics of the group. If information set by the administrator when creating the group overlaps with information extracted by the application platform (for example, the administrator also mentions the latest discussion topic), the application may display the same information only once to avoid redundancy. User A can preview basic group information without opening the session page, helping the user decide whether to open the session page and participate in group discussions. This design improves the user experience, enabling users to obtain necessary information without going deep into a group and helping the users decide whether to join or participate in the group. Meanwhile, the responsiveness of the application to user needs and the flexibility in group information management are also presented.

In some examples, when the application platform extracts information from the target group based on basic information extraction rules, the basic information extraction rules are set as follows: a plurality of score intervals are set according to a security score of the target group, and corresponding information items to be extracted are set for each score interval. The security score is determined according to a group type of the target group. Each group type has a preset score value.

For example, a score value is 60 for a sports group. A score value is 40 for a food group. A score value is 80 for a game group. When the security score of the target group is between 0 and 40, the extracted information items are the number of group members, group creation time, and the like of the target group. When the security score of the target group is between 80 and 100, the extracted information items are the current number of group members, a group member upper limit, and the like of the target group.

As an example, when the application platform extracts basic information of the target group, the platform determines which information items to extract according to a security score of the group. The security score is preset according to a group type, and different types of groups have different security score values. For example,
a security score may be 60 for a sports group, 40 for a food group, and 80 for a game group. The platform divides these security scores into a plurality of score intervals and sets corresponding information items for each interval. For example, a score interval of 0 to 40 may correspond to a lower security level. The platform may extract basic information such as the number of group members and creation time. Such information is relatively public and will not leak sensitive content.

A score interval of 41 to 60 may correspond to a medium security level. The platform may extract more information such as the latest activities or discussion topics of the group. Such information helps users understand the activity level and discussion content of the group.

A score interval of 61 to 80 may correspond to a higher security level. The platform may extract more detailed information such as group rules or the contact information of group administrators. Such information helps users understand a group management mode and participation requirements.

A score interval of 81 to 100 may correspond to the highest security level. The platform may extract more sensitive information such as the current number of group members and a maximum member limit. Such information helps users understand a group scale and whether there is still room to join.

When a user triggers a hover operation in the target region on the first page, the platform extracts corresponding information items according to the security score of the target group and displays the information items to the user. For example, if the security score of a game group is 80, the platform may extract information such as the current number of group members and the maximum member limit and display the information to the user. This helps users learn basic information and the security level of the group without opening the session page, so as to decide whether to participate in the group. Meanwhile, the responsiveness of the application to user needs and the flexibility in group information management are also presented.

As shown in FIG. 2C, when the target group is a single group, basic information of the target group is displayed when the mouse hovers in the vicinity of a target group name carrying a link tag on the session page. At this time, the basic information of the target group includes information such as "Group members: 10; Joined: Yes; Group owner nickname: xxx1".

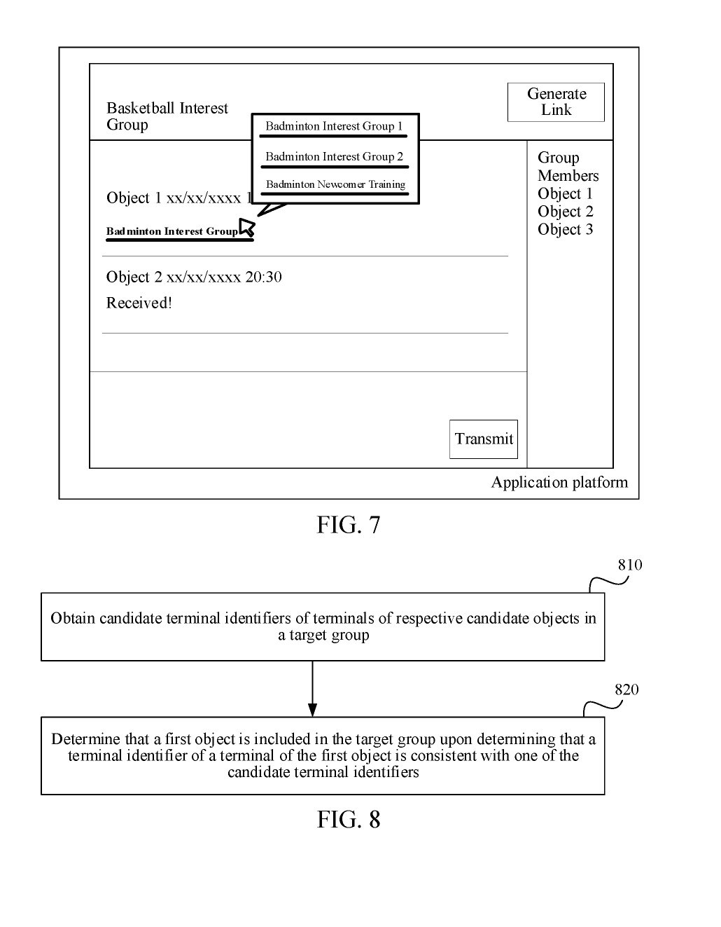

As shown in FIG. 7, group members include object 1, object 2, and object 3. When the target group includes a plurality of sub-groups, basic information of the target group is displayed when the mouse hovers in the vicinity of a target group name carrying a link tag on the session page. Specifically, when object 3 hovers the mouse in the vicinity of a group name "Badminton Interest Group" carrying a link tag transmitted by object 1 on a session page of a basketball interest group, target sub-group names carrying link tags of three target sub-groups included in the badminton interest group are displayed, where the sub-group names of the three sub-groups are "Badminton Interest Group 1", "Badminton Interest Group 2", and "Badminton Newcomer Training" respectively.

An advantage of some aspects is that a preview function for an entry link displayed as a target group name carrying a link tag is set in the application, so that an object can preview basic information of the group and understand a type of the target group without opening the session page of the group, thereby determining whether to join the group. In addition, specific content of basic group information is set respectively when the target group is a single group or includes a plurality of groups, thereby improving the transmission efficiency and display diversity of group information.

### Detailed Descriptions of Operation 330

In operation 330, a session page of the target group is displayed in response to triggering for the link tag. In some examples, a triggering operation performed on the displayed target group name on the first page is detected by the processing circuitry of the first terminal. In some examples, a session page of the target group is displayed based on the triggering operation being detected.

To improve information transmission efficiency and enable the terminal of the first entity to quickly access the session page of the target group, this disclosure provides a solution for directly displaying a session page based on a trigger operation.

In some embodiments, operation 330 specifically includes:
displaying, upon determining that the first entity is included in the target group, the session page of the target group in response to triggering for the link tag. In some examples, whether the first entity is included in the target group is determined. In some examples, when the first entity is determined as included in the target group, the session page of the target group is displayed based on the triggering operation being detected.

In an implementation of some aspects, when the terminal of the first entity (or also referred to as the terminal associated with the first entity) triggers the link tag via the target object, the server first detects a trigger event generated by the interaction between the target object and the link tag. Next, according to the trigger event and with authorization and permission, information of each group member of the target group is compared with information of the terminal of the first entity, so as to determine whether the terminal of the first entity is one of the group members of the target group. If it is determined that the target group includes the first entity, the session page of the target group is directly displayed in the application, so that the terminal of the first entity may directly view session records of other group members and conduct sessions with the other group members.

In some embodiments, when a user (first entity) clicks/taps or touches a link tag in the application through a terminal thereof, if the link tag points to a group (target group), the application performs a series of operations to determine whether the user has permission to view a session page of the group. When the user performs a trigger operation on the link tag through the terminal thereof, the application detects the trigger event. The event may be a click/tap, a touch, or another form of interaction. After detecting the trigger event, the application checks whether the user has permission to view the session page of the target group. This typically involves verifying whether the user is a member of the target group. The application may communicate with the server to request verification of the user's membership. The server compares terminal information of the user with a member list of the target group to determine whether the user is a member of the target group. This may involve checking account information of the user, a group invitation state, or other membership verification mechanisms.

In some embodiments, if the server confirms that the user is a member of the target group, the application directly displays the session page of the target group. This page generally includes group records, a member list, group announcements, and other information. The user may view session records of other group members and discuss with the other group members in real time on this page. If the server confirms that the user is not a member of the target group, the application may display a notification message informing the user that the session page of the group cannot be viewed, or provide an option to join the group so that the user can apply for membership. The entire process helps ensure that only members of the target group can view and participate in group sessions, protecting the privacy and security of the group. Meanwhile, a convenient and efficient way is also provided for users to quickly join or view groups in which the users are interested.

As an example, it is assumed that there is a group named "Photography Enthusiasts", and a group administrator (second entity) creates an entry link and sets a link tag "Join Photography Enthusiasts Group" for the entry link. The administrator expects that after users click/tap the link tag, the users can directly view the session page of the group if the users are already members of the group. When a first entity (user A) accesses the first page of the application, the user sees a group name carrying the link tag "Join Photography Enthusiasts Group". User A is interested in photography and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is already a member of the "Photography Enthusiasts" group, the server will confirm this and notify the application. After receiving the notification, the application directly displays the session page of the "Photography Enthusiasts" group. User A may view session records of other group members and discuss with the other group members in real time on the session page. If user B clicks/taps the same link tag but user B is not a member of the "Photography Enthusiasts" group, the server will detect this and notify the application. After receiving the notification, the application may display a notification message informing user B that the session page of the group cannot be viewed, or provide an option to join the group so that user B can apply for membership. The process helps ensure that only members of the group can view and participate in group sessions, protecting the privacy and security of the group. Meanwhile, a convenient and efficient way is also provided for users to quickly join or view groups in which the users are interested.

An advantage of some aspects is that, when it is detected that the terminal of the first entity triggers the link tag via the target object and it is determined that the target group includes the first entity, the session page of the target group is directly displayed according to the trigger operation without any intermediate operations, enabling the terminal of the first entity to quickly access the session page of the target group and improving information transmission efficiency.

Referring to FIG. 8, in some embodiments, whether the first entity is included in the target group is determined in the following manners:
Operation 810: Obtain candidate terminal identifiers of terminals of respective candidate objects in a target group.
Operation 820: Determine that a first entity is included in the target group upon determining that a terminal identifier of a terminal of the first entity is consistent with one of the candidate terminal identifiers.

The following describes operations 810 to 820 in further detail.

In operation 810, candidate terminal identifiers of terminals of respective candidate objects in a target group are obtained.

Candidate object terminals refer to object terminals that have completed registration on the application and belong to group members of the target group.

The candidate terminal identifiers are configured to identify the candidate object terminals so as to distinguish different candidate object terminals.

In an implementation of some aspects, basic group information and group member-related information of each group in the application are recorded in background logs of the server. Based on this, group member-related information of the target group may be obtained from the background logs of the server with authorization and permission, and candidate terminal identifiers of respective candidate object terminals (group members) in the target group may be extracted from the group member-related information.

In some embodiments, obtaining the candidate terminal identifiers of the respective candidate object terminals in the target group is an operation in the application. This involves identifying terminals of group members to distinguish different member terminals. Each user registered on the application has a unique terminal identifier. The identifier may be a device ID, a user account ID, or another form of unique identifier. These identifiers are configured to uniquely identify each user terminal on the server side. Basic group information and group member-related information of each group in the application are recorded in background logs of the server. Such information includes a group ID, a group name, a group description, a group member list, terminal identifiers of members, and the like. To protect user privacy and data security, relevant information of group members can be obtained from the background logs of the server only with authorization and permission. This generally involves verifying the identity and permissions of a requester to help ensure that only legitimate requests can access such information. Once authorized, group member-related information of the target group may be obtained from the background logs of the server, including a group ID, a group name, a group description, terminal identifiers of group members, and the like. Candidate terminal identifiers of respective candidate object terminals in the target group may be extracted from the group member-related information. These identifiers are configured to uniquely identify a terminal of each group member in the application, so as to facilitate operations such as message push and session management. The application may obtain terminal identifiers of respective group members in the target group, thereby achieving precise management and personalized services for group members. This not only improves the user experience of the application, but also enhances the interactivity and cohesion of the group.

As an example, it is assumed that there is a group named "Dance Enthusiasts", and a group administrator (second entity) creates an entry link and sets a link tag "Join Dance Enthusiasts Group" for the entry link. The administrator expects that after users click/tap the link tag, the users can directly view the session page of the group if the users are already members of the group. When a first entity (user A) accesses the first page of the application, the user sees a group name carrying the link tag "Join Dance Enthusiasts Group". User A is interested in dance and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is already a member of the "Dance Enthusiasts" group, the server will confirm this and notify the application. After receiving the notification, the application directly displays the session page of the "Dance Enthusiasts" group. User A may view session records of other group members and discuss with the other group members in real time on the session page. In addition, if user B clicks/taps the same link tag but user B is not a member of the "Dance Enthusiasts" group, the server will detect this and notify the application. After receiving the notification, the application may display a notification message informing user B that the session page of the group cannot be viewed, or provide an option to join the group so that user B can apply for membership. This design helps ensure that only members of the group can view and participate in group sessions, protecting the privacy and security of the group. Meanwhile, a convenient and efficient way is also provided for users to quickly join or view groups in which the users are interested.

In this way, by obtaining candidate terminal identifiers of respective candidate object terminals in the target group, the application can realize accurate identification and management of group members. Based on the basic group information and group member-related information recorded in the background logs of the server, the accuracy and reliability of data are ensured. With authorization and permission, the extracted candidate terminal identifiers are not only configured to distinguish different group member terminals, but also providing a foundation for efficient message push and session management for the application. This precise terminal identification mechanism helps improve user experience, enhance the interactivity and cohesion of the group, and also helps maintain the security and privacy of the group.

In operation 820, it is determined that a first entity is included in the target group upon determining that a terminal identifier of a terminal of the first entity is consistent with one of the candidate terminal identifiers.

In an implementation of some aspects, first, the candidate terminal identifiers of the respective candidate terminals are compared with the terminal identifier of the terminal of the first entity. Next, if a candidate terminal identifier consistent with the terminal identifier of the terminal of the first entity exists, it indicates that the terminal of the first entity is one of the group members of the target group, and it is determined that the terminal of the first entity is included in the target group. If no candidate terminal identifier is consistent with the terminal identifier of the terminal of the first entity, it indicates that the terminal of the first entity is not a group member of the target group, and it is determined that the terminal of the first entity is not included in the target group.

In some embodiments, in the application, the process of determining whether a user (first entity) belongs to a particular target group is as follows: the application obtains candidate terminal identifiers of all group members in the target group. These identifiers are unique and configured to identify the terminal device of each group member. The application then compares these candidate terminal identifiers with the terminal identifier of the first entity one by one. The comparison is implemented through an algorithm, typically by exact matching of two identifier character strings. If a candidate terminal identifier is found to be identical to the terminal identifier of the first entity during the comparison, the application may determine that the terminal of the first entity is one of the group members of the target group. The determination process is based on the uniqueness and accuracy of terminal identifiers. The terminal identifiers are typically generated by the application to help ensure that each terminal device has a unique identifier. Therefore, by comparing the terminal identifiers, it may be accurately determined whether a user belongs to a group. If no candidate terminal identifier identical to the terminal identifier of the first entity is found during the comparison, the application will determine that the terminal of the first entity is not a group member of the target group. This means that the user may not view or participate in the sessions of the group, thereby protecting the privacy and security of the group. This is typically triggered when the user attempts to access a group session page. This helps ensure that only legitimate group members can access group content, while providing users with a secure and private communication environment.

As an example, it is assumed that there is a group named "Technology Enthusiasts", and a group administrator (second entity) creates an entry link and sets a link tag "Join Technology Enthusiasts Group" for the entry link. The administrator expects that after users click/tap the link tag, the users can directly view the session page of the group if the users are already members of the group. When a first entity (user A) accesses the first page of the application, the user sees a group name carrying the link tag "Join Technology Enthusiasts Group". User A is interested in technology and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is already a member of the "Technology Enthusiasts" group, the server will confirm this and notify the application. After receiving the notification, the application directly displays the session page of the "Technology Enthusiasts" group. User A may view session records of other group members and discuss with the other group members in real time on the session page. In addition, if user B clicks/taps the same link tag but user B is not a member of the "Technology Enthusiasts" group, the server will detect this and notify the application. After receiving the notification, the application may display a notification message informing user B that the session page of the group cannot be viewed, or provide an option to join the group so that user B can apply for membership. The process helps ensure that only members of the group can view and participate in group sessions, protecting the privacy and security of the group. Meanwhile, a convenient and efficient way is also provided for users to quickly join or view groups in which the users are interested.

An advantage of some aspects is that by comparing terminal identifiers to determine whether the terminal of the first entity is a group member of the target group, the comparison is simple, and it can be determined whether the terminal of the first entity is included in the target group.

Since interactive mis-triggering often occurs in the application, for example, an object is not intended to trigger a process or open a page on an interface of the application, but accidentally touches a corresponding control, causing the process to be triggered or the page to be opened. This situation affects the accuracy of information display. Based on this, this disclosure provides a solution for setting a confirmation operation before displaying a session page, thereby effectively avoiding pages being displayed due to mis-triggering, and improving the accuracy of information display.

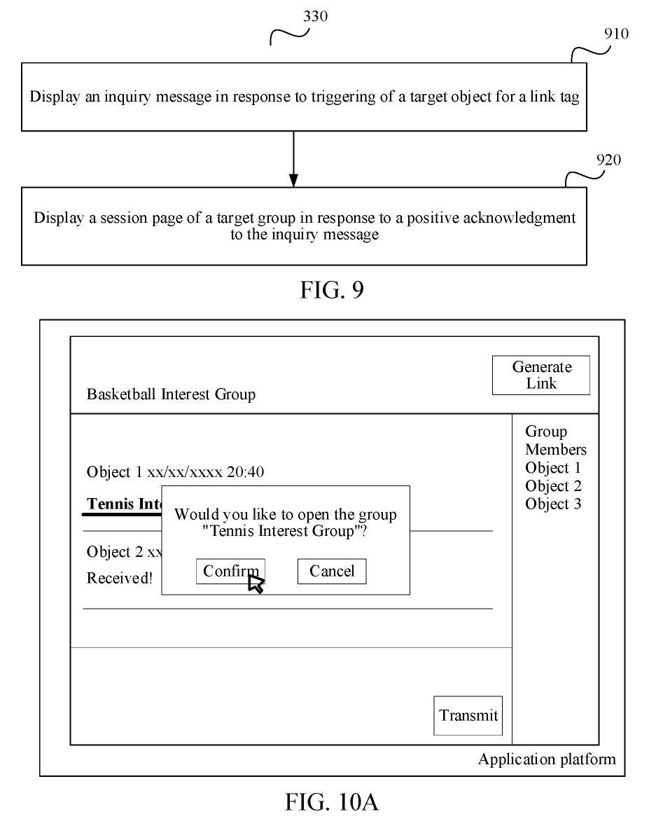

Referring to FIG. 9, in some embodiments, operation 330 specifically includes, but is not limited to, the following operations 910 to 920:
Operation 910: Display an inquiry message in response to triggering of a target object for a link tag.
Operation 920: Display a session page of a target group in response to a positive acknowledgment to the inquiry message.

The following describes operations 910 to 920 in further detail.

In operation 910, an inquiry message is displayed in response to triggering of a target object for a link tag.

The inquiry message is configured to inquire the terminal of the first entity whether to display the session page of the target group.

In an implementation of some aspects, when the terminal of the first entity triggers the link tag via the target object, upon detecting such trigger event and determining through comparison that the target group includes the terminal of the first entity, the server displays an inquiry message on the application in the form of a pop-up window to the terminal of the first entity, so as to use the inquiry message to allow the terminal of the first entity to reconfirm whether to access the session page of the target group.

In some embodiments, in the application, when a target object (typically a group administrator or another group member) triggers a link tag, the application performs the following operations to display an inquiry message: when the target object clicks/taps or touches the link tag, the application detects such trigger event. The event may be a click/tap, a touch, or another form of interaction. After detecting the trigger event, the application communicates with the server to request verification of whether the terminal of the first entity is a member of the target group. The server performs verification based on the stored group member information. If the server confirms that the terminal of the first entity is a member of the target group, the application displays an inquiry message in the form of a pop-up window on the terminal of the first entity. The message may read: "Would you like to view the session page of the 'target group'?" The terminal user of the first entity will see this inquiry message and may select "Yes" or "No". This operation allows the user to make a final confirmation before accessing the group session page, enhancing user control and privacy protection. If the user selects "Yes", the application displays the session page of the target group. If the user selects "No", the application cancels the operation and the user will not be directed to the group session page. The user engagement and control are increased, helping ensure that the user has full choice before accessing the group session page. The user experience of the application is also improved, making the user feel safer and more assured. Meanwhile, the responsiveness of the application to user needs and the respect for user privacy are presented.

As an example, it is assumed that there is a group named "Movie Enthusiasts", and a group administrator (second entity) creates an entry link and sets a link tag "Join Movie Enthusiasts Group" for the entry link. The administrator expects that after users click/tap the link tag, the users can directly view the session page of the group if the users are already members of the group. When a first entity (user A) accesses the first page of the application, the user sees a group name carrying the link tag "Join Movie Enthusiasts Group". User A is interested in movie and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is already a member of the "Movie Enthusiasts" group, the server will confirm this and notify the application. After receiving the notification, the application displays, in the form of a pop-up window on a terminal of user A, an inquiry message: "Would you like to view the session page of the 'Movie Enthusiasts' group?" After seeing the inquiry message, user A may select "Yes" or "No". If user A selects "Yes", the application directly displays the session page of the "Movie Enthusiasts" group. User A may view session records of other group members and discuss with the other group members in real time on the session page. If user A selects "No", the application cancels the operation and user A will not be directed to the group session page. The process helps ensure that the user has sufficient choice before accessing the group session page, thereby enhancing the user engagement and control. Meanwhile, the user experience of the application is also improved, making the user feel safer and more assured.

In this way, by implementing a function of displaying an inquiry message in response to the target object triggering the link tag in the application, user experience and data security can be improved. This function is based on membership verification by the server, helping ensure that only legitimate group members can receive the inquiry message. By displaying the inquiry message in the form of a pop-up window on a user terminal, the application provides the user with a final confirmation opportunity before accessing the group session page, thereby enhancing the user engagement and control, promoting effective communication and interaction among group members, and providing a safer, more private and more efficient group management mechanism for the application.

In operation 920, a session page of a target group is displayed in response to a positive acknowledgment to the inquiry message.

In an implementation of some aspects, when the terminal of the first entity gives a positive acknowledgment to the inquiry message, it indicates that the triggering of the target object for the link tag is not mis-triggering, and the session page of the target group is displayed on the terminal of the first entity. When the terminal of the first entity gives a negative acknowledgment to the inquiry message, it indicates that the triggering of the target object for the link tag may be mis-triggering and the terminal of the first entity is not intended to access the session page of the target group. Based on this, the inquiry message is closed, the session page of the target group is not displayed, and the currently displayed page of the application platform remains unchanged.

In some embodiments, after the terminal of the first entity receives the inquiry message in the application, the user may select whether to confirm accessing the session page of the target group. If the terminal user of the first entity selects "Yes" or "Confirm", the application transmits this acknowledgment back to the server. After receiving the positive acknowledgment, the server verifies the validity of this selection and confirms that the user indeed has permission to access the session page of the target group. After successful verification, the application displays the session page of the target group on the terminal of the first entity, and the user may start viewing and participating in group discussions. If the terminal user of the first entity selects "No" or "Cancel", the application transmits this acknowledgment back to the server. After receiving the negative acknowledgment, the server records this selection and confirms that the user is not intended to access the session page of the target group. Based on this selection, the application closes the inquiry message and keeps the currently displayed page unchanged, and the user will not be directed to the group session page. The process helps ensure that the user has sufficient choice before accessing the group session page, thereby avoiding inconvenience caused by mis-triggering. The user experience of the application is improved, making the user feel safer and more assured. Meanwhile, the responsiveness of the application to user needs and the respect for user privacy are also presented.

As an example, it is assumed that there is a group named "Travel Photography", and a group administrator (second entity) creates an entry link and sets a link tag "Join Travel Photography Group" for the entry link. The administrator expects that after users click/tap the link tag, the users can directly view the session page of the group if the users are already members of the group. When a first entity (user A) accesses the first page of the application, the user sees a group name carrying the link tag "Join Travel Photography Group". User A is interested in travel photography and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is already a member of the "Travel Photography" group, the server will confirm this and notify the application. After receiving the notification, the application displays, in the form of a pop-up window on a terminal of user A, an inquiry message: "Would you like to view the session page of the 'Travel Photography' group?" After seeing the inquiry message, user A may select "Yes" or "No". If user A selects "Yes", the application directly displays the session page of the "Travel Photography" group. User A may view session records of other group members and discuss with the other group members in real time on the session page. If user A selects "No", the application closes the inquiry message and keeps the currently displayed page unchanged. User A will not be directed to the group session page and may continue browsing other content of the application.

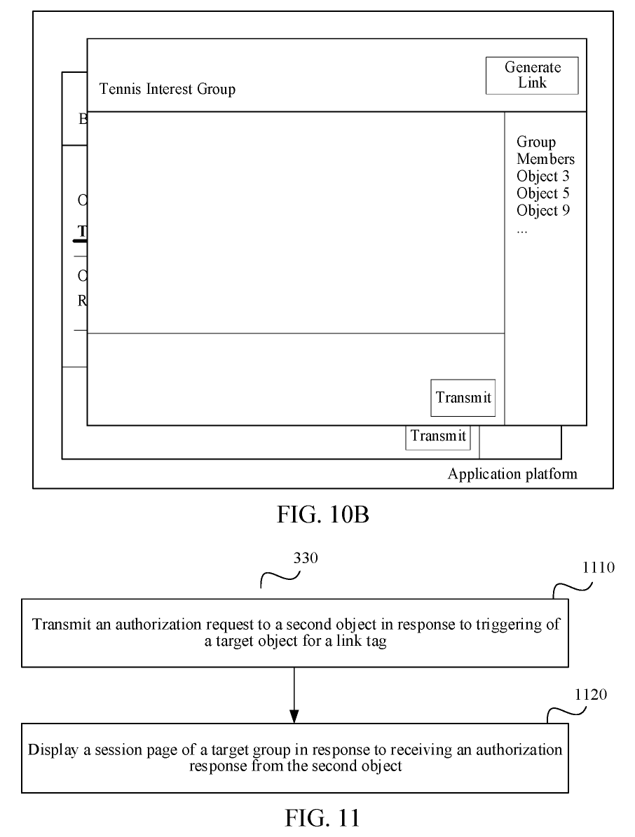

As shown in FIG. 10A, group members include object 1, object 2, and object 3. When object 3 double-clicks/double-taps a link tag of a tennis interest group transmitted by object 1 on a session page of a basketball interest group, the application platform displays an inquiry message window. An inquiry message in the inquiry message window is: "Would you like to open the group 'Tennis Interest Group'". The inquiry message window also includes an interactive "Confirm" control and a "Cancel" control.

As shown in FIG. 10B, group members include object 3, object 5, and object 9. When object 3 clicks/taps the "Confirm" control in the inquiry message window, object 3 is deemed to have given a positive acknowledgment, and a session page of the tennis interest group is displayed on the application platform. When object 3 clicks/taps the "Cancel" control in the inquiry message window, object 3 is deemed to have given a negative acknowledgment, and the inquiry message window is closed directly.

An advantage of some aspects is that when it is detected that the terminal of the first entity triggers the link tag via the target object and it is determined that the target group includes the terminal of the first entity, an inquiry message window is provided. The session page of the target group is displayed according to the trigger operation only after reconfirmation by the terminal of the first entity, thereby reducing the possibility of displaying the session page due to mis-triggering and improving information transmission efficiency and information transmission accuracy.

To improve group access security, if the terminal of the first entity is not a group member of the target group, the group page of the target group will not be directly accessed even if the link tag of the target group name is triggered. At this time, directly blocking the terminal of the first entity from entering the target group will affect the normal session communication of the terminal of the first entity and also reduce information transmission efficiency in the application. Based on this, embodiments of this disclosure provide a solution for setting an authorized access operation when displaying a session page, so that the session page can be displayed for the terminal of the first entity under authorized access.

Referring to FIG. 11, in some embodiments, operation 330 specifically includes, but is not limited to, the following operations 1110 to 1120:
Operation 1110: Transmit an authorization request to a second entity in response to triggering of a target object for a link tag.
Operation 1120: Display a session page of a target group in response to receiving an authorization response from the second entity.

The following describes operations 1110 to 1120 in further detail.

In operation 1110, an authorization request is transmitted to a second entity in response to triggering of a target object for a link tag.

In an implementation of some aspects, when the terminal of the first entity triggers the link tag via the target object, upon detecting such trigger event and determining through comparison that the target group does not include the terminal of the first entity, the server first inquires the terminal of the first entity in the form of a pop-up window whether to apply for authorization permission to join the target group. Next, when the terminal of the first entity intends to join the target group, the terminal selects to apply for authorization permission. Based on this, the server transmits an authorization request on behalf of the terminal of the first entity to the second entity, applying to join the target group. When receiving the authorization request, the second entity performs terminal identity verification on the terminal of the first entity. If it is determined that the identity verification of the terminal of the first entity is passed, an authorization response is made to permit the terminal of the first entity to join the target group. When it is determined that the identity verification of the terminal of the first entity fails, a rejection authorization response is made and the terminal of the first entity is not allowed to join the target group.

In some embodiments, in the application, when the target object triggers the link tag, if the server detects that the terminal of the first entity is not a member of the target group, the application detects such trigger event when the target object clicks/taps or touches the link tag. The event may be a click/tap, a touch, or another form of interaction. After detecting the trigger event, the application communicates with the server to request verification of whether the terminal of the first entity is a member of the target group. The server performs verification based on the stored group member information. If the server confirms that the terminal of the first entity is not a member of the target group, the application displays, in the form of a pop-up window on the terminal of the first entity, an inquiry message: "Would you like to apply to join the 'target group'?" If the terminal user of the first entity selects "Yes" or "Apply", the application transmits this selection back to the server. After receiving the application, the server transmits an authorization request on behalf of the terminal of the first entity to a second entity (a group administrator or another authorized object). After receiving the authorization request, the second entity performs identity verification on the terminal of the first entity. This may include checking registration information of the user, verifying an identity credential of the user, and the like. Upon determining that the identity verification of the terminal of the first entity is passed, the second entity may make an authorization response to permit the terminal of the first entity to join the target group. The application receives the authorization response and adds the terminal of the first entity to the target group. Upon determining that the identity verification of the terminal of the first entity fails, the second entity may make a rejection authorization response and does not allow the terminal of the first entity to join the target group. The application receives the rejection response and notifies the terminal user of the first entity that the application fails.

As an example, it is assumed that there is a group named "Healthy Living", and a group administrator (second entity) creates an entry link and sets a link tag "Join Healthy Living Group" for the entry link. The administrator expects that after a user clicks/taps the link tag, the user can apply to join the group if the user is not a member of the group. When a first entity (user A) accesses the first page of the application, the user sees a group name carrying the link tag "Join Healthy Living Group". User A is interested in healthy living and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is not a member of the "Healthy Living" group, the server will confirm this and notify the application. After receiving the notification, the application displays an inquiry message in the form of a pop-up window on a terminal of user A: "Would you like to apply to join the 'Healthy Living' group?" After seeing the inquiry message, user A may select "Yes" or "Apply". If user A selects "Yes", the application transmits this selection back to the server. After receiving the application, the server transmits an authorization request on behalf of the terminal of user A to the second entity, applying to join the "Healthy Living" group. After receiving the authorization request, the second entity (group administrator) performs identity verification on the terminal of user A. This may include checking registration information of the user, verifying an identity credential of the user, and the like. Upon determining that the identity verification of the terminal of user A is passed, the second entity may make an authorization response to permit the terminal of user A to join the "Healthy Living" group. The application receives the authorization response and adds the terminal of user A to the group. User A may view discussions of other members in the group and participate in discussions about healthy living. Upon determining that the identity verification of the terminal of user A fails, the second entity may make a rejection authorization response and does not allow the terminal of user A to join the "Healthy Living" group. The application receives the rejection response and notifies the terminal user of user A that the application fails.

In this way, by implementing a function of transmitting an authorization request to the second entity in response to triggering of the target object for the link tag in the application, the security of the group and the user experience can be improved. This function is based on membership verification by the server, helping ensure that only legitimate users can receive the authorization request. By displaying the inquiry message in the form of a pop-up window on a user terminal, the application provides the user with a final confirmation opportunity before applying to join the group, thereby enhancing the user engagement and control. When the user selects to apply to join the group, the server transmits an authorization request to the second entity on behalf of the user, and the second entity performs identity verification on the user. If the verification is passed, the second entity makes an authorization response to permit the user to join the group. If the verification fails, the second entity makes a rejection authorization response and does not allow the user to join the group. This design not only improves the security of the group, but also enhances the user experience, making users feel safer and more assured. Meanwhile, the responsiveness of the application to user needs and the respect for user privacy are also presented.

In operation 1120, a session page of a target group is displayed in response to receiving an authorization response from the second entity.

The authorization response refers to a response made by the second entity for the authorization request of the terminal of the first entity, granting authorization to join the target group.

In an implementation of some aspects, when receiving the authorization response from the second entity, it indicates that the terminal of the first entity is allowed to join the target group. Based on this, in response to receiving the authorization response from the second entity, the server first adds the terminal of the first entity as a group member of the target group, and displays the session page of the target group on the terminal of the first entity.

In some embodiments, in the application, when a second entity (e.g., a group administrator) makes an authorization response for the authorization request of the terminal of the first entity, the server receives an authorization response from the second entity. The response indicates that the terminal of the first entity is allowed to join the target group. Based on the authorization response, the server adds the terminal of the first entity as a group member of the target group, which involves updating a group member database on the server and recording the terminal information of the first entity. Once the terminal of the first entity is added as a group member of the target group, the server transmits an instruction to the terminal of the first entity to display the session page of the target group. The page may include historical group records, a list of currently online members, and an input box for transmitting new messages. After receiving an instruction from the server, the terminal of the first entity updates the interface of the application and displays the session page of the target group. The user may now view the discussion content of the group and participate in real-time discussions. This helps ensure that only authorized users can join the group and view the session page of the group, maintaining the security and privacy of the group. Meanwhile, user experience is also improved, allowing users to quickly and conveniently join groups of interest and participate in discussions.

As an example, it is assumed that there is a group named "Technology Enthusiasts", and a group administrator (second entity) creates an entry link and sets a link tag "Join Technology Enthusiasts Group" for the entry link. The administrator expects that after a user clicks/taps the link tag, the user can apply to join the group if the user is not a member of the group. When a first entity (user A) accesses the first page of the application, the user sees a group name carrying the link tag "Join Technology Enthusiasts Group". User A is interested in technology and decides to click/tap the link tag. In response to the click/tap operation of the user, the application transmits a trigger event to the server. The server first detects the trigger event, and then compares, according to the trigger event and with authorization and permission, information of each group member of the target group with terminal information of user A. Assuming that user A is not a member of the "Technology Enthusiasts" group, the server will confirm this and notify the application. After receiving the notification, the application displays, in the form of a pop-up window on a terminal of user A, an inquiry message: "Would you like to join the 'Technology Enthusiasts' group?" After seeing the inquiry message, user A may select "Yes" or "Apply". If user A selects "Yes", the application transmits this selection back to the server. After receiving the application, the server transmits an authorization request on behalf of the terminal of user A to the second entity, applying to join the "Technology Enthusiasts" group. After receiving the authorization request, the second entity (group administrator) performs identity verification on the terminal of user A. This may include checking registration information of the user, verifying an identity credential of the user, and the like. Upon determining that the identity verification of the terminal of user A is passed, the second entity may make an authorization response to permit the terminal of user A to join the "Technology Enthusiasts" group. The application receives the authorization response and adds the terminal of user A to the group. Once the terminal of user A is added to the group, an instruction will be transmitted to the terminal of user A to display the session page of the "Technology Enthusiasts" group. After receiving an instruction, the terminal of user A updates the interface of the application and displays the session page of the group. User A may now view historical records of the group and a list of currently online members, and participate in real-time discussions.

An advantage of some aspects is that an authorized access operation is set when displaying the session page. When the target group does not include the terminal of the first entity, authorized access to the session page of the target group is applied for the terminal of the first entity in response to triggering of the target object for the link tag. Under the condition of authorized access, the terminal of the first entity is included in the group members of the target group, and the session page of the target group is displayed for the terminal of the first entity. This enables the terminal of the first entity to quickly join the target group after authorization, meets the normal session communication needs of the terminal of the first entity, and improves information transmission efficiency in the application.

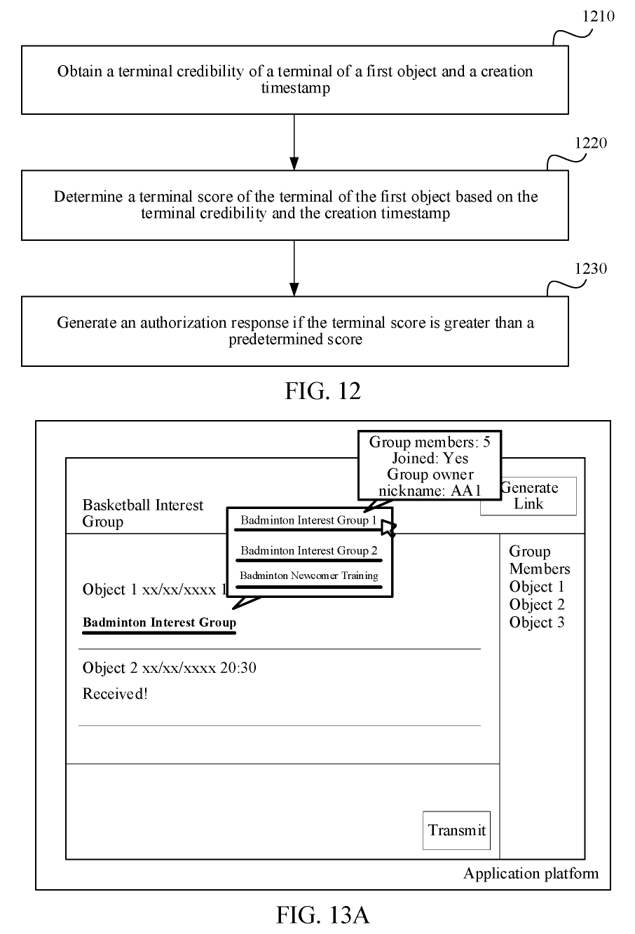

Referring to FIG. 12, in some embodiments, the authorization response is generated in the following manners:
Operation 1210: Obtain a terminal credibility of a terminal of a first entity and a creation timestamp.
Operation 1220: Determine a terminal score of the terminal of the first entity based on the terminal credibility and the creation timestamp.
Operation 1230: Generate an authorization response if the terminal score is greater than a predetermined score.

The following describes operations 1210 to 1230 in further detail.

In operation 1210, a terminal credibility of a terminal of a first entity and a creation timestamp are obtained.

The terminal credibility indicates a credit status of the terminal of the first entity.

The creation timestamp indicates a time point when the terminal of the first entity registered in the application.

In an implementation of some aspects, since the credibility and creation timestamp of each object terminal are recorded in background logs of the application server, the terminal credibility and creation timestamp of the terminal of the first entity may be directly obtained from the background logs with authorization permission.

In some embodiments, in the application, obtaining the terminal credibility and creation timestamp of the terminal of the first entity is a process, which helps evaluate the credit status of the terminal and determine a registration time point thereof in the application. The terminal credibility is an indicator for measuring the credit status of the terminal of the first entity in the application. The indicator may be based on multiple factors, such as historical behaviors of the terminal, compliance with application rules, and participation degree. The application server records credibility information of each terminal. Such information may include historical activity records of the terminal, violation records, user feedback, and the like. With authorization permission, the server may access these records and obtain the terminal credibility of the terminal of the first entity from the background logs. The creation timestamp is a time tag for indicating the time point when the terminal of the first entity registered in the application. The creation timestamp records a time when the terminal first registered or joined the application. The application server also records a registration time of each terminal. Such timestamp information is typically stored in the background logs. With authorization permission, the server may obtain the creation timestamp of the terminal of the first entity from these logs. Before obtaining such sensitive information, the application may verify that necessary authorization permission has been obtained. When obtaining and processing such information, the application may take appropriate security measures to help ensure data security and integrity. This may include data encryption, access control, regular auditing, and the like.

As an example, it is assumed that there is an application named "Online Education". The application provides various online courses and learning resources. To help ensure the security and quality of a learning environment, the application evaluates the credibility of user terminals and records user registration time. When a first entity (user A) attempts to access a protected advanced course, the application may evaluate a terminal credibility and registration time of user A. When user A attempts to access an advanced course, the application transmits a request to the server to evaluate the terminal credibility of user A. The server checks the background logs to find the terminal credibility records of user A. Such records may include historical behavior, participation degree, compliance with community rules, and the like of user A. Based on such information, the server calculates a terminal credibility score of user A. A higher score indicates a better terminal credibility of user A. The server checks the creation timestamp of the terminal of user A to determine the registration time of user A. The creation timestamp records an exact time when user A first registered the application. This helps evaluate the loyalty and participation degree of user A to the application. Before obtaining such information, the application may verify that authorization permission from user A has been obtained, for example, through user agreements or privacy policies. This helps ensure that the application accesses and uses user data legally and transparently. Based on the terminal credibility and registration time of user A, the application decides whether to allow user A to access the advanced course. If user A has high credibility and a long registration period, the application may allow access. If the credibility is low or the registration time is short, the application may restrict access or require the user to provide more information.

In this way, by implementing a function of obtaining a terminal credibility and creation timestamp of a terminal of a first entity in an application, the security and user experience of the application can be improved. This function is based on records of terminal credibility and registration time in the server, helping ensure data accuracy and real-time performance. By obtaining such information from the background logs, the application can efficiently evaluate the credit status and registration time of the terminal, thereby making more informed decisions such as permission management and risk control. This not only improves the security of the application, but also enhances user experience, making users feel safer and more assured. Meanwhile, the responsiveness of the application to user needs and the respect for user privacy are also presented. The function of obtaining a terminal credibility and a creation timestamp provides the application with a tool to better manage user terminals, protect user data, and improve overall service quality.

In operation 1220, a terminal score of the terminal of the first entity is determined based on the terminal credibility and the creation timestamp.

The terminal score indicates authorization scoring for the terminal of the first entity to join the target group.

In an implementation of some aspects, first, a first score is determined according to the terminal credibility. Next, a second score is determined according to the creation timestamp. Finally, a weighted sum operation is performed on the first score and the second score to obtain the terminal score.

Specifically, when determining the first score according to the terminal credibility, a function calculation manner is adopted. The terminal credibility is taken as an independent variable and substituted into a preset function, and an output of the preset function is taken as the first score, where the preset function is an increasing function. A higher terminal credibility indicates a higher first score.

When determining the second score according to the creation timestamp, first, a time difference between the creation timestamp and a current time is calculated. Next, a table lookup method is adopted to invoke a mapping table of time difference intervals and candidate scores, determine a time difference interval where a time difference is located in the mapping table, and take a candidate score corresponding to the found time difference interval as the second score. A larger time difference indicates a higher second score.

In some embodiments, in the application, determining a terminal score of the terminal of the first entity based on the terminal credibility and creation timestamp is an important decision-making process, which helps evaluate the qualification and authorization scoring of the terminal to join the target group. The terminal credibility is an indicator measuring the credit status of the terminal, and reflects a behavior history, rule compliance, and user feedback of the terminal in the application. To convert the terminal credibility into a quantifiable score, the application may adopt a preset increasing function. This function takes the terminal credibility as an independent variable and outputs a corresponding first score. Since the function is increasing, a higher terminal credibility indicates a higher first score. The creation timestamp records the registration time point of the terminal in the application, and helps evaluate the activity and loyalty of the terminal. To convert the creation timestamp into a quantifiable score, the application may first calculate a time difference between the current time and the creation timestamp. The application may use a table lookup method with reference to a predefined mapping table of time difference intervals and candidate scores. This table divides the time difference into different intervals, each interval corresponding to a candidate score. A larger time difference corresponds to a higher second score. Once the first score and the second score are obtained, the application performs a weighted sum operation on the two scores to obtain a final terminal score. The weighted sum operation involves assigning different weights to the first score and the second score. The weights reflect respective importance in the terminal score. For example, if the terminal credibility is considered more important than the registration time, the weight of the first score may be higher. The final terminal score is a weighted sum of the first score and the second score, comprehensively considers the credit status and registration time of the terminal, and provides a comprehensive rating basis for authorization decisions.

As an example, it is assumed that there is a group named "Professional Photography Discussion". The group is a discussion platform for advanced photography enthusiasts. To help ensure the quality and professionalism of the group, the group administrator expects to evaluate user terminals applying to join to determine whether the users meet the requirements of the group. When user A applies to join the "Professional Photography Discussion" group, the application first evaluates a terminal credibility of user A. Assuming that a terminal credibility score of user A is 80 (out of 100), the application substitutes this credibility score into a preset increasing function to calculate a first score. For example, the increasing function may be f(x)=x, and then the first score is also 80. The application evaluates a terminal creation timestamp of user A. Assuming that the terminal of user A was registered two years ago, the application calculates a time difference of two years between the current time and the creation timestamp. Then the application refers to a mapping table of time difference intervals and candidate scores. For example, the mapping table may be: 0-1 year: 10; 1-2 years: 20; 2-3 years: 30; and more than 3 years: 40. According to the time difference of two years, a second score of user A is 20. The application performs a weighted sum operation on the first score and the second score to obtain a terminal score. Assuming that a weight of the first score is 0.6 and a weight of the second score is 0.4, the terminal score is equal to 56 ((80*0.6)+(20*0.4)=48+8). The group administrator decides whether to authorize user A to join the group based on the terminal score. If an authorization threshold of the group is 60, the terminal score of user A is 56, which is less than the threshold. The group administrator may reject a join application of user A. If the group administrator considers that the terminal score of user A is close to the threshold, the administrator may require the user to provide more information or undergo further evaluation.

In some embodiments, when performing a weighted sum operation on the first score and the second score to obtain a terminal score, a first weight and a second weight are first determined, where the first weight indicates the importance of the terminal credibility in terminal scoring, the second weight indicates the importance of the creation timestamp in terminal scoring, and a sum of the first weight and the second weight is 1. Next, a product of the first weight and the first score and a product of the second weight and the second score are added to obtain the terminal score of the terminal of the first entity.

In operation 1230, an authorization response is generated if the terminal score is greater than a predetermined score.

The predetermined score is configured to measure whether the terminal of the first entity meets conditions for joining the target group.

In an implementation of some aspects, first, the terminal score is compared with the predetermined score. Next, if it is determined that the terminal score is greater than the predetermined score, it indicates that the terminal of the first entity is relatively secure and meets the conditions for joining the target group, and an authorization response is generated. When it is determined that the terminal score is less than or equal to the predetermined score, it indicates that the terminal of the first entity has a relatively high risk and fails to meet the conditions for joining the target group, and a rejection authorization response is generated.

In some embodiments, the application may set a predetermined score. The score serves as a benchmark for measuring whether the terminal meets the conditions for joining the target group. The application compares the calculated terminal score with the predetermined score to determine whether the terminal meets the conditions for joining the group. If the terminal score is greater than the predetermined score, the application generates an authorization response. This indicates that the terminal of the first entity is relatively secure and has met the conditions for joining the target group. The authorization response typically includes an instruction to allow joining the group, and the application transmits this response to the terminal of the first entity, enabling the terminal to join the group and participate in discussions. If the terminal score is less than or equal to the predetermined score, the application generates a rejection authorization response. The terminal of the object has a relatively high risk and fails to meet the conditions for joining the target group. The rejection authorization response typically includes an instruction to prohibit joining the group, and the application transmits this response to the terminal of the first entity, notifying the terminal that the terminal may not join the group. Regardless of whether an authorization response or a rejection authorization response is generated, the application notifies the result to the terminal of the first entity. If an authorization response is generated, the user will be able to view the session page of the group and participate in discussions. If a rejection authorization response is generated, the user will receive a notification indicating that the terminal fails to meet the conditions for joining the group. Based on an authorization mechanism of the terminal score, the application can effectively manage group members, helping ensure the security and professionalism of the group. Meanwhile, the responsiveness of the application to user needs and the respect for user privacy are also presented.

As an example, it is assumed that there is a group named "Advanced Investment Discussion", which is a professional discussion platform only for experienced investors to participate in. To ensure the quality and security of the group, the group administrator sets a predetermined score, and only users whose terminal score exceeds this score can join the group. When user A applies to join the "Advanced Investment Discussion" group, the application first evaluates a terminal score of user A. It is assumed that the terminal score of user A is 75 and the predetermined score is 70. The application compares the terminal score of user A (75) with the predetermined score (70). The comparison result shows that the terminal score of user A is greater than the predetermined score. Since the terminal score of user A is greater than the predetermined score, the application generates an authorization response. The authorization response includes an instruction to allow user A to join the group, and the application transmits this response to the terminal of user A. After receiving the authorization response, the terminal of user A displays the session page of the group. User A may now view historical records of the group and a list of currently online members, and participate in real-time discussions.

As another example, it is assumed that user B applies to join the same group, but the terminal score of user B is 65, which is lower than the predetermined score. When user B applies to join the "Advanced Investment Discussion" group, the application evaluates a terminal score of user B. It is assumed that the terminal score of user B is 65 and the predetermined score is 70. The application compares the terminal score of user B (65) with the predetermined score (70). The comparison result shows that the terminal score of user B is less than the predetermined score. Since the terminal score of user B is less than the predetermined score, the application generates a rejection authorization response. The rejection authorization response includes an instruction to prohibit user B from joining the group, and the application transmits this response to the terminal of user B. After receiving the rejection authorization response, the terminal of user B displays a notification indicating that the terminal fails to meet the conditions for joining the group. User B may not join the group or view the session page of the group. Based on an authorization mechanism of the terminal score, how to help group administrators manage group members is determined, to help ensure the quality and security of the group.

An advantage of some aspects is that the terminal score of the terminal of the first entity is comprehensively determined based on the terminal credibility and the creation timestamp, and the terminal verification process of the terminal of the first entity is quantified by means of scoring. This can improve the convenience and reliability of the terminal verification of the terminal of the first entity, thereby improving the reliability and security of the group access authorization for the terminal of the first entity.

To improve the display efficiency of group information, a plurality of groups may be aggregated into one entry link for sharing based on the setting of the second entity, so that other objects can preview basic information such as the names of the plurality of groups through one entry link.

In some aspects, the target group according to one or more embodiments of this disclosure includes a plurality of target sub-groups, and the entry link is synthesized based on sub-entry links created by the second entity for each target sub-group. The manner of creating a sub-entry link for each target sub-group is basically the same as a manner of creating the entry link of the target group.

Based on this, when the target group includes a plurality of target sub-links, the basic information of the target group includes target sub-group names of the respective target sub-groups, the target sub-group name being associated with the target sub-group when the second entity creates the entry link, and the target sub-group name carrying the link tag.

In some aspects, operation 330 specifically includes:
displaying a session page of the target sub-group in response to triggering of the target object for the link tag on the target sub-group name. For example, a session page of the target sub-group is displayed based on a corresponding sub-group link tag associated with the target sub-group based on a triggering operation performed on the corresponding displayed target sub-group name being detected.

In an implementation of some aspects, various situations of displaying the session page of the target sub-group in response to triggering of the target object for the link tag on the target sub-group name in one or more embodiments of this disclosure are similar to the foregoing operations 910 to 920 and operations 1110 to 1120. To save space, no repeat will be provided.

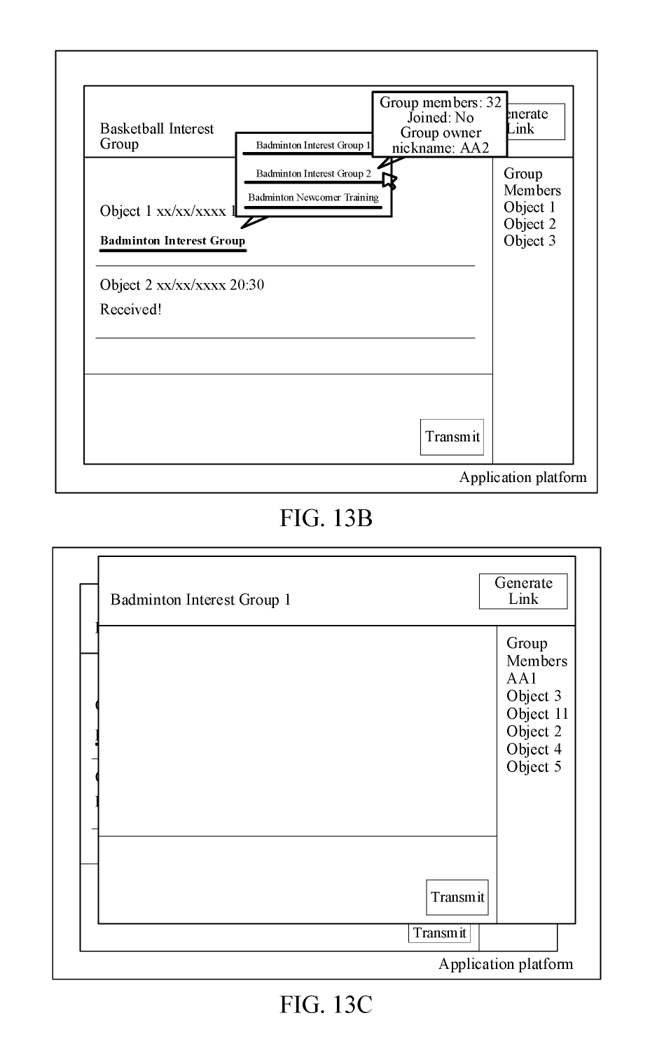

As shown in FIG. 13A, group members include object 1, object 2, and object 3. When object 3 hovers a mouse in the vicinity of a group name "Badminton Interest Group" carrying a link tag transmitted by object 1 on a session page of a basketball interest group, target sub-group names carrying link tags of three target sub-groups included in the badminton interest group are displayed, where the sub-group names of the three sub-groups are "Badminton Interest Group 1", "Badminton Interest Group 2", and "Badminton Newcomer Training" respectively. At this time, when object 3 hovers the mouse in the vicinity of the group name of the target sub-group "Badminton Interest Group 1", the application platform displays basic information of the target sub-group: "Group members: 5; Joined: Yes; Group owner nickname: AA1".

As shown in FIG. 13B, group members include object 1, object 2, and object 3. When object 3 hovers a mouse in the vicinity of a group name of a target sub-group "Badminton Interest Group 2", the application platform displays basic information of the target sub-group: "Group members: 32; Joined: No; Group owner nickname: AA2".

As shown in FIG. 13C, group members AA1 include object 3, object 11, object 2, object 4, and object 5. Based on comparison of basic information of each target sub-group, object 3 double-clicks/double-taps a link tag of the target sub-group "" on the application platform to trigger the link tag. At this time, the session page of the target sub-group "Badminton Interest Group 1" is displayed on the application platform.

An advantage of some aspects is that a plurality of groups are aggregated into one entry link for sharing based on the setting of the second entity, so that other objects can preview group names of the plurality of groups through one entry link, preview basic information of each group based on a hover operation over group names of different groups, and trigger the link tag of a group to enter the session page of the group, thereby improving the display efficiency and transmission efficiency of group information.

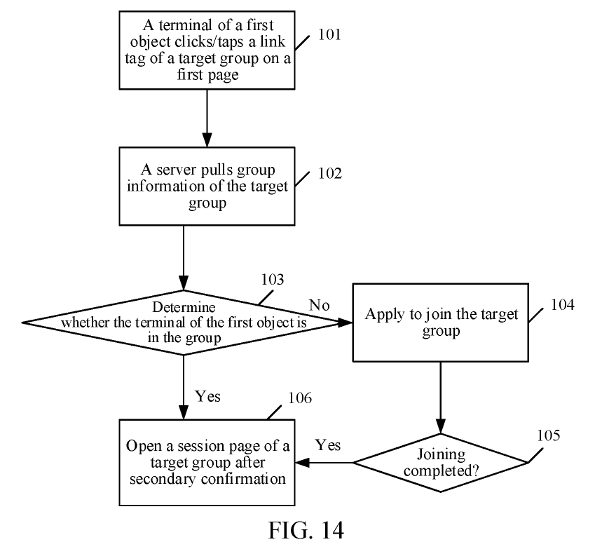

FIG. 14 shows a process executed by an application server when displaying a session page of a target group. Specifically, in operation 101, a terminal of a first entity clicks/taps a link tag of a target group on a first page. In operation 102, a server pulls group information of the target group. In operation 103, it is determined whether the terminal of the first entity is in the group. In operation 104, if the terminal of the first entity is not in the group, the terminal applies to join the target group. In operation 105, it is determined whether the joining is successful. In operation 106, when the terminal of the first entity is in the group or joins to the target group successfully, a session page of the target group is opened after secondary confirmation. When the terminal of the first entity clicks/taps the link tag of the target group on the first page to trigger the link tag, the server first pulls the group information of the target group and determines whether the terminal of the first entity is in the group based on the group information, where an implementation process is similar to the foregoing operations 810 and 820.

In some embodiments, when it is determined that the terminal of the first entity is in the target group, the session page of the target group is opened after secondary confirmation, where an implementation process is similar to the foregoing operations 910 and 920. When it is determined that the terminal of the first entity is not in the target group and the terminal of the first entity applies to join the target group, it is determined whether the joining of the terminal of the first entity is successful. After it is determined that the joining is successful and the session page of the target group is opened after secondary confirmation of the terminal of the first entity, where an implementation process is similar to the foregoing operations 1110 and 1120. To save space, no repeat will be provided.

### Detailed Descriptions of Creating Entry Link of Target Group According to Embodiment of this Disclosure

To improve the creation convenience and accuracy of an entry link, embodiments of this disclosure provide a link creation solution based on random numbers and coding rules, which can improve link creation efficiency and make entry links of different groups different from each other.

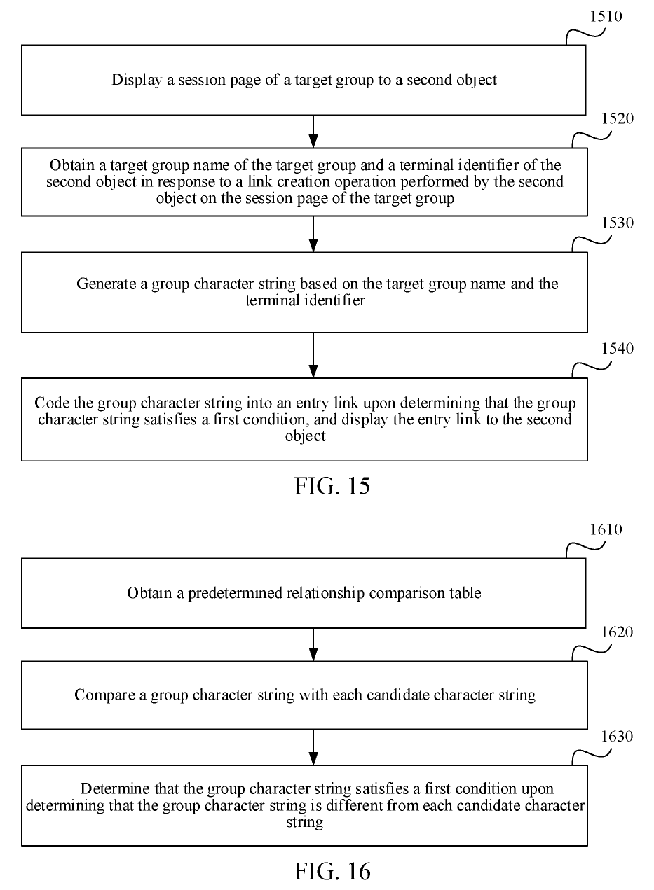

Referring to FIG. 15, in some embodiments, when the target group only includes a single group, the process of creating an entry link of the target group specifically includes, but is not limited to, the following operations 1510 to 1540:
Operation 1510: Display a session page of a target group to a second entity.
Operation 1520: Obtain a target group name of the target group and a terminal identifier of the second entity in response to a link creation operation performed by the second entity on the session page of the target group.
Operation 1530: Generate a group character string based on the target group name and the terminal identifier.
Operation 1540: Code the group character string into an entry link upon determining that the group character string satisfies a first condition and display the entry link to the second entity.

The following describes operations 1510 to 1540 in further detail.

In operation 1510, a session page of a target group is displayed to a second entity.

In an implementation of some aspects, when the second entity logs into an application platform and intends to access the session page of the target group to which the object belongs, a server responds to an access request of the second entity and displays the session page of the target group to the second entity. The session page of the target group is provided with a link generation interactive control for generating an entry link of the target group.

In some embodiments, displaying the session page of the target group to the second entity in the application is an interaction process, which allows a user to access and participate in group discussions. The second entity (user B) launches the application and logs into the application platform. The login process typically involves verifying user credentials, such as a user name and a password, to help ensure the security of the user identity. After login, user B intends to access the session page of the target group to which the user belongs. User B selects a corresponding group on an interface of the application or clicks/taps a group name in a group list, thereby transmitting an access request to the server. After receiving the access request from user B, the server verifies whether user B has the permission to access the session page of the target group. This involves checking whether a terminal score of user B reaches a predetermined score, or confirming whether user B has obtained access permission through other means. If user B has the permission to access the session page of the target group, the server transmits the content of the session page of the target group to a terminal of user B. The session page typically includes historical records of the group, a list of currently online members, a message input box, and various interactive controls, such as a message transmission button and a file upload button. The server includes a link generation interactive control on the session page of the target group. This control allows user B to generate an entry link for inviting others to join the target group. When user B clicks/taps the link generation interactive control, the server generates a unique invitation link and displays the link on the session page. User B may share this link with other users to invite the other users to join the target group. User B may now view and participate in discussions of the target group and conduct real-time discussions with other members. By generating and sharing the invitation link, user B may invite other users to join the group, expanding the influence and activity of the group. The application can display the session page of the target group to the second entity and provide a function of generating an invitation link, thereby improving the user interaction experience and group activity.

As an example, it is assumed that there is a group named "City Explorers", which is a platform for outdoor enthusiasts to share travel experiences and plan adventure activities. User B (second entity) is a member of this group and expects to access the session page of the group through the application. User B launches the "City Explorers" application and enters a corresponding user name and password to log in. The application verifies credentials of user B to ensure that the user is legitimate. After login, user B sees a group list on a main interface of the application, clicks/taps the "City Explorers" group, and transmits a request to the server for accessing a group session page. After receiving the access request from user B, the server checks whether user B has the permission to access the session page of the "City Explorers" group. This may include verifying whether a terminal score of user B reaches a predetermined score, or confirming whether user B has obtained access permission through other means. If user B has the permission to access the session page of the group, the server transmits the content of the session page of the "City Explorers" group to a terminal of user B. The session page displays historical records of the group, including travel photos, adventure plans, and discussion topics shared by members. The page also provides a list of online members showing the current online group members. At a prominent position on the session page, the server includes a link generation interactive control. This control may be a button labeled "Generate Invitation Link". After user B clicks/taps this button, the server generates a unique invitation link and displays the link on the session page. This link may be configured to invite others to join the "City Explorers" group. The session page of the target group is displayed to the second entity, with a function of generating an invitation link provided. This design not only improves the interactivity and sociality of the application, but also helps users expand social circles and enhance the overall user experience.

In this way, by displaying the session page of the target group to the second entity and providing an interactive control for generating an entry link on the page, the application can improve the social interaction experience of users and group activity. Specifically, when the second entity logs into the application platform and accesses the session page of the target group, the server responds to the access request and presents a session page containing elements such as historical records, an online member list, and a message input box. This process not only enables a user to participate in group discussions in real time, but also empowers the user to invite others to join the group through the link generation interactive control. The sense of belonging and participation of the user are enhanced, and the influence of the group is also expanded through a social sharing mechanism, thereby improving the user stickiness and activity of the entire application.

In operation 1520, a target group name of the target group and a terminal identifier of the second entity are obtained in response to a link creation operation performed by the second entity on the session page of the target group.

The terminal identifier of the second entity is configured to mark the second entity, so as to distinguish the second entity from terminals of other objects.

In an implementation of some aspects, when the second entity intends to create an entry link of the target group, the second entity triggers a link generation interactive control on the session page of the target group. Based on this, the server receives a trigger event of the link generation interactive control from the second entity, and obtains, in response to a link creation operation of the second entity on the session page of the target group, a target group name of the target group and a terminal identifier of the second entity from background logs.

In some embodiments, in the application, when the second entity intends to create an entry link of the target group, the process involves a plurality of operations to help ensure that the link generation is secure and traceable. The second entity clicks/taps or triggers an interactive control for dynamically generating a link on the session page of the target group, such as a button or a link generator. A trigger event may be transmitted to the server, to notify the server that the second entity intends to generate an entry link. After receiving the trigger event, the server responds to a link creation operation of the second entity. The server retrieves a name of the target group from a database or group management module thereof. The name is an identifier of the group and is configured to display and identifying the group in the link. The server obtains a terminal identifier of the second entity from background logs or user session management. The identifier is unique and is configured to mark the terminal of the second entity so as to distinguish the terminal from terminals of other users. The terminal identifier is not only configured to mark the second entity, but also may be configured to detect the generation and usage of the link, helping ensure the security and traceability of the link. The server generates a unique entry link by using the obtained target group name and the terminal identifier of the second entity. The link contains necessary information that allows other users to join the target group through the link. The generated entry link is transmitted back to the terminal of the second entity, displayed on the session page, or provided to the second entity through other means (e.g., by being copied to a clipboard).

As an example, it is assumed that there is a group named "Photography Enthusiasts Community". The group is a platform for photography enthusiasts to discuss skills and share works. User B (second entity) is an active member of this group and intends to invite friends to join the group. User B logs into a "Photography Enthusiasts Community" application and accesses a session page of the group. The page displays group records, an online member list, and a button for generating an invitation link. User B clicks/taps the button for generating an invitation link, to trigger a link generation interactive control. This action transmits a trigger event to the server, indicating that user B intends to generate an entry link. After receiving the trigger event from user B, the server starts to respond to a link creation operation of the user. The server retrieves a group name "Photography Enthusiasts Community" from a database thereof, which is an identifier of the group and will be displayed in the invitation link. The server obtains a terminal identifier of user B from background logs. The identifier is unique and is configured to mark a terminal of user B, helping ensure the security and traceability of the invitation link. The server generates a unique invitation link by using the obtained group name and the terminal identifier of user B. The link contains necessary information that allows other users to join the "Photography Enthusiasts Community" group through the link. The generated invitation link is transmitted back to the terminal of user B and displayed on the session page. User B may copy the link and share the link with friends via email, social media, or other means.

In operation 1530, a group character string is generated based on the target group name and the terminal identifier. In some examples, the group character string is generated by the second entity.

The group character string is a randomly generated character string. The group character string is usually unique and can identify the target group, and the group character strings of different groups are different from each other.

In an implementation of some aspects, a random string may be generated by using a pseudo-random number generation algorithm or a predetermined encryption algorithm according to the target group name and the terminal identifier, and the random string is used as the group character string of the target group. The group character string of the target group may be unique. The predetermined encryption algorithm includes, but is not limited to, an SHA-256 encryption algorithm and the like.

In some embodiments, to generate a unique group character string based on the target group name and the terminal identifier, a name of the target group, such as "Photography Enthusiasts Community", is obtained first. A terminal identifier of the second entity, such as a user device ID or a unique session token, is obtained. The target group name and the terminal identifier are combined into a single character string. This may be implemented by simply concatenating two character strings, for example: "Photography Enthusiasts Community" + "Device ID 12345". A predetermined encryption algorithm, such as SHA-256, is selected to generate the group character string. SHA-256 is a secure hash algorithm that may generate a fixed-length hash value with good uniqueness and tamper resistance. The combined character string is hashed by using the selected encryption algorithm. For example, "Photography Enthusiasts Community Device ID 12345" is hashed by using the SHA-256 algorithm to generate a unique hash value. The generated hash value is used as the group character string. The character string is generated based on the target group name and the terminal identifier, is unique, and may be configured to identify the target group. Before the group character string is used in actual applications, the uniqueness may be verified. This may be accomplished by checking whether the same group character string already exists in the database. If yes, the group character string may be regenerated. The verified group character string is stored in the database and associated with the target group and the terminal identifier of the second entity. The group character string is used to identify the target group and referenced when necessary (e.g., generating an invitation link).

In operation 1540, the group character string is coded into an entry link upon determining that the group character string satisfies a first condition, and the entry link is displayed to the second entity.

The first condition is configured to implement conflict detection of the group character string, so as to determine whether the group character string of the target group is unique and whether the group character string is duplicated with group character strings of other groups.

In an implementation of some aspects, first, uniqueness detection is performed on the group character string according to the first condition. When the randomly generated group character string is unique, it is determined that the group character string satisfies the first condition. Next, the group character string is coded by using URL coding or a custom coding rule to generate an entry link of the target group, where the entry link of the target group is unique.

In some embodiments, before generating the entry link, the uniqueness of the group character string may be verified, to avoid conflict with group character strings of other groups. The group character string is generated according to the target group name and the terminal identifier. This may be implemented by hashing the combined character string using an encryption algorithm (e.g., SHA-256). Next, uniqueness detection is performed on the generated group character string. This typically involves querying the database to confirm whether the group character string already exists. If the group character string already exists in the database, it indicates that the group character string conflicts with that of another group and does not satisfy the first condition. If the group character string does not exist in the database, it indicates that the group character string is unique and satisfies the first condition. Once it is determined that the group character string satisfies the first condition (i.e., the group character string is unique), the group character string may be coded into an entry link. Coding may adopt standard URL coding rules to help ensure secure transmission of the group character string in the URL. Custom coding rules may be used to increase the complexity of the entry link and prevent easy guessing or abuse. The coded group character string is combined with a domain name of the application or a specific routing path to form the entry link of the target group. For example, if the domain name of the application is 'example.com' and the coded group character string is 'abc123', the entry link may be 'https://example.com/join/abc123'. The generated entry link is displayed to the second entity. This may be implemented by displaying a button or a link on the interface of the application. The second entity may copy the entry link and share the link with others via email, social media, or other means to invite others to join the target group. The application helps ensure that each entry link is unique and secure, effectively preventing conflicts of group character strings and providing users with a convenient invitation mechanism.

In a specific example, a format of the entry link may be expressed as: "https://example.com/group?token=xxxx", where "xxxx" represents the group character string of the target group.

An advantage of some aspects is that a link generation interactive control is provided on a session page of each group, so that group members of each group may directly trigger the link generation interactive control to generate an entry link of a single group, improving operation convenience. In addition, when the server generates the entry link, the entry link is formed by generating a unique random string based on a group name and a terminal identifier of a terminal triggering the control, and coding the random string according to a predetermined rule and a fixed format, thereby making entry links of different groups different from each other and enabling a plurality of generated entry links to have good format consistency.

Referring to FIG. 16, in some embodiments, the process of determining that the group character string satisfies the first condition specifically includes, but is not limited to, the following operations 1610 to 1630:
Operation 1610: Obtain a predetermined relationship comparison table.
Operation 1620: Compare a group character string with each candidate character string.
Operation 1630: Determine that the group character string satisfies a first condition upon determining that the group character string is different from each candidate character string.

The following describes operations 1610 to 1630 in further detail.

In operation 1610, a predetermined relationship comparison table is obtained.

The predetermined relationship comparison table is configured to indicate corresponding relationships between respective candidate groups and recorded character strings.

The candidate groups refer to other session groups created in the application platform.

The recorded character strings refer to group character strings of other session groups in the application platform.

In an implementation of some aspects, the predetermined relationship comparison table is stored in the background by the server, and the candidate groups and the recorded character strings corresponding to the candidate groups in the predetermined relationship comparison table are continuously updated as entry links of the groups are created. The recorded character strings of all candidate groups in the application are recorded in the predetermined relationship comparison table. Based on this, the predetermined relationship comparison table maintained by the server may be directly invoked under authorization.

In some embodiments, the predetermined relationship comparison table is a data structure in the application platform for managing corresponding relationships between groups and group character strings. The predetermined relationship comparison table is a data structure that records a mapping relationship between all candidate groups and the corresponding recorded character strings in the application platform. Each candidate group has a unique candidate character string. The character string is generated by a specific algorithm to uniquely identify the group. The candidate groups refer to other session groups that have been created in the application platform. These groups may have different themes, purposes, and members. A candidate character string is a group character string of each candidate group, which is generated by combining a group name and a terminal identifier and processed by an encryption algorithm. The predetermined relationship comparison table is typically stored in a background database of the server. Whenever a new group entry link is created, the server generates a new group character string, associates the group character string with the corresponding group, and then updates the predetermined relationship comparison table. Such update is dynamic. As groups are created and entry links are generated, the predetermined relationship comparison table is continuously updated to reflect the latest corresponding relationship between groups and group character strings. The application may invoke the predetermined relationship comparison table maintained by the server under authorization. This is typically implemented through an API request. The application transmits a request to the server to obtain data of the predetermined relationship comparison table. After verifying the legitimacy of the request, the server returns the content of the predetermined relationship comparison table. Once the application obtains the predetermined relationship comparison table, the application may use the table to verify the uniqueness of a group character string and help ensure no conflict when generating a new entry link. The application may alternatively use the predetermined relationship comparison table to parse an entry link and determine a group corresponding to the link, thereby allowing users to join the corresponding group.

In operation 1620, a group character string is compared with each candidate character string to determine whether the group character string is unique.

In some embodiments, helping ensure the uniqueness of the group character string is relevant in the application, as it is related to the identification and security of the group. The application generates a group character string according to the name of the target group and the terminal identifier of the second entity. This is typically implemented by hashing the combined character string using an encryption algorithm (e.g., SHA-256). The application may obtain the predetermined relationship comparison table maintained by the server, which contains all existing candidate groups and corresponding recorded character strings. This may be implemented by transmitting an API request to the server. After verifying the legitimacy of the request, the server returns data of the predetermined relationship comparison table. The application compares the generated group character string with each candidate character string in the predetermined relationship comparison table. If the generated group character string is different from all recorded character strings, it may be determined that the group character string is unique and satisfies the first condition. If the generated group character string is identical to any candidate character string, it indicates that the group character string already exists and does not satisfy the first condition, and thus may be regenerated. If the group character string is unique, the application may proceed to use the group character string to generate an entry link. If the group character string is not unique, the application may regenerate the group character string and perform the comparison again until a unique character string is found. To improve comparison efficiency, the application may use a data structure (e.g., a hash table) to store the recorded character strings in the predetermined relationship comparison table, so that the comparison process may be completed in constant time. The application may further check the uniqueness of the group character string immediately upon generation, instead of performing comparison after generation, so as to reduce unnecessary computation.

In operation 1630, it is determined that the group character string satisfies a first condition upon determining that the group character string is different from each candidate character string.

In some embodiments, if it is determined that the group character string is different from each candidate character string, indicating that the group character string does not conflict with other recorded character strings and the group character string is unique, it is determined that the group character string satisfies the first condition. If it is determined that the group character string is identical to a particular candidate character string, indicating that the group character string conflicts with one candidate character string, the group character string is not unique, and the same random string corresponds to at least two groups, it is determined that the group character string does not satisfy the first condition. A new random string is regenerated according to the target group name of the target group and the terminal identifier of the second entity, and when the generated random string is unique, the random string is coded as the group character string of the target group.

As an example, it is assumed that there is an application named "Healthy Living Community" in which users may create and join various health-related groups. When a user intends to create a new group and generate an entry link, the application may verify that the generated group character string is unique. User A intends to create a new group named "Vegetarianism Discussion". The user fills in a group name in the application and submits a creation request. The application generates a group character string according to the group name and a terminal identifier of user A. For example, "Vegetarianism Discussion" and a device ID of user A are hashed by using an SHA-256 algorithm to generate a unique hash value as a group character string. After generating the group character string, the application may obtain a predetermined relationship comparison table maintained by the server. This is typically implemented by transmitting an API request to the server. After verifying the legitimacy of the request, the server returns all current candidate groups and the corresponding recorded character strings. The application compares the generated group character string with all recorded character strings in the predetermined relationship comparison table. This may be implemented by traversing the predetermined relationship comparison table and comparing the group character string with each candidate character string one by one to determine whether the strings are identical. If the generated group character string is different from all recorded character strings, it may be determined that the group character string is unique and satisfies the first condition. If the generated group character string is identical to any candidate character string, it indicates that the group character string already exists and does not satisfy the first condition, and thus may be regenerated. Once it is determined that the group character string is unique, the application codes the group character string into an entry link. For example, the group character string is coded using URL coding rules and combined with a domain name of the application to generate a unique entry link. The application displays the generated entry link to user A. User A may share this link with other users to invite the other users to join the "Vegetarianism Discussion" group. The predetermined relationship comparison table is obtained, the group character string is compared with recorded character strings, the uniqueness of the group character string is determined, and a unique entry link is generated. This design helps ensure that each group has a unique identifier, prevents conflicts of group character strings, and improves the reliability and user experience of the application.

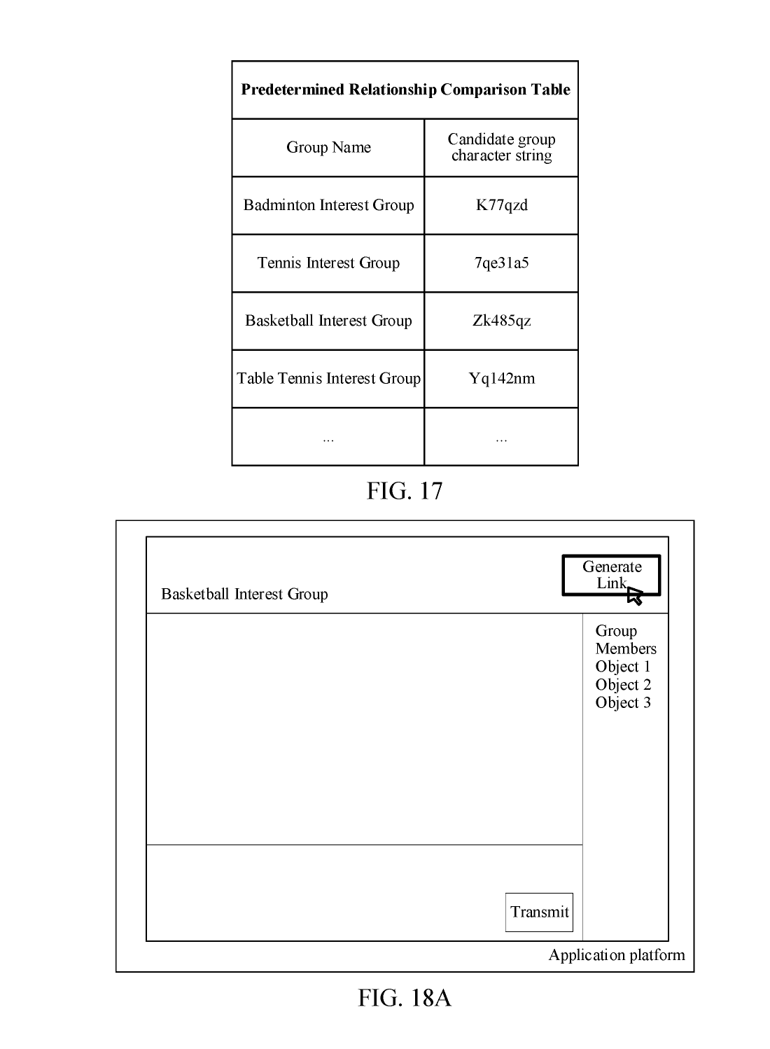

FIG. 17 shows a schematic structural diagram of a predetermined relationship comparison table. Specifically, in the predetermined relationship comparison table, the candidate group character string of each candidate group is a key, and the group name of each candidate group is a value, so that group information such as the group name of each candidate group can be found through the candidate group character string. A candidate group character string "K77qzd" indicates a badminton interest group. A candidate group character string "7qe31a5" indicates a tennis interest group. A candidate group character string "Zk485qz" indicates a basketball interest group. A candidate group character string "Yq142nm" indicates a table tennis interest group.

An advantage of some aspects is that the predetermined relationship comparison table stores group information and group character strings of each group in the form of key-value pairs, with the group character string as a search key and the group information as a value, thereby searching and extracting the group information of each group according to the group character string (or entry link), and improving the efficiency of group information search and group information transmission. In addition, the relationship comparison table may be used to check whether each newly generated group character string conflicts with an existing group character string, helping ensure that the group character string (or entry link) of each group is unique.

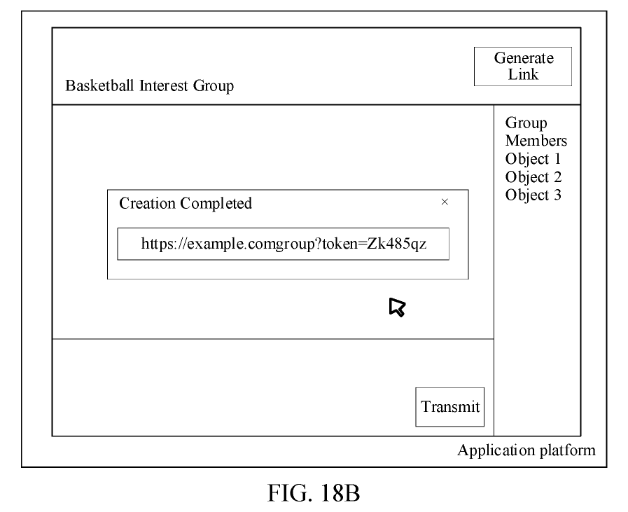

As shown in FIG. 18A, group members include object 1, object 2, and object 3. After object 1 opens a session page of a basketball interest group and intends to generate an entry link of the basketball interest group, object 1 clicks/taps a "Generate Link" button on the session page, so that the server creates an entry link for the basketball interest group.

As shown in FIG. 18B, group members include object 1, object 2, and object 3. When an entry link is generated, a notification message "Creation Successful" is displayed on a session page, together with the entry link of a basketball interest group: "https://example.comgroup?token=Zk485qz". At this time, object 1 may copy the entry link and paste the entry link into any editing region in the application platform.

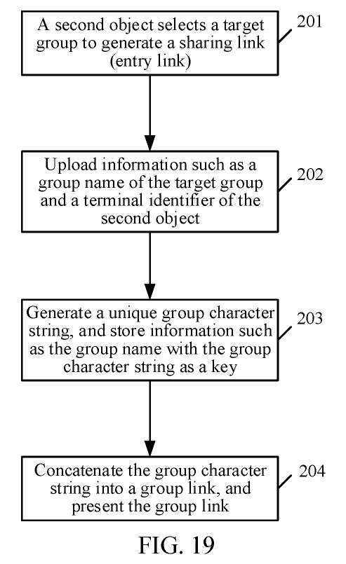

FIG. 19 shows a process executed by an application server when creating an entry link of a target group. In operation 201, a second entity selects a target group to generate a sharing link. In operation 202, information such as a group name of the target group and a terminal identifier of the second entity is uploaded. In operation 203, a unique group character string is generated, and information such as the group name is stored with the group character string as a key. In operation 204, the group character string is concatenated into a group link, and the group link is presented. Specifically, the second entity first selects to generate a sharing link (entry link) for a target group on a session page of the target group. Next, stored information such as a group name of the target group and a terminal identifier of the second entity is uploaded to the server. The server generates a unique group character string based on the information such as the group name of the target group and the terminal identifier of the second entity and stores the information such as the group name as a value with the group character string as a key. Finally, the group character string is concatenated into a group link, and the group link is presented. An implementation process is similar to the foregoing operations 1510 to 1540. To save space, no repeat will be provided.

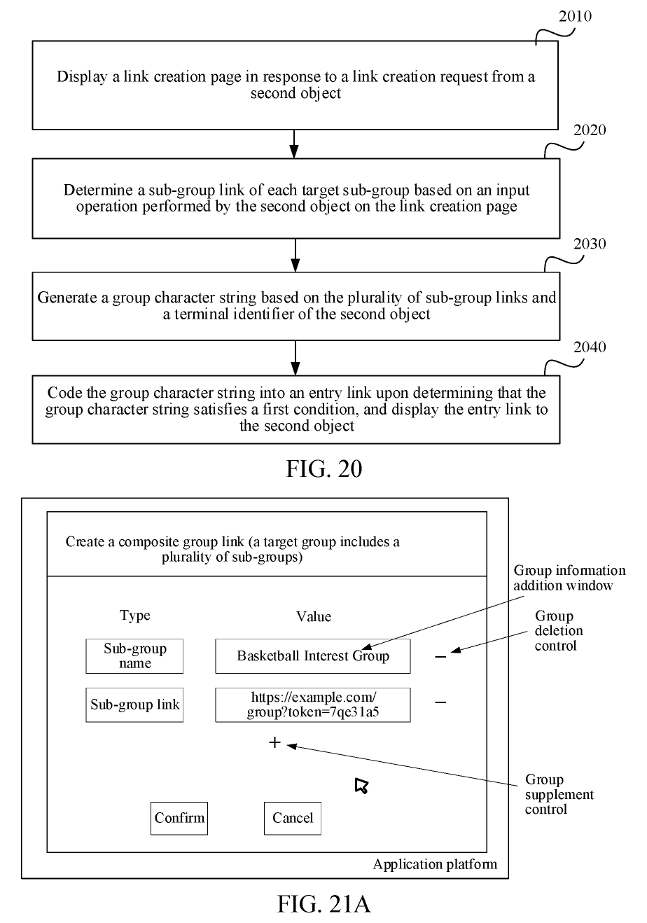

Referring to FIG. 20, in some embodiments, when the target group includes a plurality of sub-groups, the process of creating the target group specifically includes, but is not limited to, the following operations 2010 to 2040:
Operation 2010: Display a link creation page in response to a link creation request from a second entity.
Operation 2020: Determine a sub-group link of each target sub-group based on an input operation performed by the second entity on the link creation page.
Operation 2030: Generate a group character string based on the plurality of sub-group links and a terminal identifier of the second entity.
Operation 2040: Code the group character string into an entry link upon determining that the group character string satisfies a first condition and display the entry link to the second entity.

The following describes operations 2010 to 2040 in further detail.

In operation 2010, a link creation page is displayed in response to a link creation request from a second entity.

The link creation page is configured to provide an object with a function of integrating a plurality of groups into a large group and creating an entry link of the large group, so as to realize aggregation and nesting among groups and enable the object to quickly access the plurality of groups.

In an implementation of some aspects, when the second entity logs into the application platform and intends to share a plurality of groups through a single entry link, the second entity transmits a link creation request and triggers a composite group link generation process on the application platform. Based on this, the server displays a link creation page on the application platform in response to the link creation request of the second entity, so that the second entity adds group information of a plurality of groups to be integrated and shared in the same entry link, where the group information includes, but is not limited to, a group link (entry link) and a group name of each group.

In some embodiments, when the second entity intends to share a plurality of groups through a single entry link, the application may provide a link creation page for the object to integrate the plurality of groups and create an entry link of a large group. The second entity logs into the application platform and enters an interface where a composite group link is to be created. The object clicks/taps a button or option for creating a link and transmits a link creation request. After receiving the link creation request, the application triggers the composite group link generation process, which is intended to allow the object to integrate a plurality of groups into a large group and create a unified entry link. The server displays a link creation page on the application platform in response to the link creation request. The link creation page provides a user interface that allows the object to add and manage groups to be integrated. The object adds group information of the plurality of groups to be integrated on the link creation page. The group information includes, but is not limited to, a group link (entry link) and a group name of each group. The object may view and manage a list of added groups. The object may add new groups, or delete or edit existing group information. Once the object completes the addition and management of groups, the object may click/tap a button for generating a link. The application collects all added group information and generates a composite group link. The composite group link allows the object to access a plurality of groups through a single entry link. When other users click/tap the link, the users are able to access all integrated groups, realizing aggregation and nesting among groups. The object may share the generated composite group link with other users via email, social media, or other means. The other users may be quickly invited to join a plurality of groups, thereby improving the efficiency of social interaction. The application is capable of responding to the link creation request of the second entity, displaying the link creation page, and allowing the object to integrate a plurality of groups, and create a unified entry link.

In operation 2020, a sub-group link of each target sub-group is determined based on an input operation performed by the second entity on the link creation page.

The sub-group link is connected to a session page of the target sub-group, so that an object quickly navigates to or accesses the session page of the target sub-group.

In an implementation of some aspects, the target group corresponding to the entry link to be created by the second entity is a parent group of a plurality of groups to be shared, and the plurality of groups to be shared through a single entry link are a plurality of target sub-groups of the target group. Based on this, the second entity first inputs group information of each target sub-group (e.g., a group name and an entry link of the target sub-group) on the link creation page. Next, the server extracts content inputted by the second entity for each target sub-group in response to an input operation of the second entity on the link creation page, so as to obtain a sub-group link of each target sub-group.

In some embodiments, when creating an entry link capable of sharing a plurality of groups, the second entity may specify detailed information of each target sub-group on the link creation page. The second entity logs into the application platform and enters the link creation page. This page provides an interface for inputting and managing group information. The object inputs group information of each target sub-group on the link creation page. Such information typically includes a group name and an entry link of the target sub-group. The object may input such information manually, or select and add the information from an existing group list in the application. The server parses and extracts the input content in response to the input operation of the second entity. The server identifies and extracts the entry link of each target sub-group. Such link is a URL connected to the session page of the target sub-group. To help ensure validity of sub-group links, the server may verify each link. The verification process may include checking whether the link points to a valid group page and whether the object has permission to access these groups. Once the sub-group links are extracted and verified, the server associates the links with the target group and stores the links in a database of the application. Based on the stored sub-group links, the server generates a composite group link. The link contains information of entry links pointing to all target sub-groups. The composite group link may be a unique URL. When a user clicks/taps the link, a list of all target sub-groups is displayed, or the user is directly navigated to session pages of these groups. The second entity may share the generated composite group link with other users through various channels such as email and social media. Users receiving the link may click/tap the link to quickly access all integrated target sub-groups, enjoying a convenient group access experience.

To save space, the process of determining a sub-group link of each target sub-group based on an input operation performed by the second entity on the link creation page according to embodiments of this disclosure will be described in further detail below. Details are not described herein again.

An implementation processes of operations 2030 and 2040 are similar to the foregoing operations 1530 and 1540. The difference lies in that the group character string in operation 1530 is generated according to a target group name and a terminal identifier, while the group character string in operation 2030 is generated according to a plurality of sub-group links and a terminal identifier. To save space, no repeat will be provided.

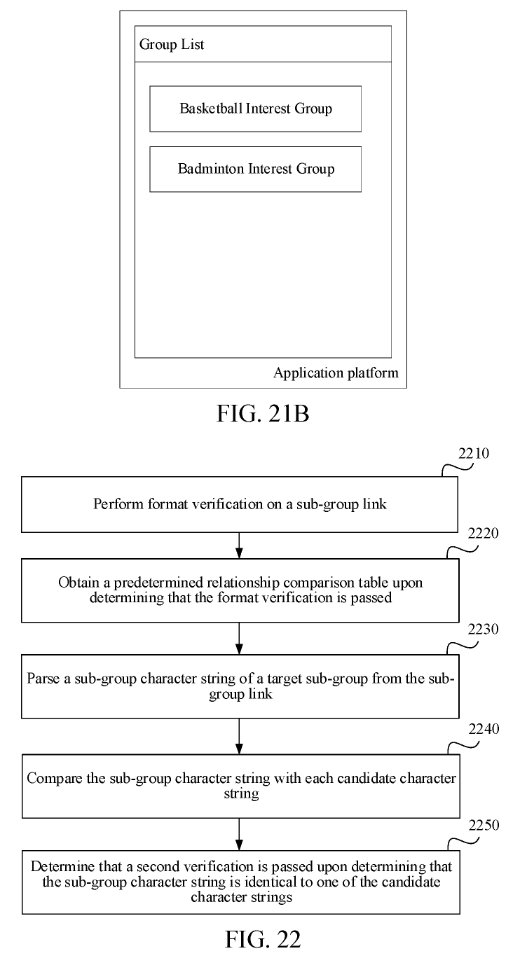

As shown in FIG. 21A, when the second entity intends to create a common entry link for a plurality of groups, a page of a composite group link creation process is displayed on the application platform. The page displays a type editing region for selecting an information entry type of a sub-group, and a value editing region for entering specific information of the sub-group. In addition, the page is also provided with a group deletion control for deleting group information of a particular sub-group, and a group supplement control for adding a group information entry region for a sub-group. At this time, the second entity selects "Sub-group Name" as an entry information type of a particular sub-group in the type editing region of a first row, and then inputs "Basketball Interest Group" in the value editing region of the first row. Similarly, the second entity selects "Sub-group Link" as an entry information type of a particular sub-group in the type editing region of a second row, and then inputs an entry link of a tennis interest group "https://example.com/group?token=7qe31a5" in the value editing region of the second row, so as to create a common entry link for the basketball interest group and the tennis interest group.

As shown in FIG. 21B, when the second entity selects "Sub-group Name" as an entry information type of a target sub-group in the type editing region of the first row and the second entity clicks/taps the value editing region of the first row, a group list consisting of all groups in the application platform is displayed in the form of a pop-up window. The group list includes the basketball interest group and the badminton interest group. At this time, if the second entity selects the basketball interest group in the group list, "Basketball Interest Group" is displayed in the value editing region of the first row, enabling the second entity to quickly select a group to be added, and automatically filling the value editing region corresponding to "Sub-group Name" according to a selection operation of the second entity.

An advantage of some aspects is that a manner of packaging group links of a plurality of groups into a new entry link is provided, realizing composition of group links of a plurality of target sub-groups. A common entry link can be generated according to the group name or group link of each target sub-group, enabling the object to quickly access a plurality of groups by clicking/tapping a nested link (entry link). The object may share a plurality of groups with other objects by sharing one entry link, which brings convenience for the object to quickly access a plurality of groups and also improves the efficiency of group information transmission.

Since the second entity may input a sub-group name or a sub-group link of the target sub-group on the link creation page, the processing manner of the server varies to some extent when different group information is inputted by the second entity.

In some embodiments, the determining a sub-group link of each target sub-group includes:
generating, upon determining that the second entity inputs a sub-group name of a target sub-group on the link creation page, a sub-group character string based on the sub-group name and coding the sub-group character string into the sub-group link.

In an implementation of some aspects, if it is determined that the second entity inputs a sub-group name of the target sub-group on the link creation page, a sub-group link of the target sub-group may be generated according to the sub-group name. An implementation process is similar to the manner of generating an entry link in the foregoing operations 1530 and 1540. To save space, no repeat will be provided.

Upon determining that the second entity inputs a sub-group link of the target sub-group on the link creation page, a second verification is performed on the sub-group link, and the sub-group link that passes the second verification is used to generate the group character string.

In an implementation of some aspects, if it is determined that the second entity inputs a sub-group link of the target sub-group on the link creation page, format verification and correctness verification may be performed on the inputted sub-group link to help ensure that the inputted sub-group link is correct. Next, the sub-group links that pass the second verification and sub-group links of other target sub-groups form a group link list, and a group character string is generated by using a plurality of sub-group links in the group link list.

An advantage of some aspects is that corresponding processing operations are provided respectively in consideration of different group information of the inputted target sub-groups. An inputted sub-group name is converted into a sub-group link. A verification operation is performed on an inputted sub-group link, thereby generating sub-group links of each target sub-group to be composed, so as to compose a plurality of sub-group links into one entry link, thereby improving group management efficiency.

Referring to FIG. 22, in some embodiments, the process of performing a second verification on the sub-group link specifically includes, but is not limited to, the following operations 2210 to 2250:
Operation 2210: Perform format verification on a sub-group link.
Operation 2220: Obtain a predetermined relationship comparison table upon determining that the format verification is passed.
Operation 2230: Parse a sub-group character string of a target sub-group from the sub-group link.
Operation 2240: Compare the sub-group character string with each candidate character string.
Operation 2250: Determine that a second verification is passed upon determining that the sub-group character string is identical to one of the recorded character strings.

The following describes operations 2210 to 2250 in further detail.

The predetermined relationship comparison table is configured to indicate corresponding relationships between respective candidate groups and recorded character strings, has been schematically described in FIG. 17, and will not be repeated here.

In operation 2210, a link format required for entry links of all groups in the application platform is first invoked. Next, format verification is performed on the sub-group link according to the link format required for entry links of all groups, so as to determine whether a format of the sub-group link is consistent with the link format.

In some embodiments, entry links of all groups in the application platform may comply with a particular format specification to help ensure uniformity and identifiability of the links. The application platform first defines a format of entry links. The format may include a protocol (e.g., HTTP or HTTPS), a domain name, a path, query parameters, and the like. For example, a typical entry link format may be: 'https://example.com/group?id=GROUP_ID', where 'GROUP_ID' is a unique identifier of the group. The application stores the defined link format in a configuration file or a database of the server for invocation and verification when needed. When an entry link may be generated or verified, the application invokes the predefined link format from the configuration file or the database. This is implemented through variables or constants in a programming language to help ensure consistency and maintainability of the link format. Performing format verification on the sub-group link is an operation to help ensure the validity and security of the link. The application checks whether the sub-group link conforms to the defined link format by using a regular expression or other character string processing methods. For example, a regular expression may be used to match the protocol, domain name, path, and query parameters of the link. The application traverses each sub-group link and performs format verification one by one. If the format of the sub-group link is consistent with the defined link format, the verification is passed. If the format of the sub-group link is inconsistent, the verification fails, and the application may notify a user or take other measures. For sub-group links that pass the verification, the application may continue to use the sub-group links to generate a composite group. For sub-group links that fail the verification, the application may notify the user to re-enter or correct the link format. To improve efficiency, the application may automate the format verification process and provide real-time feedback to the user on whether the link meets requirements. This may be implemented through front-end JavaScript verification or back-end server verification.

In operation 2220, if the format of the sub-group link is consistent with the required link format, it is determined that the format verification is passed, indicating that the inputted sub-group link conforms to the predetermined group link format, and correctness and existence verification may be performed on the sub-group link. Based on this, the predetermined relationship comparison table is obtained in the manner of the foregoing operation 1610. If the format of the sub-group link is inconsistent with the required link format, it is determined that the format verification is not passed, and the second verification is not passed, reminding the second entity to re-enter a correct sub-group link.

In some embodiments, if the format of the sub-group link is consistent with the defined link format, the application determines that the format verification is passed. The inputted sub-group link is structurally correct and conforms to the format expected by the application. Although the format verification is passed, the application may further verify the correctness and existence of the sub-group link, so as to help ensure that the link is not only structurally correct but also actually points to a valid group. The application obtains the predetermined relationship comparison table maintained by the server according to the operations defined above. The comparison table contains all existing groups and corresponding group character strings. The application compares the group identifier in the sub-group link with records in the predetermined relationship comparison table. If the group identifier exists in the comparison table and the corresponding information is consistent, the verification is passed. If the group identifier does not exist or the information is inconsistent, the verification fails. If the correctness and existence verification is passed, the application may continue to use the sub-group link to generate a composite group. If the verification fails, the application may notify the second entity and require re-entering a correct sub-group link. If the format of the sub-group link is inconsistent with the defined link format, the application determines that the format verification is not passed. The inputted link is structurally wrong and does not conform to the format expected by the application. For a sub-group link that fails the format verification, the application may remind the second entity to re-enter a correct link. This is implemented by displaying an error message, highlighting an input box, or providing a format guide. To improve user experience, the application may provide real-time format verification feedback to help the second entity correct input errors in a timely manner. This is implemented through front-end JavaScript verification to check whether the inputted link format is correct in real time.

In operation 2230, since the sub-group link is composed of a fixed character string and a group character string, the sub-group link is split according to the link format, thereby parsing the sub-group character string of the target sub-group.

In some embodiments, the application may clarify the format of the sub-group link. The link format may be 'https://example.com/group?id=GROUP_STRING', where 'GROUP_STRING' is the group character string. The fixed character string part includes a protocol (e.g., 'https://'), a domain name (e.g., 'example.com'), and a path (e.g., '/group'). The application splits the sub-group link into a fixed character string part and a group character string part by using a character string processing method. Once the link is split, the application may extract the group character string part. For example, if the link is '://example.com/group?id=abc123', the group character string is 'abc123'. If the group character string contains URL-coded characters, the application may decode the character string to obtain an original group character string. For example, if the group character string is 'abc%20123', the application may decode the character string into 'abc 123'. After extracting the group character string, the application may verify the group character string to help ensure that the group character string conforms to an expected format and length. Once the verification is passed, the application may store the group character string in a memory or directly use the group character string to access the session page of the target sub-group. If an error occurs during splitting or extracting the group character string, the application may catch the error and provide appropriate feedback to the user. For example, if the link format is incorrect, the application may display an error message notifying the user to re-enter a correct link.

In operation 2240, for each candidate character string, the candidate character string is compared with the sub-group character string, so as to determine whether the sub-group character string in the inputted sub-group link is a group character string of a particular group.

In some embodiments, the application may obtain a predetermined relationship comparison table maintained by the server. The comparison table contains all existing groups and corresponding group character strings. The application extracts the sub-group character string from the inputted sub-group link. This is typically implemented by parsing a specific part of the link. The application compares each candidate character string with the sub-group character string. This may be implemented through a simple character string comparison operation. If the sub-group character string is identical to a particular candidate character string, it may be determined that the sub-group character string in the inputted sub-group link corresponds to a group to which the candidate character string belongs. Once a matching candidate character string is found, the application may record a matching result, including an identifier and name of the group. According to the matching result, the application may perform a corresponding operation, for example, allowing a user to access the session page of the group or adding the group to a composite group link. If the sub-group character string does not match any candidate character string, it may be determined that the sub-group character string in the inputted sub-group link does not correspond to any existing group. The application may notify the user that the inputted link may be incorrect or the group does not exist. The application may use a data structure (e.g., a hash table) to store the recorded character strings in the predetermined relationship comparison table, so that the comparison process may be completed in constant time.

In operation 2250, upon determining that the sub-group character string is identical to one candidate character string, indicating that the inputted sub-group character string actually exists and can point to a group, it is determined that the second verification is passed. Upon determining that the sub-group character string is different from any candidate character string, indicating that the inputted sub-group character string does not exist and cannot point to a group, it is determined that the second verification is not passed.

In some embodiments, the application compares the inputted sub-group character string with each candidate character string in the predetermined relationship comparison table. The comparison table contains all existing groups and corresponding group character strings. If the sub-group character string is identical to a particular candidate character string, it may be determined that the inputted sub-group character string actually exists and can point to a corresponding group. When the sub-group character string matches one candidate character string, the application determines that the second verification is passed. The inputted sub-group link is valid and may be configured to access or integrate the corresponding group. The application may record the matched group information, such as the identifier and name of the group, which may be configured to perform operations such as generating a composite group link or allowing the user to access the group. If the sub-group character string is different from all recorded character strings, it may be determined that the inputted sub-group character string does not exist and may not point to any group. When the sub-group character string does not match all recorded character strings, the application determines that the second verification is not passed. This means that the inputted sub-group link is invalid and may not be configured to access or integrate a group. In a case that the second verification is not passed, the application may notify the user that the inputted link may be incorrect or the group does not exist. This is implemented by displaying an error message, notifying the user to re-enter the link, and the like.

An advantage of some aspects is that format verification is performed on the inputted sub-group link, and when it is determined that the inputted sub-group link conforms to the predetermined group link format, correctness and existence verification is performed on the sub-group link according to recorded character strings of each candidate group stored in the predetermined relationship comparison table, so as to determine that the inputted sub-group link actually exists and can accurately point to a particular group in the application, improving the accuracy of link creation.

In one or more embodiments of this disclosure, the link creation page is provided with a plurality of group information addition windows and a group supplement control.

The group information addition window is configured to provide the object with a function of adding a sub-group name or a sub-group link of the target sub-group.

The group supplement control is configured to add a group information entry region for a sub-group, so as to increase the number of target sub-groups in a target group to be composed.

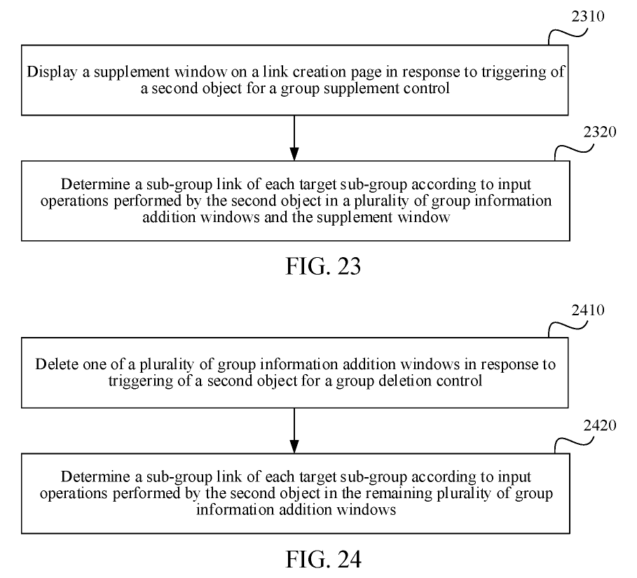

Referring to FIG. 23, in some embodiments, operation 2020 specifically includes, but is not limited to, the following operations 2310 to 2320:
Operation 2310: Display a supplement window on a link creation page in response to triggering of a second entity for a group supplement control.
Operation 2320: Determine a sub-group link of each target sub-group according to input operations performed by the second entity in a plurality of group information addition windows and the supplement window.

The following describes operations 2310 and 2320 in further detail.

In operation 2310, after the second entity fills in the sub-group information of each target sub-group in the sub-group information editing region displayed on the link creation page, if the sub-group information of the target sub-groups to be included has not been properly entered, the second entity may trigger a group supplement control on the link creation page. Based on this, the server detects a trigger event for the group supplement control, and continues to display a plurality of supplement windows on the link creation page, so that the second entity can further input the sub-group information of the target sub-groups to be included.

In some embodiments, on the application platform, when the second entity edits sub-group information on the link creation page, the second entity may need to add a plurality of target sub-groups. If the second entity has not completed the input of all target sub-groups, the second entity may trigger the group supplement control to continue adding more sub-group information. The second entity inputs information of each target sub-group in the sub-group information editing region of the link creation page, where such information typically includes a group name and an entry link. When the second entity determines that more target sub-groups need to be added, the second entity triggers the group supplement control on the link creation page. This is typically a button or link labeled with words such as "Add More" or "Supplement Group". The server detects the trigger event of the group supplement control through front-end JavaScript or other technologies. The second entity may continue to input the sub-group information of the target sub-groups to be included in new supplement windows. This process may be repeated multiple times until the second entity completes the input of all target sub-groups. For each newly added sub-group information, the application performs format verification and existence verification to help ensure that the inputted information is valid and correct. Once the verification is passed, the server stores such information in a database and associates the information with the composite group link. When the information of all target sub-groups has been inputted and verified, the server generates a composite group link containing entry links of all target sub-groups. The application enables the second entity to dynamically add information of a plurality of target sub-groups on the link creation page, improving the flexibility of the user interface and user experience.

An implementation process of operation 2320 is similar to the foregoing two situations of determining the sub-group link of each target sub-group. To save space, no repeat will be provided.

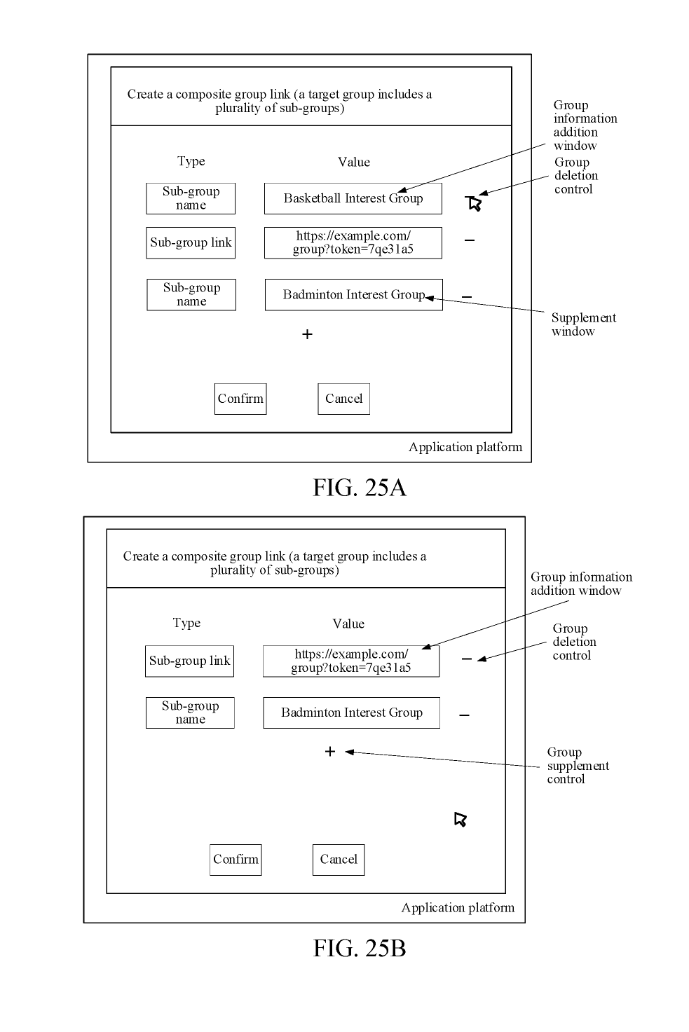

As shown in FIG. 25A, after the second entity inputs sub-group information of a basketball interest group and a tennis interest group in two rows of editing regions displayed on a link creation page, if more sub-group information may be entered, the second entity clicks/taps a group supplement control (a plus button in the figure) on the link creation page. At this time, a new editing row (supplement window) is displayed on the link creation page. Based on this, the second entity selects "Sub-group Name" in a type editing region of the newly added editing row, and inputs "Badminton Interest Group" in a value editing region, so that a generated entry link can simultaneously navigate other objects to the basketball interest group, the tennis interest group, and the badminton interest group.

An advantage of some aspects is that an input channel for adding group information of target sub-groups of a target group is provided, which can flexibly and freely determine the number of target sub-groups to be included in one target group, improving the flexibility and diversity of group management.

In one or more embodiments of this disclosure, the link creation page is provided with a plurality of group information addition windows and a group deletion control.

The group deletion control is configured to delete group information of a particular sub-group, so as to reduce the number of target sub-groups in a target group to be composed.

Referring to FIG. 24, in some embodiments, operation 2020 specifically includes, but is not limited to, the following operations 2410 to 2420:
Operation 2410: Delete one of a plurality of group information addition windows in response to triggering of a second entity for a group deletion control.
Operation 2420: Determine a sub-group link of each target sub-group according to input operations performed by the second entity in the remaining plurality of group information addition windows.

The following describes operations 2310 and 2320 in further detail.

In operation 2410, if the second entity finds that some sub-groups are not suitable to be placed in the target group after filling in the sub-group information of each target sub-group in the sub-group information editing region displayed on the link creation page, the second entity triggers a group deletion control corresponding to a target sub-group to be deleted on the link creation page. Based on this, the server detects a trigger event for the group deletion control of the target sub-group and clears an editing row corresponding to the target sub-group as well as sub-group information in the editing row on the link creation page.

In some embodiments, on the application platform, when creating a composite group link, the second entity may find that some sub-groups added thereby are not suitable to be included in the target group. At this time, the second entity may remove such unsuitable sub-groups by triggering the group deletion control. The second entity inputs or selects information of each target sub-group in the sub-group information editing region of the link creation page, where such information typically includes a group name and an entry link. After completing the input of all sub-group information, the second entity may review these sub-groups and find that some sub-groups are not suitable to be included in the target group. For each unsuitable sub-group, the second entity triggers the corresponding group deletion control on the link creation page. This is typically a button, link or icon labeled with words such as "Delete" or "Remove", located beside each sub-group information editing row. The server detects the trigger event of the group deletion control through front-end JavaScript or other technologies, which involves transmitting an AJAX request to the server to notify the server of the need to delete specific sub-group information. Once the server detects the trigger event, the server responds to the request and clears an editing row corresponding to the target sub-group as well as all sub-group information in the editing row on the link creation page. After deleting the sub-group information, the server updates the composite group link and removes the entry link of the deleted sub-group. This helps ensure that the finally generated composite group link only contains target sub-groups deemed suitable by the second entity. If the second entity is satisfied with the selection of sub-groups, the changes may be saved. The server stores the updated sub-group information in a database and associates the information with the composite group link. The server generates a composite group link containing entry links of all selected target sub-groups. Such link may be shared by the second entity with other users for the users to access all integrated target sub-groups. The application enables the second entity to dynamically remove unsuitable sub-groups during the link creation process, improving the flexibility of the user interface and user experience. Such design allows a user to easily adjust and optimize the composite group link to help ensure that the link only contains relevant and suitable target sub-groups.

An implementation process of operation 2420 is similar to the foregoing two situations of determining the sub-group link of each target sub-group. To save space, no repeat will be provided.

As shown in FIG. 25B, after the second entity inputs sub-group information of a basketball interest group, a tennis interest group, and a badminton interest group in a plurality of editing regions displayed on a link creation page, the second entity intends that a generated entry link navigates other objects to the tennis interest group and the badminton interest group, but not to the basketball interest group. At this time, the second entity clicks/taps a group deletion control (a minus button in the figure) behind an editing row of the sub-group information of the basketball interest group, deletes the group information of the basketball interest group on a link creation page, and only retains a group link of the tennis interest group and a group name of the badminton interest group.

An advantage of some aspects is that an input channel for deleting group information of target sub-groups of a target group is provided, which can flexibly and freely adjust target sub-groups to be included in one target group, improving the flexibility of group management.

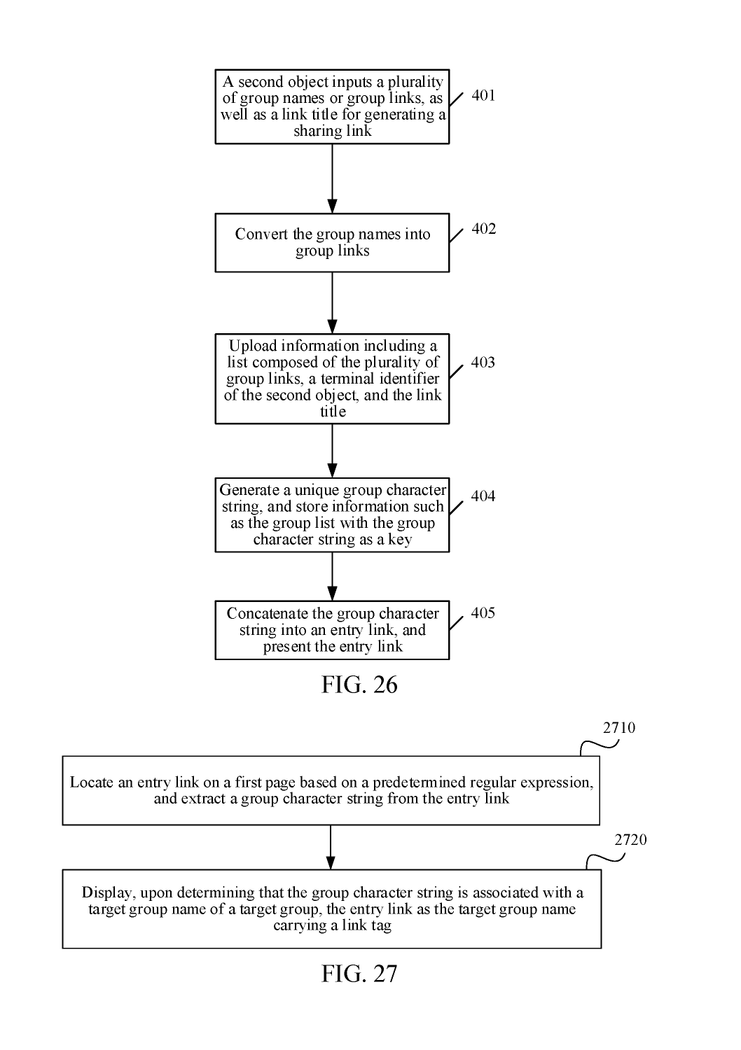

FIG. 26 is an overall flowchart of creating an entry link according to another embodiment of this disclosure. In operation 401, a second entity inputs a plurality of group names or group links, as well as a link title for generating a sharing link. In operation 402, the group names are converted into group links. In operation 403, information including a list composed of the plurality of group links, a terminal identifier of the second entity, and the link title is uploaded. In operation 404, a unique group character string is generated, and information such as the group list is stored with the group character string as a key. In operation 405, the group character string is concatenated into an entry link, and the entry link is presented. A process is executed by the application server when creating an entry link of a target group composed of a plurality of sub-groups. Specifically, the second entity first inputs a plurality of group names or group links, as well as a link title of the target group on the link creation page for generating a sharing link. An implementation process is similar to the foregoing operations 2010 and 2020. Next, a front-end server of the application converts the group names inputted by the second entity into corresponding group links, and uploads a list composed of a plurality of group links, the terminal identifier of the second entity, and the link title to a back-end server of the application. The back-end server generates a unique group character string, and stores information such as the group list with the group character string as a key. Finally, the group character string is concatenated into an entry link, and the entry link is presented. An implementation process is similar to the foregoing operations 2030 and 2040. To save space, no repeat will be provided.

### Detailed Descriptions of Displaying Entry Link as Target Group Name Carrying Link Tag in Embodiments of this Disclosure

Since the entry link according to one or more embodiments of this disclosure may exist in a plurality of scenarios such as a session window, group announcement, and documents, when the entry link is placed together with other text data, it is often necessary to identify and present the entry link in dense text data so as to clearly indicate the corresponding target group according to the entry link. Based on this, embodiments of this disclosure provide a solution for identifying and presenting entry links based on regular expressions, which can improve the positioning efficiency of entry links and the transmission efficiency of group information.

Referring to FIG. 27, in some embodiments, the process of displaying an entry link as a target group name carrying a link tag specifically includes, but is not limited to, the following operations 2710 and 2720:
Operation 2710: Locate an entry link on a first page based on a predetermined regular expression and extract a group character string from the entry link.
Operation 2720: Display, upon determining that the group character string is associated with a target group name of a target group, the entry link as the target group name carrying a link tag.

The following describes operations 2710 and 2720 in further detail.

In operation 2710, the predetermined regular expression is configured to indicate a correct expression form of the entry link of the target group. The predetermined regular expression may be understood as a correct link format of the entry link.

In an implementation of some aspects, the server first checks whether content matching the predetermined regular expression exists in the first page. Next, the content matching the predetermined regular expression is regarded as the located entry link. Finally, splitting and character string extraction are performed according to the link format required for the entry link to obtain the group character string in the entry link.

In operation 2720, an identical candidate character string is first searched in the predetermined relationship comparison table according to the group character string, and group information corresponding to the candidate character string identical to the group character string is extracted. A specific process is similar to the foregoing operations 2220 to 2250. Next, if a candidate character string identical to the group character string exists, it is determined that the group character string is associated with the target group name of the target group, the group name is parsed from the extracted group information, and the target group name carrying the link tag is constructed. Finally, the entry link is displayed as the target group name carrying the link tag.

In some embodiments, the application first searches in the predetermined relationship comparison table according to the group character string. The table contains all existing groups and corresponding group character strings. If a candidate character string identical to the group character string is found, the application extracts group information corresponding to the candidate character string. Such information typically includes a group name, a group identifier, and the like. The application parses the group name from the extracted group information. This is typically a field in the group information, directly representing the group name. The application combines the parsed group name with the entry link to construct a target group name carrying a link tag. This typically involves wrapping the group name in an HTML '<a>' tag to form a clickable/tappable link. The application displays the target group name carrying the link tag to a user. When the user clicks/taps the link, the user is redirected to the session page of the corresponding target group.

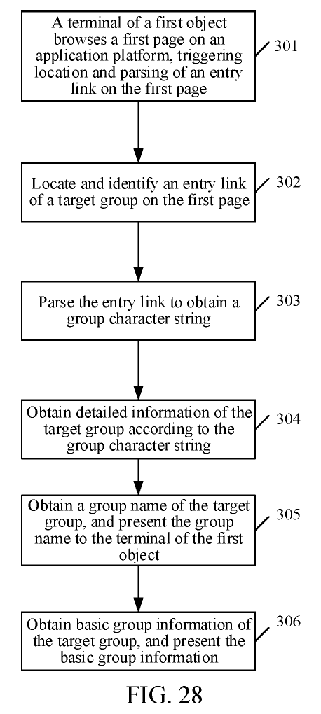

Referring to FIG. 28, FIG. 28 is an overall flowchart of presenting a group name and basic group information according to another embodiment of this disclosure. In operation 301, a terminal of a first entity browses a first page on an application platform, triggering location and parsing of an entry link on the first page. In operation 302, an entry link of a target group is located and identified on the first page. In operation 303, the entry link is parsed to obtain a group character string. In operation 304, detailed information of the target group is obtained according to the group character string. In operation 305, basic group information of the target group is obtained, and the basic group information is presented. A process is executed by the application server when parsing an entry link and displaying the entry link as a target group name carrying a link tag Specifically, the terminal of the first entity first browses the first page on the application platform. Based on this, the server detects a browsing event of the terminal of the first entity on the first page, triggering location and parsing of the entry link on the first page. The server locates and identifies the entry link of the target group on the first page, and parses the entry link to obtain the group character string. A specific process is similar to the foregoing operation 2710.

In some embodiments, the server obtains detailed information of the target group according to the group character string, obtains a group name of the target group from the detailed information, and displays the group name to the terminal of the first entity. A specific process is similar to the foregoing operation 2720. Finally, basic group information of the target group is obtained from the detailed information, and the basic group information is presented. A specific process is similar to the foregoing operation 340. To save space, no repeat will be provided.

An advantage of some aspects is that an entry link is identified and located based on regular expressions, and a group character string in the entry link is extracted, so as to extract and present group information of a target group (e.g., target group name and basic group information) according to the group character string, thereby improving the location efficiency of the entry link and improving the transmission efficiency of group information.

### Diagram of Implementation Details of Group Presentation Method in Application according to Embodiments of this Disclosure

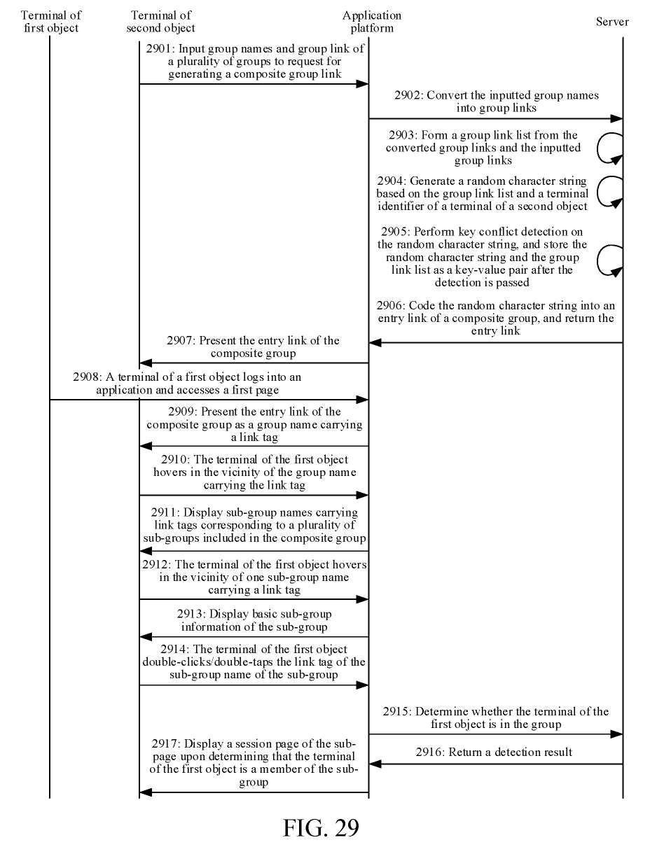

Implementation details of a group display method in an application according to embodiments of this disclosure are described below in further detail with reference to FIG. 29.

In operation 2901, a terminal of a second entity inputs group names and group link of a plurality of groups on an application platform to request for generating a composite group link.

In operation 2902, the application platform converts the inputted group names into corresponding group links through a server.

In operation 2903, the server forms a group link list from the converted group links and the inputted group links.

In operation 2904, the server generates a random character string based on the group link list and a terminal identifier of the terminal of the second entity.

In operation 2905, the server performs key conflict detection on the random character string, and stores the random character string and the group link list as a key-value pair after the detection is passed.

In operation 2906, the server codes the random character string into an entry link of a composite group and returns the entry link to the application platform.

In operation 2907, the application platform presents the entry link of the composite group to the terminal of the second entity.

In operation 2908, a terminal of a first entity logs into an application and accesses a first page.

In operation 2909, the application platform presents the entry link of the composite group as a group name carrying a link tag.

In operation 2910, a mouse of the terminal of the first entity hovers in the vicinity of the group name carrying the link tag.

In operation 2911, the application platform displays sub-group names carrying link tags corresponding to a plurality of sub-groups included in the composite group.

In operation 2912, the mouse of the terminal of the first entity hovers in the vicinity of one sub-group name carrying a link tag.

In operation 2913, the application platform displays basic sub-group information of the sub-group.

In operation 2914, the terminal of the first entity double-clicks/double-taps the link tag of the sub-group name of the sub-group.

In operation 2915, the application platform determines, through the server, whether the terminal of the first entity is in the sub-group.

In operation 2916, the server returns a detection result.

In operation 2917, if it is determined that the terminal of the first entity is a member of the sub-group, a session page of the sub-group is displayed.

Specific processes of operations 2901 to 2907 are similar to operations 2010 to 2040 in the foregoing embodiments. Specific processes of operations 2908 and 2909 are similar to operation 320 in the foregoing embodiments. Specific processes of operations 2910 to 2913 are similar to operation 330 in the foregoing embodiments. Specific processes of operations 2914 to 2917 are similar to operations 1110 and 1120 in the foregoing embodiments. To save space, no repeat will be provided herein.

### Descriptions of Apparatus and Device in Embodiments of this Disclosure

Although the operations are displayed sequentially according to the indications of the arrows in the flowcharts, these operations are not necessarily performed sequentially in the sequence indicated by the arrows. Unless otherwise explicitly specified in this disclosure, execution of these operations is not strictly limited by the sequence, and these operations may be performed in other sequences. Moreover, at least part of the operations in the foregoing flowcharts may include a plurality of operations or a plurality of stages. These operations or stages are not necessarily executed at the same time, but may be executed at different times. The order of execution of these operations or stages is not necessarily performed sequentially, but may be performed in turn or alternately with other operations or at least a part of operations or stages of other operations.

In an implementation of this disclosure, when related processing may be performed according to data related to a target object characteristic, such as attribute information or an attribute information set of a target object, permission or consent of the target object is first obtained. In addition, when the attribute information of the target object may be acquired in one or more embodiments of this disclosure, individual permission or individual consent of the target object is obtained through a pop-up window or skipping to a confirmation page. After the individual permission or the individual consent of the target object is explicitly obtained, necessary data related to the target object configured to enable one or more embodiments of this disclosure to operate normally are obtained.

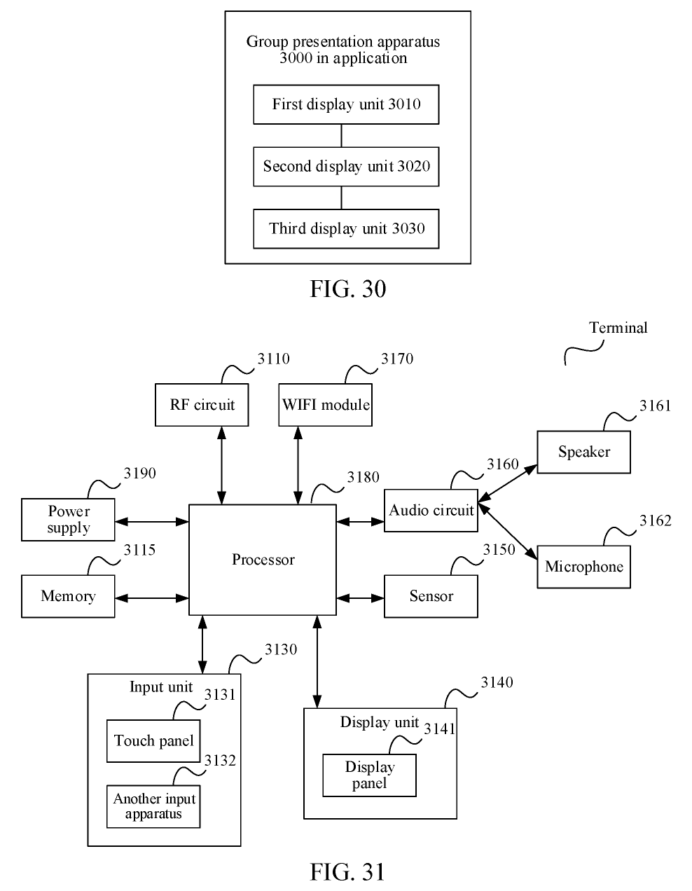

FIG. 30 is a schematic structural diagram of a group presentation apparatus 3000 in an application according to an embodiment of this disclosure. The group presentation apparatus 3000 in an application includes:
a first display unit 3010, configured to display a first page in the application, the first page including a target group name of a target group, the target group name carrying a link tag of an entry link of the target group, and the entry link being created by a second entity in the target group and associated with the target group name of the target group upon creation;
a second display unit 3020, configured to display basic information of the target group in response to a hover operation triggered in the vicinity of the target group name, a target region being a region on the first page where a distance from a display position of the target group name is less than a distance threshold, and the basic information being configured to notify the first entity whether to trigger the link tag; and
a third display unit 3030, configured to display a session page of the target group in response to triggering for the link tag.

In some embodiments, the target group name of the first page is determined in the following manner:
constructing, if the second entity of the target group has enabled name display for the terminal of the first entity when creating the entry link, the link tag of the entry link as the target group name.

In some embodiments, the target group name of the first page is determined in the following manner:
determining a group name specified for the terminal of the first entity by the second entity when creating the entry link as the target group name corresponding to the terminal of the first entity, the second entity specifying different group names for different object terminals when creating the entry link.

In some embodiments, the target group name of the first page is determined in the following manner:
determining, among a plurality of candidate group names, a candidate group name corresponding to a first preference of the terminal of the first entity as the target group name, the plurality of candidate group names being associated with the entry link when the second entity creates the entry link.

In some embodiments, the third display unit 3030 is configured to:
display, upon determining that the first entity is included in the target group, the session page of the target group in response to triggering for the link tag.

In some embodiments, the third display unit 3030 is configured to: obtain candidate terminal identifiers of terminals of respective candidate objects in the target group; and determine that the first entity is included in the target group upon determining that a terminal identifier of the terminal of the first entity is consistent with one of the candidate terminal identifiers.

In some embodiments, the third display unit 3030 is configured to:
display an inquiry message in response to triggering for the link tag, the inquiry message being configured to inquire the terminal of the first entity whether to display the session page of the target group; and
display the session page of the target group in response to a positive acknowledgment to the inquiry message.

In some embodiments, the third display unit 3030 is configured to:
transmit an authorization request to the second entity in response to triggering for the link tag; and
display the session page of the target group in response to receiving an authorization response from the second entity.

In some embodiments, the third display unit 3030 is configured to:
transmit, upon determining that the first entity is not included in the target group, the authorization request to the second entity in response to triggering for the link tag.

In some embodiments, the basic information of the target group includes at least one of information set by the second entity when creating the target group, or information extracted from the target group by an application platform based on basic information extraction rules.

In some embodiments, the target group includes a plurality of target sub-groups, and the entry link is synthesized based on sub-entry links created by the second entity for each target sub-group.

The basic information of the target group includes target sub-group names of the respective target sub-groups, the target sub-group name being associated with the target sub-group when the second entity creates the entry link, and the target sub-group name carrying the link tag.

The third display unit 3030 is configured to:
display a session page of the target sub-group in response to triggering for the link tag on the target sub-group name.

In some embodiments, the third display unit 3030 is configured to:
create the entry link of the target group in the following manners:
   displaying the session page of the target group to the second entity;
   obtaining the target group name of the target group and a terminal identifier of the second entity in response to a link creation operation performed by the second entity on the session page of the target group;
   generating a group character string based on the target group name and the terminal identifier; and
   coding the group character string into the entry link upon determining that the group character string satisfies a first condition and displaying the entry link to the second entity.

In some embodiments, the third display unit 3030 is configured to:
obtain a predetermined relationship comparison table, the predetermined relationship comparison table being configured to indicate corresponding relationships between respective candidate groups and recorded character strings;
compare the group character string with the respective recorded character strings; and
determine that the group character string satisfies the first condition upon determining that the group character string is different from the respective recorded character strings.

In some embodiments, the target group includes a plurality of target sub-groups.

The entry link of the target group is created by:
a display module (not shown), configured to display a link creation page in response to a link creation request from the second entity;
a determining module (not shown), configured to determine a sub-group link of each target sub-group based on an input operation performed by the second entity on the link creation page;
a generation module (not shown), configured to generate a group character string based on the plurality of sub-group links and a terminal identifier of the second entity; and
a coding module (not shown), configured to code the group character string into the entry link upon determining that the group character string satisfies a first condition, and display the entry link to the second entity.

In some embodiments, the determining a sub-group link of each target sub-group includes:
generating, upon determining that the second entity inputs a sub-group name of a target sub-group on the link creation page, a sub-group character string based on the sub-group name, and coding the sub-group character string into the sub-group link; and
performing, upon determining that the second entity inputs a sub-group link of the target sub-group on the link creation page, a second verification on the sub-group link, and using the sub-group link that passes the second verification to generate the group character string.

In some embodiments, the performing a second verification on the sub-group link includes:
performing format verification on the sub-group link;
obtaining, upon determining that the format verification is passed, a predetermined relationship comparison table, the predetermined relationship comparison table being configured to indicate corresponding relationships between respective candidate groups and recorded character strings;
parsing a sub-group character string of the target sub-group from the sub-group link;
comparing the sub-group character string with the respective recorded character strings; and
determining that the second verification is passed upon determining that the sub-group character string is identical to one of the recorded character strings.

In some embodiments, the link creation page is provided with a plurality of group information addition windows and a group supplement control.

The determining module (not shown) is configured to:
display a supplement window on the link creation page in response to triggering of the second entity for the group supplement control; and
determine a sub-group link of each target sub-group according to input operations performed by the second entity in the plurality of group information addition windows and the supplement window.

In some embodiments, the link creation page is provided with a plurality of group information addition windows and a group deletion control.

The determining module (not shown) is configured to:
delete one of the pluralities of group information addition windows in response to triggering of the second entity for the group deletion control; and
determine a sub-group link of each target sub-group according to input operations performed by the second entity in the remaining plurality of group information addition windows.

In some embodiments, the target group name is displayed in the following manners:
locating the entry link on the first page based on a predetermined regular expression and extracting a group character string from the entry link; and
displaying the entry link as the target group name carrying the link tag upon determining that the group character string is associated with the target group name of the target group.

In some embodiments, the terminal of the first entity included in the target group is determined in the following manners:
obtaining candidate terminal identifiers of terminals of respective candidate objects in the target group; and
determining that the terminal of the first entity is included in the target group upon determining that a terminal identifier of the terminal of the first entity is consistent with one of the candidate terminal identifiers.

In some embodiments, the authorization response from the second entity is generated in the following manners:
obtaining a terminal credibility of the terminal of the first entity and a creation timestamp;
determining a terminal score of the terminal of the first entity based on the terminal credibility and the creation timestamp; and
generating the authorization response if the terminal score is greater than a predetermined score.

Referring to FIG. 31, FIG. 31 is a structural block diagram of a part of a terminal implementing a group presentation method in an application according to an embodiment of this disclosure. The terminal includes components such as a radio frequency (RF) circuit 3110, a memory 3115, an input unit 3130, a display unit 3140, a sensor 3150, an audio circuit 3160, a Wi-Fi module 3170, processing circuitry (e.g., a processor 3180), and a power supply 3190. Those skilled in the art may understand that the terminal structure shown in FIG. 31 is not limited to a mobile phone or a computer, and may include more or few components than those shown, or combine some components, or have different component arrangements.

The RF circuit 3110 may be configured to receive and transmit signals during an information receiving and transmitting process or a call process. Specifically, the RF circuit receives downlink information from a base station, and then delivers the downlink information to the processor 3180 for processing. In addition, designed uplink data is transmitted to the base station.

The memory 3115 may include a non-transitory computer-readable storage medium configured to store software programs and modules. The processor 3180 executes various functional applications and data processing of an object terminal by running the software programs and modules stored in the memory 3115.

The input unit 3130 may be configured to receive input digital or character information and generate key signal input related to setting and function control of the object terminal. Specifically, the input unit 3130 may include a touch panel 3131 and another input apparatus 3132.

The display unit 3140 may be configured to display input information or provided information and various menus of the object terminal. The display unit 3140 may include a display panel 3141.

The audio circuit 3160, a speaker 3161, and a microphone 3162 may provide an audio interface.

In some aspects, the processor 3180 included in the terminal may perform the group presentation method in an application in one or more foregoing embodiments.

In one or more embodiments of this disclosure, the terminal includes, but is not limited to, a mobile phone, a computer, an intelligent voice interaction device, a smart home appliance, an in-vehicle terminal, an aircraft, and the like. Embodiments of the present disclosure may be applied to various scenarios, including but not limited to data security, blockchains, data storage, and information technology.

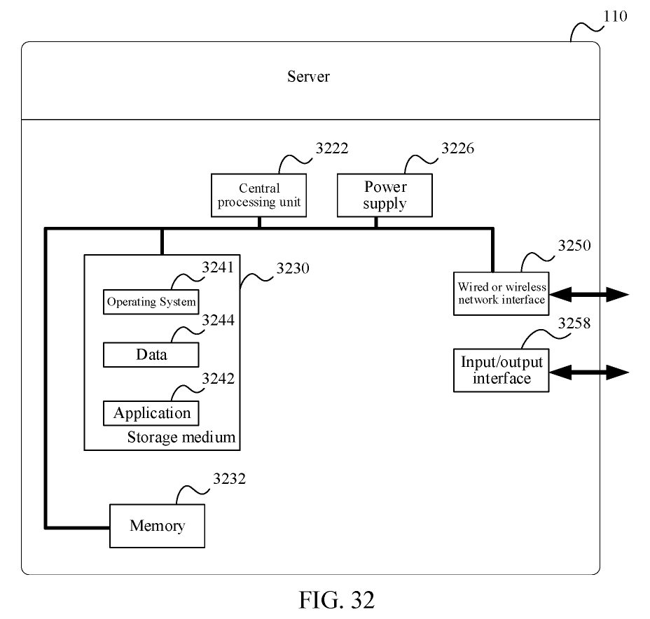

FIG. 32 is a structural block diagram of a part of a server implementing a group presentation method in an application according to an embodiment of this disclosure. The server may vary greatly due to different configurations or performances and may include processing circuitry such as one or more central processing units (CPU) 3222 (e.g., one or more processors), a memory 3232, and one or more non-transitory computer-readable storage media 3230 (e.g., one or more mass storage apparatuses) for storing applications 3242 or data 3244. The memory 3232 may be transient or persistent storages. The program stored in the one or more storage media 3230 may include one or more modules (not shown). Each module may include a series of instruction operations in the server. The CPU 3222 may be configured to communicate with the one or more storage media 3230 and execute a series of instruction operations in the one or more storage media 3230 in the server.

The server may further include one or more power supplies 3226, one or more wired or wireless network interfaces 3250, one or more input/output interfaces 3258, and/or one or more operating systems 3241, such as Windows ServerTM, Mac OS XTM, UnixTM, LinuxTM, and FreeBSDTM.

The CPU 3222 in the server may be configured to perform the group presentation method in an application according to one or more embodiments of this disclosure.

Embodiments of this disclosure further provide a computer-readable storage medium. The computer-readable storage medium is configured to store program code. The program code is configured to perform the group presentation method in an application according to one or more foregoing embodiments.

Embodiments of this disclosure further provide a computer program product. The computer program product includes a computer program. A processor of a computer device reads and executes the computer program, to enable the computer device to perform the foregoing group presentation method in an application.

In the specification and the foregoing accompanying drawings of this disclosure, the terms "first", "second", "third", "fourth", and the like (if existent) are intended to distinguish between similar objects but do not necessarily indicate a specific order or sequence. Data used in this way is exchangeable in a proper case, so that one or more embodiments of this disclosure described herein can be implemented in an order different from the order shown or described herein. In addition, the terms "include", "comprise", and any other variants are intended to cover the non-exclusive inclusion. For example, a process, method, system, product, or apparatus that includes a series of operations or units is not necessarily limited to those expressly listed operations or units, but may include other operations or units not expressly listed or inherent to such a process, method, product, or apparatus.

In this disclosure, "at least one" indicates one or more, and "a plurality of" indicates two or more. The term "and/or" describes an association between associated objects and represents that three associations may exist. For example, "A and/or B" may indicate that only A exists, only B exists, and both A and B exist, where A and B may be singular or plural. The character "/" generally indicates an "or" relationship between the associated objects. The phrase "at least one of the following" etc. indicate any combination of these items, including a single one or any combination of plural ones. For example, at least one item of a, b, or c may indicate a, b, c, "a and b", "a and c", "b and c", or "a, b, and c", where a, b, and c may be singular or plural.

In the descriptions in one or more embodiments of this disclosure, the term "a plurality of" indicates two or more, the terms "greater than", "less than", "exceed", etc. are interpreted as excluding the present number, and the terms "above", "below", "within", etc. are interpreted as including the present number.

In the several embodiments provided in this disclosure, the disclosed system, apparatus, and method may be implemented in other manners. For example, the described apparatus embodiment is merely an example. For example, the unit division is merely logical function division and there may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separated, and parts displayed as units may or may not be physical units, to be specific, may be located in one position, or may be distributed on a plurality of network units. Some or all of the units may be selected according to actual needs to achieve the objectives of the solutions of one or more embodiments.

In addition, functional units in one or more embodiments of this disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of the software function unit, and sold or used as an independent product, the integrated unit may be stored in a computer-readable storage medium. Based on such understanding, the technical solution of this disclosure, all or some of the technical solution may be embodied in a form of a software product. The computer software product is stored in one non-transitory computer-readable storage medium and includes several instructions configured to cause one computer apparatus (which may be a personal computer, a server, a network apparatus, etc.) to perform all or some of the operations of the method in one or more embodiments of this disclosure. The non-transitory computer-readable storage medium may include any medium that may store a computer program, such as a USB flash drive, a removable hard disk, a read-only memory (ROM), a random access memory (RAM), a magnetic disk, or an optical disk.

Various implementations according to one or more embodiments of this disclosure may be combined in different manners to form other embodiments, so as to achieve different technical effects.

The above description illustrates non-limiting examples of this disclosure, and this disclosure is not limited to one or more of foregoing examples. Those skilled in the art may make various modifications or replacements without going beyond the spirit of this disclosure. These modifications or replacements are all included within the scope of this disclosure.

What is claimed is:

1. A group presentation method, the method comprising:
displaying, on a display of a terminal associated with a first entity, a first page in an application;
displaying a target group name of a target group in the first page, the target group name being associated with a link tag of an entry link of the target group, the entry link being created by a second entity in the target group and associated with the target group name of the target group upon creation by the second entity;
detecting, by processing circuitry of the first terminal, a hover operation performed in a region of the displayed target group name on the first page;
displaying basic information of the target group in a notification window overlaying the first page based on the hover operation being detected;
detecting, by the processing circuitry of the first terminal, a triggering operation performed on the displayed target group name on the first page; and
displaying a session page of the target group based on the triggering operation being detected.

2. The method according to claim 1, further comprising:
determining the link tag of the entry link as the target group name when the second entity enables name display of the target group for the terminal associated with the first entity upon creation of the entry link of the target group.

3. The method according to claim 1, further comprising:
determining a group name specified for the terminal associated with the first entity as the target group name, the group name being specified by the second entity upon creation of the entry link of the target group, different group names being specified by the second entity for different terminals upon creation of the entry link of the target group.

4. The method according to claim 1, further comprising:
determining, among a plurality of candidate group names, a candidate group name corresponding to a first preference of the terminal associated with the first entity as the target group name, the plurality of candidate group names being associated with the entry link by the second entity upon creation of the entry link of the target group.

5. The method according to claim 1, wherein the displaying the session page of the target group comprises:
determining whether the first entity is included in the target group; and
displaying, when the first entity is determined as included in the target group, the session page of the target group based on the triggering operation being detected.

6. The method according to claim 5, wherein the determining whether the first entity is included in the target group comprises:
obtaining candidate terminal identifiers of terminals of respective candidate entities in the target group; and
determining that the first entity is included in the target group when a terminal identifier of the terminal associated with the first entity is consistent with one of the candidate terminal identifiers.

7. The method according to claim 1, wherein the displaying the session page of the target group comprises:
displaying an inquiry message based on the triggering operation being detected, the inquiry message being configured to inquire whether to display the session page of the target group; and
displaying the session page of the target group based on a positive acknowledgment to the inquiry message.

8. The method according to claim 1, wherein the displaying the session page of the target group comprises:
transmitting an authorization request to the second entity based on the triggering operation being detected; and
displaying the session page of the target group based on receiving an authorization response from the second entity.

9. The method according to claim 8, wherein the transmitting the authorization request to the second entity comprises:
transmitting, upon determining that the first entity is not included in the target group, the authorization request to the second entity based on the triggering operation being detected.

10. The method according to claim 1, wherein the basic information of the target group comprises at least one of first information set by the second entity when creating the target group, or second information extracted from the target group by an application platform based on basic information extraction rules.

11. The method according to claim 1, wherein
the target group includes a plurality of target sub-groups;
the entry link is synthesized based on sub-entry links created by the second entity for respective target sub-groups of the plurality of target sub-groups;
the basic information of the target group includes target sub-group names of the respective target sub-groups of the plurality of target sub-groups, each one of the target sub-group names being associated with the respective target sub-group when the second entity creates the entry link; and
the method further includes:
displaying a session page of the target sub-group based on a corresponding sub-group link tag associated with the target sub-group based on a triggering operation performed on the corresponding displayed target sub-group name being detected.

12. The method according to claim 1, wherein
the entry link is coded based on a group character string; and
the group character string is generated by the second entity based on the target group name and a terminal identifier of another terminal associated with the second entity.

13. The method according to claim 12, wherein
the group character string satisfies a first condition that corresponds to the group character string being different from recorded character strings in a relationship comparison table.

14. The method according to claim 12, wherein
the group character string corresponds to a random string generated by the second entity based on the target group name of the target group and the terminal identifier of the other terminal associated with the second entity.

15. The method according to claim 1, wherein
the target group includes a plurality of target sub-groups;
the entry link is coded based on a group character string; and
the group character string is generated by the second entity based on a plurality of sub-group links of the plurality of target sub-groups and a terminal identifier of another terminal associated with the second entity.

16. The method according to claim 15, wherein
each one of the plurality of sub-group links of a respective target sub-group of the plurality of target sub-groups is coded based on a respective sub-group character string; and
each sub-group character string is determined based on a corresponding sub-group name.

17. The method according to claim 16, wherein
each sub-group character string is identical to one of recorded character strings in a relationship comparison table.

18. The method according to claim 1, wherein the displaying the target group name comprises:
locating the entry link on the first page based on a predetermined regular expression, and extracting a group character string from the entry link; and
displaying the target group name associated with the link tag when the group character string is determined as associated with the target group name of the target group.

19. A group presentation apparatus, comprising:
processing circuitry configured to:
display, on a display of the apparatus associated with a first entity, a first page in an application;
display a target group name of a target group in the first page, the target group name being associated with a link tag of an entry link of the target group, the entry link being created by a second entity in the target group and associated with the target group name of the target group upon creation by the second entity;
detect a hover operation performed in a region of the displayed target group name on the first page;
display basic information of the target group in a notification window overlaying the first page based on the hover operation being detected;
detect a triggering operation performed on the displayed target group name on the first page; and
display a session page of the target group based on the triggering operation being detected.

20. A non-transitory computer-readable storage medium storing instructions, which when executed by a processor, cause the processor to perform a group presentation method, the method comprising:
displaying, on a display of a terminal associated with a first entity, a first page in an application;
displaying a target group name of a target group in the first page, the target group name being associated with a link tag of an entry link of the target group, the entry link being created by a second entity in the target group and associated with the target group name of the target group upon creation by the second entity;
detecting a hover operation performed in a region of the displayed target group name on the first page;
displaying basic information of the target group in a notification window overlaying the first page based on the hover operation being detected;
detecting a triggering operation performed on the displayed target group name on the first page; and
displaying a session page of the target group based on the triggering operation being detected.
